(19) United States
(12) Patent Application Publication
(10) Pub. No.: US 2025/0073687 A1
(43) Pub. Date: Mar. 6, 2025

(54) PIEZOCATALYST, PIEZOELECTRIC MATERIAL COMPRISING PIEZOCATALYST, MANUFACTURING METHOD, AND USES THEREFOR

(71) Applicant: City University of Hong Kong, Kowloon (HK)

(72) Inventors: Chun-Sing LEE, Kowloon (HK); Weifeng YAO, Shang Hai (CN); Qi ZHAO, Kowloon (HK); Yajun SUN, Kowloon (HK)

(21) Appl. No.: 18/825,151

(22) Filed: Sep. 5, 2024

Related U.S. Application Data
(60) Provisional application No. 63/580,527, filed on Sep. 5, 2023.
(60) Provisional application No. 63/580,528, filed on Sep. 5, 2023.

(51) Int. Cl. B01J 27/24; B01D 67/00; B01D 69/14; B01D 71/02; B01D 71/34; B01J 35/33; B01J 35/59; B01J 35/61; B01J 37/04; B01J 37/08; C02F 1/72; C02F 101/30

(52) U.S. Cl. CPC B01J 27/24; B01D 67/00793; B01D 69/145; B01D 71/022; B01D 71/34; B01J 35/33; B01J 35/59; B01J 35/617; B01J 37/04; B01J 37/086; C02F 1/725; C02F 2101/308; C02F 2305/023; C02F 2305/08

(57) ABSTRACT

A piezocatalyst containing a nitrogen doped carbon skeleton derived from a zeolitic imidazolate framework (ZIF), and a single-atom alkaline earth metal anchored on the nitrogen doped carbon skeleton, where the alkaline earth metal is selected from the group of beryllium (Be), magnesium (Mg), calcium (Ca), Strontium (Sr), and barium (Ba); the piezocatalyst includes an active cite formed with the single-atom alkaline earth metal and nitrogen atoms from the ZIF. A piezocatalytic material includes the piezocatalyst. Also provided herein is a method of manufacturing such a piezocatalyst/piezocatalytic material and an environmental remediation method employing such a piezocatalyst/piezocatalytic material.

### FIELD OF THE INVENTION

The present invention relates to a piezocatalyst, piezocatalytic material comprising piezocatalyst, methods of manufacture thereof, and uses thereof.

### BACKGROUND

Piezoelectric crystals are well-known to provide an electric field, or even a spark upon physical compression, agitation, heating, etc. Recently, researchers have created piezoelectric polymer membranes with similar properties. It is known that the β-crystal phase is the most active piezoelectric phase and thus researchers seek piezoelectric polymers promoting this phase. Current piezoelectric polymer membranes and/or piezoelectric crystals are used in various applications such as, for example, catalytic dye decomposition (You, et al., “Piezoelectrically/pyroelectrically-driven vibration/cold-hot energy harvesting for mechano-/pyro-bi-catalytic dye decomposition of NaNbO₃ nanofibers”, Nano Energy. vol. 52, pp. 351-59, 2018), wastewater treatment (Singh, “Transparent ferroelectric glass-ceramics for wastewater treatment by piezocatalysis”, Commun. Mater., vol. 1, p. 100, 2020), organic pollutant degradation (Biswas, “ZnSnO3 Nanoparticle-Based Piezocatalysts for Ultrasound-Assisted Degradation of Organic Pollutants”, ACS Appl. Nano Mater., vol. 2, pp. 1120-28, 2019), etc.

Thus, piezoelectric catalysis (piezocatalysis) is increasingly seen as a viable new green technology for environmental remediation. (see, e.g., You, and Singh, above). Various piezocatalysts are known in the art, including those formed from ZnO, BiFeO₃, BaTiO₃, etc. Without intending to be limited by theory, it is believed that there are currently two theoretical mechanisms for piezocatalysis; the Energy Band Theory and the Screening Charge Effect. See, Wang, et al., “The Mechanism of Piezocatalysis: Energy Band Theory or Screening Charge effect?”, Angewandte Chemie International Edition, https://onlinelibrary.wiley.com/doi/10.1002/anie.202110429, 2021. According to the Screening Charge Effect, when immersed in water and subjected to mechanical stress, such as ultrasonic vibration, a piezoelectric membrane, crystal, nanoparticle, etc. can generate a built-in electric field promoting spatial separation of excited electrons and holes pairs which may then trigger redox reactions in surrounding water to generate reactive oxygen species (ROS). The ROS then may subsequently degrade surrounding organic contaminants by attacking, for example, double-bonds.

However, these reported inorganic piezoelectric catalysts, such as ZnO, BiFeO₃, BaTiO₃ do not have a catalytic performance that is high enough for wider applications. It also has been found that various piezocatalysts are provided as powders and when present in dispersions, they may provide various levels of catalytic performance. However, as powders, they may be difficult to separate from the liquid dispersion after use, thus potentially leading to secondary environmental contamination (see Orudzhev, et al. “Ultrasound and water flow driven piezophototronic effect in self-polarized flexible α-Fe₂O₃ containing PVDF nanofibers membrane for enhanced catalytic oxidation”, Nano Energy. vol. 90, 106586, 2021).

Previously, piezocatalysts were thought of as being rigid inorganic constructs, recently organic piezocatalysts employing polymer membranes provide unique benefits such as mechanical flexibility, chemically inertness, low toxicity, and biocompatibility. For example, polyvinylidene fluoride (PVDF) is an upcoming piezocatalyst candidate due to its good chemical, thermal and mechanical stability. See, e.g., Raju, Polyvinylidene Fluoride/ZnSnO3 Nanocube/Co₃O₄ Nanoparticle Thermoplastic Composites for Ultrasound-Assisted Piezo-Catalytic Dye Degradation, ACS Appl. Nano Mater., vol. 3, pp. 4777-87, 2020; Wang, “Bi-piezoelectric effect assisted ZnO nanorods/PVDF-HFP spongy photocatalyst for enhanced performance on degrading organic pollutant”, Chem. Eng. J., vol. 439, 2022; Zheng, “Effective Removal of Sulfanilic Acid From Water Using a Low-Pressure Electrochemical RuO₂—TiO₂@Ti/PVDF Composite Membrane”, Front Chem., vol. 6, p. 395, 2018; etc. Such reported piezocatalysts appear to all require multiple metal atomic species, such as, for example, zinc and tin, ruthenium and titanium, etc. potentially requiring complicated production processes and expensive and/or rare minerals. Furthermore, current piezoelectric polymer membranes typically possess low energy efficiency.

Accordingly there exists a need for a piezocatalyst containing a single metal atom, an easily-manufacturable and scalable piezocatalyst, an improved process for making a piezocatalyst, a piezocatalyst with an improved energy efficiency and/or reaction constant, a piezocatalyst made with abundant alkaline earth metals, etc.

### SUMMARY OF THE INVENTION

An embodiment of the invention herein relates to a piezocatalyst comprising a nitrogen doped carbon skeleton derived from a zeolitic imidazolate framework (ZIF), and a single-atom alkaline earth metal anchored on the nitrogen doped carbon skeleton, wherein the alkaline earth metal is selected from the group consisting of beryllium (Be), magnesium (Mg), calcium (Ca), Strontium (Sr), and barium (Ba), wherein the piezocatalyst comprises an active cite formed with the single-atom alkaline earth metal and nitrogen atoms from the ZIF.

In recent years, piezocatalysis technology has been recognized as a green way to remove stubborn organic pollutants in the environment. However, the low utilization rate, low activity and poor stability of the catalyst have seriously hindered the development of piezocatalysis technology. The piezocatalyst based on single-atom Ca anchored on N doped porous carbon derived from ZIF according to this application is believed to be efficient and stable in piezocatalytic applications. As illustrated in the examples herein, the piezocatalyst according this application has high piezocatalytic activity and stability in dye degradation. Without intending to be bound by theory, it is believed that co-doping of single atom of alkaline earth metal (such as, calcium) and N atoms can enhance the piezoelectric response of carbon-based materials.

An embodiment of the invention herein relates to piezocatalytic material comprising the piezocatalyst as described herein.

Another embodiment of the invention relates to a method for preparing the piezocatalyst as described herein, comprising the steps of: (A) providing a precursor comprising an alkaline earth metal doped zeolitic imidazolate framework (ZIF); and (B) subjecting the precursor from step (A) to a pyrolysis process.

Another embodiment of the invention relates to a method for manufacturing a piezocatalytic material comprising, comprising the steps of: (1) providing a precursor comprising an alkaline earth metal doped zeolitic imidazolate framework (ZIF), comprising (A1) providing a first mixture comprising a Zn source and an alkaline earth metal source comprising an alkaline earth metal selected from the group consisting of beryllium (Be), magnesium (Mg), calcium (Ca), Strontium (Sr), and barium (Ba); or Ba, Mg and Ca; or Mg and Ca; or Ca; (A2) providing a second mixture comprising 2-methylimidazole; (A3) mixing the first mixture and the second mixture by stirring to provide a third mixture; (A4) heating the third mixture to about 120° C. in an airtight container to provide a fourth mixture; and (A5) isolating the precursor from the fourth mixture; (2) subjecting the precursor from step (1) to a pyrolysis process; and (3) forming the piezocatalytic material.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention will now be more particularly described, by way of example only, with reference to the accompanying drawings, in which:

FIG. 1A is a schematic diagram illustrating the synthesis of Ca/NC according to an embodiment of this application;

FIG. 1B shows TEM image of Ca/NC according to an embodiment of this application;

FIG. 1C shows HR-TEM of Ca/NC according to an embodiment of this application;

FIG. 1D shows Aberration-corrected HAADF-STEM image of Ca/NC with a scale bar of 2 nm, showing that Ca in the carbon framework existing as single atom (Bright spots are partially marked out with red circles);

FIG. 1E shows Aberration-corrected HAADF-STEM image of Ca/NC with a scale bar of 5 nm, showing that Ca in the carbon framework existing as single atom (Bright spots are partially marked out with red circles);

FIG. 1F shows the HAADF-STEM image of the Ca/NC according to an embodiment of this application;

FIG. 1G shows the images of elemental mapping of C, N, O, and Ca in the Ca/NC according to an embodiment of this application;

FIG. 2A shows SEM image of ZIF-8;

FIG. 2B shows SEM image of Ca/ZIF-8;

FIG. 2C shows simulated XRD patterns of ZIF-8 and experimental XRD patterns of ZIF-8 and Ca/NC according to an embodiment of this application;

FIG. 2D shows Ca/NC electron energy loss spectroscopy (EELs);

FIG. 3A shows XRD patterns of NC and Ca/NC according to an embodiment of this application;

FIG. 3B shows Raman of patterns of NC and Ca/NC according to an embodiment of this application;

FIG. 3C shows N₂ adsorption-desorption isotherms curve of NC and Ca/NC according to an embodiment of this application;

FIG. 3D shows pore size distribution curve based on the Brunauer-Emmett-Teller method;

FIG. 4A shows the elemental survey spectrum of Ca/NC according to an embodiment of this application;

FIG. 4B shows the C Is spectra of NC;

FIG. 4C shows the C Is spectra of Ca/NC according to an embodiment of this application;

FIG. 4D is a diagram showing the relative content of C—C, C—N, C═N bonds in NC and Ca/NC according to an embodiment of this application;

FIG. 4E shows the N Is XPS spectra of NC;

FIG. 4F shows the N Is spectra of Ca/NC according to an embodiment of this application;

FIG. 4G shows the Ca 2p spectra of Ca/NC according to an embodiment of this application;

FIG. 5A shows Ca K-edge X-ray absorption near edge structure spectra of Ca/NC according to an embodiment of this application and CaO;

FIG. 5B shows Fourier transform (FT) of the Ca K-edge extended XAFS (EXAFS) spectra of Ca/NC according to an embodiment of this application and CaO at k-space;

FIG. 5C shows Fourier transform (FT) of the Ca K-edge extended XAFS (EXAFS) spectra of Ca/NC according to an embodiment of this application and CaO at R-space;

FIG. 5D shows Corresponding EXAFS fitting curve of Ca/NC in R-space, insets are the schematic model of Ca—N₃;

FIG. 6A shows the wavelet transform (WT) diagram of CaO;

FIG. 6B shows the wavelet transform (WT) diagram of Ca/NC according to an embodiment of this application;

FIG. 7A shows the PFM topography of Ca/NC according to an embodiment of this application;

FIG. 7B shows the PFM amplitude of Ca/NC according to an embodiment of this application;

FIG. 7C shows the PFM phase mapping of Ca/NC according to an embodiment of this application;

FIG. 7D shows the butterfly amplitude loop and phase curve of Ca/NC according to an embodiment of this application;

FIG. 7E shows the butterfly amplitude loop and phase curve of NC;

FIG. 7F shows the slope of the hysteresis loop over different samples;

FIG. 8A is a diagram showing the effect of initial concentration (C0) on piezocatalytic degradations of RhB solutions;

FIG. 8B is a diagram showing the corresponding k values for different dyes in FIG. 8A;

FIG. 8C is a diagram showing the piezocatalytic degradation efficiencies for different catalysts;

FIG. 8D is a diagram showing the corresponding k values for different catalysts in FIG. 8C;

FIG. 8E is a diagram showing the piezocatalytic degradation efficiencies for different dyes;

FIG. 8F is a chart showing the corresponding k values for different dyes in FIG. 8E;

FIG. 9A is a diagram showing the piezocatalytic degradations of RhB solutions at C₀ of 5 mg/L under different PH values;

FIG. 9B is a diagram showing the cycling test of piezocatalytic RhB degradation (5 mg/L);

FIG. 9C is a diagram showing the piezocatalytic degradations of RhB solutions with various scavengers;

FIG. 9D is a diagram showing the corresponding k values for different dyes in FIG. 9C;

FIG. 9E is a diagram showing the DMPO spin-trapping ESR detection of DMPO-·OH;

FIG. 9F is a diagram showing the DMPO spin-trapping ESR detection of DMPO-·O₂⁻;

FIG. 10A is a diagram showing the transient piezoelectric current response profiles of Ca/NC piezocatalyst and NC;

FIG. 10B is a diagram showing the electrochemical impedance spectra (EIS) Nyquist plots of Ca/NC piezocatalyst and NC;

FIG. 10C is a diagram showing Mott-Schottky curves of Ca/NC according to an embodiment of this application;

FIG. 10D is a diagram showing Mott-Schottky curves of NC;

FIG. 11 is a schematic diagram illustrating the piezo-electrocatalytic dye degradation over Ca/NC catalyst;

FIG. 12 is a schematic diagram illustrating the synthesis of Ca—NC in accordance with an embodiment of the invention;

FIG. 13 shows a HAADF-STEM image of Ca—NC according to an embodiment of this application;

FIG. 14A shows the Ca K-edge XANES spectra of Ca—NC according to an embodiment of this application and CaO, respectively;

FIG. 14B shows the Ca K-edge FT-EXAFS spectra of Ca—NC according to an embodiment of this application and CaO at R-space, respectively;

FIG. 14C shows the corresponding Ca K-edge EXFAFS fitting curve for Ca—NC according to an embodiment of this application at R-space. The insert is a schematic model of Ca—NC;

FIG. 15A shows the WT-EXAFS analysis of CaO;

FIG. 15B shows the WT-EXAFS analysis of Ca—NC according to an embodiment of this application;

FIG. 16A shows the UV-Vis absorption spectra of RhB in an aqueous solution of 10 mg/L Ca—NC according to an embodiment of this application sampled at predetermined intervals;

FIG. 16B shows the UV-Vis absorption spectra of RhB in an aqueous solution of 20 mg/L Ca—NC according to an embodiment of this application sampled at predetermined intervals;

FIG. 16C shows the UV-Vis absorption spectra of RhB in an aqueous solution of 30 mg/L Ca—NC according to an embodiment of this application sampled at predetermined intervals;

FIG. 16D shows the UV-Vis absorption spectra of RhB in an aqueous solution of 10 mg/L ZIF-8 sampled at predetermined intervals;

FIG. 17A shows a schematic of an embodiment of a Ca—NC synthesis herein;

FIG. 17B shows an aberration-corrected high-angle annular dark-field scanning transmission electron microscopy (HAADF-STEM) image of the Ca—NC in FIG. 17A;

FIG. 17C shows TEF image of ZIF-8;

FIG. 17D shows EM (left) and TEM (right) image of Ca@ZIF-8;

FIG. 17E is a diagram showing XRD patterns of Ca@ZIF-8 and ZIF-8;

FIG. 17F shows TEM image of the produced Ca—NC in FIG. 17A;

FIG. 17G shows an electron energy loss spectroscopy (EELS) spectrum of an embodiment of the Ca—NC herein;

FIG. 17H, which shows a HAADF-STEM image and its corresponding energy-dispersive A-ray spectroscopy (EDS) mapping of C, N, Ca and the Ca—NC according to an embodiment of this application;

FIG. 17I shows XRD patterns of Ca—NC according to an embodiment of this application and NC;

FIG. 17J shows a Brunauer-Emmett-Teller (BET) surface area analysis and Barrett-Joyner-Halenda (BJH) pore size and volume analysis of an embodiment of the Ca—NC herein;

FIG. 17K is a diagram showing Ca K-edge XANES curves of Ca—NC according to an embodiment of this application and CaO, respectively;

FIG. 17L is a diagram showing FT-EXAFS spectra of Ca—NC according to an embodiment of this application and CaO, respectively;

FIG. 17M shows a Ca K-edge EXAFS fitting curves for Ca—NC of an embodiment herein (The insets: a schematic model of Ca—NC. The colors of atoms: green, Ca; dark gray, C; pink, N);

FIG. 17N shows the result of WT-EXAFS analysis of CaO;

FIG. 17O shows the result of WT-EXAFS analysis of Ca—NC according to an embodiment of this application;

FIG. 18A is a diagram showing the Formation energy (E_{F}) for Ca—N_{X(X=1-4)}C with their geometries for top view: Q_{Ca} (in |e|) shows the charge of Ca atom, analyzed by natural population analysis (NPA) method; Q_{NM} is the sum charge of four no-metal atoms surrounding the Ca atom; the most stable geometry of the Ca—NC with four N atoms in the right;

FIG. 18B is a diagram showing the total energy changes of Ca—N₁C during ab initio molecular dynamics (AIMD) simulations of 8,000 fₛ (8 ps) with a time step of 1 fₛ at T=700K, with the final configurations of Ca—N_{X(X=1)}C at 8,000 fₛ (8 ps) inserted;

FIG. 18C is a diagram showing the total energy changes of Ca—N₂C during ab initio molecular dynamics (AIMD) simulations of 8,000 fₛ (8 ps) with a time step of 1 fₛ at T=700K, with the final configurations of Ca—N_{X(X=2)}C at 8,000 fₛ (8 ps) inserted;

FIG. 18D is a diagram showing the total energy changes of Ca—N₃C during ab initio molecular dynamics (AIMD) simulations of 8,000 fₛ (8 ps) with a time step of 1 fₛ at T=700K, with the final configurations of Ca—N_{X(X=3)}C at 8,000 fₛ (8 ps) inserted;

FIG. 18E is a diagram showing the total energy changes of Ca—N₄C during ab initio molecular dynamics (AIMD) simulations of 8,000 fₛ (8 ps) with a time step of 1 fₛ at T=700K, with the final configurations of Ca—N_{X(X=4)}C at 8,000 fₛ (8 ps) inserted;

FIG. 19A shows a schematic diagram of the Ca-PVDF manufacturing method herein;

FIG. 19B are digital photos of PVDF (left) and Ca-PVDF (right) membranes according to an embodiment of this application;

FIG. 19C shows a graph of XRD intensity of raw PVDF and an embodiment of the Ca-PVDF membrane herein;

FIG. 19D shows the Raman spectra of raw PVDF and an embodiment of the Ca-PVDF membrane herein;

FIG. 19E shows the FTIR spectra of raw PVDF and an embodiment of the Ca-PVDF membrane herein;

FIG. 19F shows DFT calculations for the Ca—NC modified α-phase of PVDF membrane (Ca-α-PVDF), in which I shows the side view for optimized geometry of Ca-α-PVDF, II shows the charge density distributions for Ca—NC, and III shows the charge density distributions for α-PVDF. The Q stands for the charge (in |e|), and the isovalue was set as 0.001 (yellow: accepting electrons, and blue: donating electrons;

FIG. 20A shows a scanning electron microscope (SEM) image of the “air” side of a PDVF membrane according to an embodiment of this application;

FIG. 20B shows a SEM image of the “glass” side of a PDVF membrane;

FIG. 20C shows a SEM image of the “air” side of an embodiment of the Ca-PVDF membrane herein;

FIG. 20D shows a SEM image of the “glass” side of an embodiment of the Ca-PVDF membrane herein;

FIG. 20E shows a high magnification SEM image of the “air” side of an embodiment of the Ca-PVDF membrane herein;

FIG. 20F shows elemental mapping of C, N, Ca, O, and F, in Ca-PVDF;

FIG. 20G shows graphs of BET and BJH analyses of a PVDF membrane according to an embodiment of this application;

FIG. 20H shows graphs of BET and BJH analyses of an embodiment of an embodiment of the Ca-PVDF membrane herein;

FIG. 20I shows photos of the contact angles for PVDF and an embodiment of the Ca-PVDF herein;

FIG. 20J shows a graph of PVDF's binding energy;

FIG. 20K shows a graph of a Ca-PVDF embodiment's binging energy;

FIG. 20L is a graph showing high resolution XPS spectra of F Is of an embodiment of the Ca-PVDF herein;

FIG. 20M is a graph showing high resolution XPS spectra of F Is of PVDF;

FIG. 21A is a diagram showing DFT calculations of Ca-PVDF membranes according to embodiments of this application;

FIG. 21B is a diagram showing the two-layer β-phase-PVDF with the charges of key atoms marked; in which the black arrow shows the direction of its dipole moment;

FIG. 21C shows the four possible geometries for the Ca-PVDF membrane according to an embodiment of this application,

FIG. 21D shows the relative energies of the four possible geometries for the Ca-PVDF membrane in FIG. 21C;

FIG. 22A is a graph showing piezoelectric performance of recently-reported materials and an embodiment of the present invention;

FIG. 22B is a graph comparing RhB degradation across various piezocatalysts;

FIG. 22C is a graph comparing the reaction constants of various piezocatalysts;

FIG. 22D is a graph showing the degradation rate vs. cycle number of an embodiment of the Ca-PVDF herein;

FIG. 22E is a diagram showing the piezocatalytic degradation curves for various dyes using the Ca-PVDF membrane according to an embodiment herein;

FIG. 22F is a diagram showing the piezocatalytic degradation stability for the removal of MB solutions stability of the Ca-PVDF membrane according to an embodiment herein;

FIG. 22G is a diagram showing the piezocatalytic degradation stability for the removal of MO solutions stability of the Ca-PVDF membrane according to an embodiment herein;

FIG. 22H is a diagram showing the piezocatalytic degradations of RhB solutions under different surface areas of the Ca-PVDF membrane according to an embodiment herein;

FIG. 22I is a diagram showing the corresponding degradation kinetic rate constants (min 1) for RhB removal of the Ca-PVDF membrane according to an embodiment herein under different additive amounts of Ca—NC (wt %);

FIG. 23A shows photographs of E. coli colonies on agar plates over time;

FIG. 23B shows the comparative antibacterial efficacy against E. coli after 0 and 60 minutes US treatment;

FIG. 24A is a graph showing the piezo-catalytic degradation of RhB using the Ca-PVDF membrane according to an embodiment herein with or without the presence of different scavengers;

FIG. 24B is a graph showing the ESR spectra of the Ca-PVDF membrane according to an embodiment herein over DMPO-·O₂ and DMPO-·OH in 10 min;

FIG. 24C is a graph showing the increase of the DMPO-·O₂ signal peaks over time;

FIG. 25A is a schematic diagram showing different stress states of spontaneous dipole polarization;

FIG. 25B is a schematic diagram showing the compression and stretching of an embodiment of the Ca-PVDF herein;

FIG. 26A is a diagram showing the total density of states (TDOS) for the most stable geometry of Ca-PVDF membrane (structure (1)), and partial density of states (PDOS) for Ca element, and N element, with the overlap population density of states (OPDOS) between Ca and N atoms;

FIG. 26B is a diagram showing the highest occupied molecular orbital (HOMO) and the lowest unoccupied molecular orbital (LUMO) distributions of Ca-PVDF membrane (structure 1), with isovalue set as 0.002 a.u. (positive charge in yellow and negative charge in blue);

FIG. 26C shows the side views for the optimized O₂ adsorption structures;

FIG. 26D shows the side views for the optimized H₂O adsorption structures and the adsorption energies (ΔE_{ads}, in eV) with key distances (in Å) and the charge (in |e|) of O₂ molecule;

FIG. 26E is a diagram showing the energy profile of the O₂ molecular hydrogenation process on Ca-PVDF (black line) and NC-PVDF (yellow line) surfaces, in which intermediates on the Ca-PVDF and the distance (D_{O-O}, in A) between two O atoms * Denotes that the molecules/species are adsorbed on the surface;

FIG. 26F is a diagram showing the differential charge density distributions for O₂ adsorption structures under the extra electric fields of 0.50 (tiny blue arrows) and 1.00 V/Å (thick blue arrows) on Ca-PVDF in FIG. 26F-I and -II, and NC-PVDF in FIG. 26F-III and 26F-IV, compared to that without any extra electric field;

FIG. 26G shows DFT Calculations for reaction mechanisms of the reduction for O₂ on the Ca-PVDF membranes under alkaline conditions, in which E (in eV) stands for the reaction energy, and the negative value of E implies an exothermic and spontaneous reaction;

FIG. 26H is a graph showing the piezocatalytic degradations of RhB solutions under different pH values;

FIG. 26I shows the adsorption configurations of the intermediates (*O₂ (a)→*OOH (b)→*OH+*OH (c)→*OH (d)) for O₂ hydrogenation on the NC-PVDF;

FIG. 27A is a diagram showing the energy profile diagram of the O₂ molecular hydrogenation process on β-phase-PVDF

FIG. 27B shows the structures for the intermediates on β-phase-PVDF;

FIG. 27C is a diagram showing the energy profile of the O₂ molecular hydrogenation process on Ca—NC (black line) and NC (yellow line) surfaces, in which the structures for the intermediates on the Ca—NC with the distance (DO-O, in Å) between two O atoms and the charge (in |e|) of 02 molecule are shown in the energy profile diagram;

FIG. 27D shows the structures for the intermediates (*O₂→*OOH→*OH+*OH→*OH) for the O₂ molecular hydrogenation process on NC with the distance between two O atoms and the charge of O₂ molecule. * presents that the molecules are adsorbed on the surface;

FIG. 28A is a diagram showing the optimum voltage output (180 mV) applied mechanical stress by hand bend mildly;

FIG. 28B is a diagram showing the Ca-PVDF membrane optimum voltage output (2V) under the vibration (5 HZ);

FIG. 29 shows the geometry for the Ca-PVDF membrane, with the distance between Ca—NC and PVDF of 2.00 Å, in which the dipole moment (in Debye) is marked from the level of ωB97XD/6-31G (d, p), the black arrow shows its direction along the Z-axis (the negative charge center points to the positive charge center);

FIG. 30A is a schematic diagram of the Ca-PVDF membranes for piezocatalytic performance;

FIG. 30B is a schematic diagram of an embodiment of the Ca-PVDF herein at different piezocatalytic states: (B—I) The original electrostatic balance state of Ca-PVDF membranes; (B-II) The release of surface screening charges under compressed strain to trigger surface redox reactions of Ca-PVDF membranes; (B—III) the modified electrostatic balance state under maximum compressive stress; (B—IV) The adsorption of charges from the surrounding electrolyte under reduced compressive stress; the charges in the electrolyte with opposite polarity to the adsorbed charges will participate in the redox reaction to produce reactive species;

FIG. 31A shows PFM amplitude image of PVDF;

FIG. 31B shows PFM amplitude image of Ca-PVDF;

FIG. 31C shows the corresponding amplitude of Ca-PVDF;

FIG. 31D shows the corresponding phase hysteresis loops of Ca-PVDF;

FIG. 31E is a diagram showing the variation of the height signals from the 3D-PFM Topography image of PVDF

FIG. 31F is a diagram showing the variation of the height signals from the 3D-PFM Topography image of Ca-PVDF membranes;

FIG. 31G shows PFM morphology image of PVDF;

FIG. 31H shows phase image of PVDF;

FIG. 31I shows PFM morphology image of Ca-PVDF membranes; and

FIG. 31J shows phase image of Ca-PVDF membranes.

The figures herein are for illustrative purposes only and are not necessarily drawn to scale.

### DESCRIPTION OF THE PREFERRED EMBODIMENTS

Unless otherwise specifically provided, all tests herein are conducted at standard conditions which include a room and testing temperature of 25° C., sea level (1 atm.) pressure, pH 7, and all measurements are made in metric units. Furthermore, all percentages, ratios, etc. herein are by weight, unless specifically indicated otherwise. It is understood that unless otherwise specifically noted, the materials compounds, chemicals, etc. described herein are typically commodity items and/or industry-standard items available from a variety of suppliers worldwide.

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion.

As used herein the term “piezocatalyst”, and other forms of this term, indicates a piezoelectric material which performs a catalytic function such as, for example, generating a reactive oxygen species. Based on the proposed theory of piezoelectric effect and piezotronics, it is believed that a piezocatalytic reaction occurs when deformation and mechanical, external stress is applied to piezoelectric materials. With the transformation of the instinct crystal structure, a nonzero dipole moment formed in the crystal lattice may induce a polarizing potential with negative and positive charges distributed on the opposite sides of the piezoelectric material. See, Tu, et al., “Piezocatalysis and Piezo-Photocatalysis: Catalysts Classification and Modification Strategy, Reaction Mechanism, and Practical Application”, Adv. Func. Mat., vol. 30, Is. 48, 2020, https://onlinelibrary.wiley.com/doi/full/10.1002/adfm.202005158.

As used herein the term “piezoelectric”, and other forms of this term, indicates that an electric charge and/or field is created by a material in response to stress, typically vibrational, heat and/or mechanical stress. See, Tu, et al., above.

As used herein, the term “piezocatalytic material” refers to material including the piezocatalyst as defined above. For example, the piezocatalytic material may be a composite including a piezocatalyst. In some instances, the composite may be a composite membrane including the piezocatalyst and an additional material (e.g., carbon materials, or polymers such as PVDF).

As used herein, the phrase “single-atom catalyst” indicates a material where the catalytic process is driven by a single atom. Similarly, the term “single-atom catalysis” indicates a process wherein a single atom on a catalytic surface drives a catalytic reaction.

### I. Piezocatalyst and Products Comprising Piezocatalyst

An embodiment of this application relates to a piezocatalyst comprising a nitrogen doped carbon skeleton derived from a zeolitic imidazolate framework (ZIF), and single-atom alkaline earth metal anchored on the porous carbon skeleton, wherein the alkaline earth metal is selected from the group consisting of beryllium (Be), magnesium (Mg), calcium (Ca), Strontium (Sr), and barium (Ba), wherein the single-atom alkaline earth metal element and nitrogen atoms from the ZIF form an active center of the piezocatalyst. The piezocatalyst can be derived from a precursor comprising an alkaline earth metal and nitrogen co-doped porous carbon material. Without intending to be bound by theory, it is believed that co-doping of single atom of alkaline earth metal (such as, calcium) and N atoms can enhance the piezoelectric response of carbon-based materials. In addition, it is also believed that piezocatalysis based on piezoelectric effect has been proved to be a new advanced oxidation process and a potential dye wastewater purification technology due to its wide range of applications, sustainability, low operating costs and other advantages.

According to some embodiments, the ZIF for the piezocatalyst is selected from the group consisting of ZIF-6, ZIF-7, ZIF-8, and combinations thereof. In some embodiments, the ZIF is ZIF-8. Without intending to be bound by theory, it is believed that ZIF-8 has rich nitrogen sources, excellent thermal stability, high porosity, large mechanical energy capture area and rich catalytic active sites, and is an ideal precursor for preparing heteroatom and metal atom co-doped carbon materials.

According to some embodiments, the alkaline earth metal is Ca. Without intending to be bound by theory, it is believed that improvement of piezocatalytic activity is mainly due to the redistribution of carbon skeleton charge density due to the incorporation of different electronegative atoms. Among the widely recorded metals, the main group metal calcium (Ca) in s region, as the fifth abundant element in the crust, is one of the cheapest and most biocompatible metals. Therefore, it is believed that the reasonable application of calcium in catalytic reaction can realize the development of catalytic reaction towards a more economic and environment-friendly direction, which meets the needs of contemporary society for green chemistry. It is also believed that monoatomic Ca can be used as an efficient and high-performance electrocatalyst.

According to some embodiments, the piezocatalyst according to this application includes a Ca—N₃ or Ca—N₄ configuration.

According to some embodiments, the piezocatalyst according to this application has a porous structure with a BET surface area ranging from greater than 0 to about 950 m²/g, or about 530 m²/g to about 925 m²/g. For example, the piezocatalyst may have a BET surface area in a range of about 530 m²/g to about 600 m²/g, about 650 m²/g to about 700 m²/g, about 750 m²/g to about 800 m²/g, or about 850 m²/g to 925 m²/g. In particular, the piezocatalyst may have a BET surface area of about 530 m²/g, about 535 m²/g, about 815 m²/g, about 900 m²/g, or about 921 m²/g. Without intending to be bound by theory, it is believed that the large specific surface area is conducive to effective mechanical capture, rapid transfer of charge carriers and adsorptions of organic dyes, and thus conducive to the degradation of organic dyes.

According to some embodiments, the piezocatalyst according to this application is prepared by subjecting the alkaline earth metal doped ZIF precursor to a pyrolysis process.

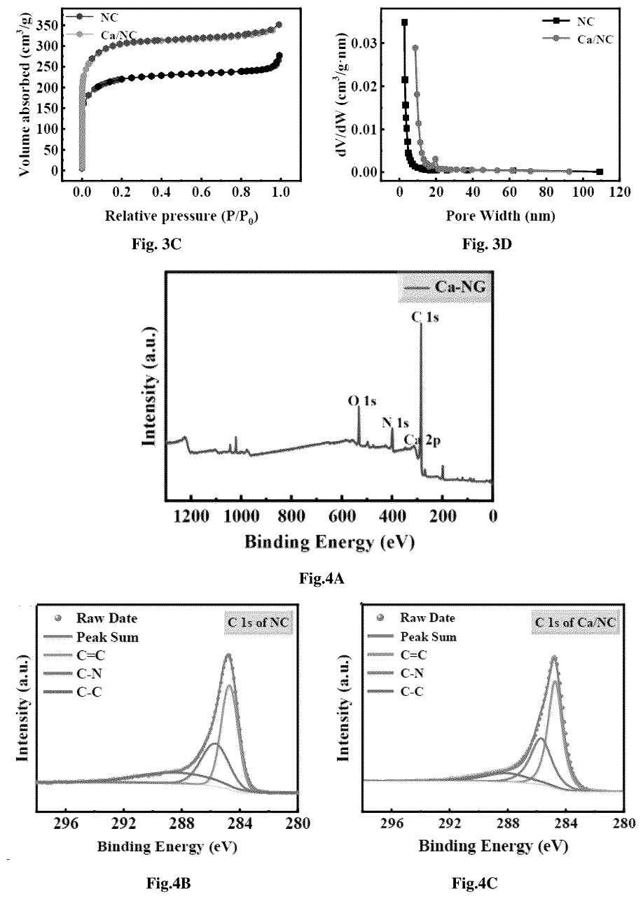

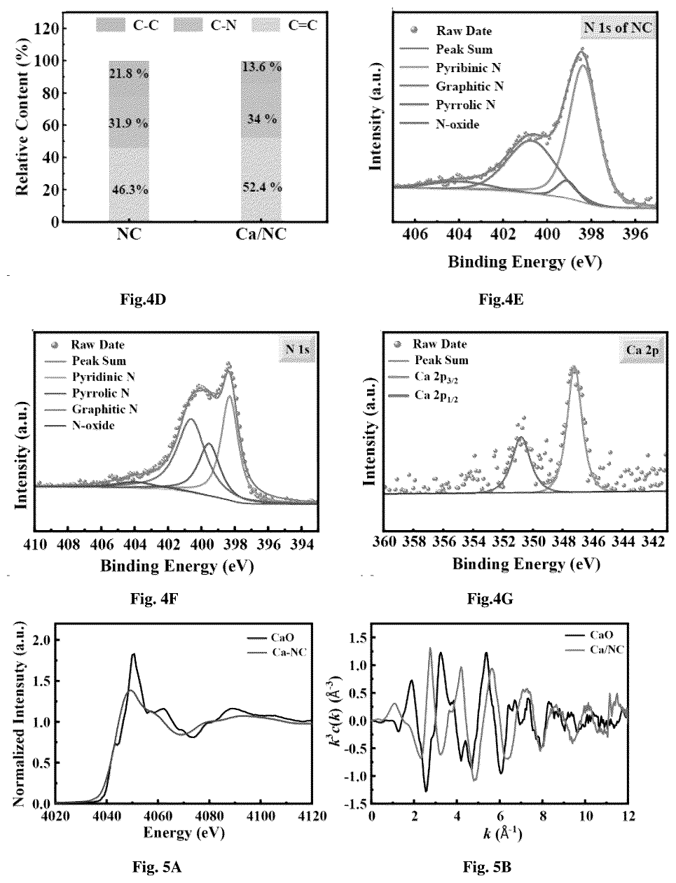

According to some embodiments, the piezocatalyst according to this application has a total pore volume of greater than 0 to about 0.6 cm³/g, for example, about 0.54 cm³/g. FIG. 3D shows a pore size distribution curve of Ca/NC (Carbon-anchored Nitrogen doped Carbon) of an embodiment herein based on the Brunauer-Emmett-Teller method.

According to some embodiments, the piezocatalyst is a nanoparticle of calcium atom-embedded nitrogen-doped carbon (Ca/NC). In some embodiments, the piezocatalyst is Ca/NC that comprises single atom of Ca, which is anchored on N-doped carbon derived from ZIF materials such as ZIF-8. Without intending to be bound by theory, it is believed that Ca/NC has high piezocatalytic activity and stability in dye degradation. In some embodiments, the Ca/NC's degradation efficiency of RhB dye can reach 98% and the degradation rate constant (k) can reach 0.025 min⁻¹ during 150 min under 40 kHz and 120 W ultrasonic vibration. In some embodiments, Ca/NC according to this invention can have unsaturated Ca—N₃, which is a highly catalytic site for the degradation of organic dyes, while pyrrolic-N included in its structure is the adsorption site of the target organic molecules. Without intending to be bound by theory, it is believed that the monoatomic Ca/NC catalyst with rich structural defects, unsaturated Ca—N₃ sites and sufficient pyrrolic-N can effectively realize the synergistic effect of adsorption and catalysis, which greatly shortens the migration distance of free radicals to the adsorbed organic molecules, and opens up a new way to develop high-performance, environment-friendly piezocatalysts.

According to some embodiments, the piezocatalyst according to this application has an average pore diameter ranging from about 8 nm to about 10 nm, for example, about 9.5 nm, or about 9.55 nm. It is believed that the piezocatalyst prepared herein, such as Ca/NC, can have a smaller semicircle diameter than the nitrogen-doped carbon material without anchoring an alkaline earth metal. Without intending to be bound by theory, it is believed that this indicates that the anchoring of the alkaline earth metal atoms can stimulate more effective carrier separation, generate faster interface charge transfer, effectively promote carrier transfer, and thus improve the piezocatalytic efficiency.

An embodiment of this application relates to a piezocatalytic material that includes a piezocatalyst as described herein. In some embodiments, the piezocatalyst can be derived from a precursor comprising an alkaline earth metal and nitrogen co-doped porous carbon material. Optionally, the piezocatalyst includes a nitrogen doped carbon skeleton derived from a zeolitic imidazolate framework (ZIF). The ZIF is selected from the group consisting of ZIF-6, ZIF-7, ZIF-8, and combinations thereof. The piezocatalyst can further includes a single-atom alkaline earth metal anchored on the nitrogen doped carbon skeleton. The alkaline earth metal can be calcium.

According to some embodiments, the piezocatalytic material includes greater than 0 to about 20 wt % of the piezocatalyst. In some embodiments, the piezocatalyst can be present in an amount from about 1 to about 10 wt %, from about 2 to 8 wt %, from about 3 to 7 wt %, from about 4 to 6 wt %. For example, the piezocatalyst can be present in an amount of about 3 wt %, about 4 wt %, about 5 wt %, about 6 wt %, or about 9 wt %.

In some embodiments, the piezocatalytic material includes nanoparticle of calcium atom-anchored nitrogen-doped carbon.

According to some embodiments, the piezocatalytic material further includes a carbon material selected from the group consisting of graphite, carbon fiber, carbon nanotube, graphene, carbon black, hollow spheres, mesoporous carbon, and reduced graphene oxide (GO).

According to some embodiments, the piezocatalytic material further comprises a polymer selected from the group consisting of polyvinyl acetate (PVA), polydimethyl silane (PDMS), polyurethane (PU), polyethylene, cellulose, polytrifluoroethylene (PTFE), polyvinylidene fluoride (PVDF), polyamide, polyester, aramid, and a combination thereof. In some embodiments, the membrane of piezocatalytic material include PVDF. Without intending to be bound by theory, it is believed that a piezoelectric polymer membrane based on single metal atoms can be effective by anchoring isolated calcium (Ca) atoms on a composite of nitrogen-doped carbon and polyvinylidene fluoride (PVDF). It is believed that the addition of Ca-atom-anchored carbon nanoparticles can not only promote the formation of the β phase (from 29.8 to 56.3%), the most piezoelectric active phase, in PVDF, but also introduce much higher porosity and hydrophilicity. Under ultrasonic excitation, the fabricated catalyst membrane demonstrates a record-high and stable dye decomposing rate of about 0.11 min⁻¹ and antibacterial efficiencies of about 99.8%. DFT calculations reveal that the primary contribution to catalytic activity may arise from the single-atom Ca doping, and a possible synergistic effect between PVDF and Ca atoms can improve the catalytic performance. It is shown that O₂ molecules can be easily hydrogenated to produce ·OH on Ca-PVDF, and the local electric field provided by the β-phase-PVDF might enhance the production of 0.02. The polymer membrane herein is expected to inspire rational design of piezocatalysts, and pave ways for the application of piezocatalysis technology for practical environmental remediation.

According to some embodiments, the membrane formed with the piezocatalytic material has a porous structure which provides active cites for free radical reactions. In some embodiments, the piezocatalytic material is a membrane having a porous structure on both sides.

According to some embodiments, the piezocatalytic material comprises the carbon material, which is subjected to a pyrolysis process together with the precursor comprising alkaline earth metal doped ZIF to form a membrane.

In some embodiments, the piezocatalytic material is a hybrid membrane composited with the piezocatalyst and PVDF. The hybrid membrane may have an improved β phase ratio compared with a raw PDVF membrane.

According to some embodiments, the polymer membrane comprises PVDF and the piezocatalyst is a nanoparticle of calcium atom-embedded nitrogen-doped carbon (Ca/NC).

According to some embodiments, the polymer membrane comprises a first side having microscale structure and a second side having nanoscale structure.

An embodiment of the invention herein relates to a piezocatalyst containing a zeolitic imidazolate framework (ZIF-8) nanocrystal and a polymer membrane, where the polymer membrane comprises the ZIF-8 nanocrystal. The zeolitic imidazolate framework (ZIF-8) nanocrystal includes an alkaline earth metal selected from the group of beryllium (Be), magnesium (Mg), calcium (Ca), Strontium (Sr), and barium (Ba); or Ba, Mg and Ca; or Mg and Ca; or Ca. Without intending to be limited by theory, it is believed that Radium (Ra), is less effective as an alkaline earth metal in the ZIF-8. The polymer membrane includes a polymer selected from the group of polyvinyl acetate (PVA), polydimethyl silane (PDMS), polyurethane (PU), polyethylene, cellulose, polytrifluoroethylene (PTFE), polyvinylidene fluoride (PVDF), and a combination thereof; or polyvinyl acetate (PVA), polydimethyl silane (PDMS), polyurethane (PU), nylon, polyethylene, cellulose, polytrifluoroethylene (PTFE), polyvinylidene fluoride (PVDF), polyamide, polyester, aramid, and a combination thereof; or polyvinylidene fluoride (PVDF).

The zeolitic imidazolate framework (ZIF-8) containing an alkaline metal provides a piezoelectric property to the polymer membrane. It is believed that the polymer membrane containing single alkali earth metal atoms effectively embed (i.e., anchor) isolated calcium (Ca) atoms on a composite of, for example, nitrogen-doped carbon and polyvinylidene fluoride (PVDF). In short, it is believed that the ZIF-8 nanocrystals as well as the polymer membrane containing the ZIF-8 nanocrystals possess piezoelectric properties.

Without intending to be limited by theory, it is believed that zeolitic imidazolate ZIF-8 epitomizes the successful combination of metallic organic frameworks (MOFs) and colloidal science. ZIFs are a MOF subfamily that presents crystalline topology like that of zeolites, Among them, ZIF-8 [Zn(2-mim)₂] (where 2-mim is 2-methylimidazole) has been widely studied due to its large pore volume and surface area (>1600 m² g⁻¹), high thermal and chemical stabilities, and ready synthesis: it can be prepared by simply mixing solutions of Zn(II) and 2-mim. Although initial research focused on the synthesis of ZIF-8 crystals (normally performed in dimethylformamide) in the micrometer-to-millimeter scale for structural elucidation. ZIF-8 synthesis enables the production of colloidal crystals under a high degree of control over size and morphology. ZIF-8 is now a new constituent of colloidal science and has also expanded the boundaries of crystal engineering. See, Troyano, et al., “Colloidal metal-organic framework particles: the pioneering case of ZIF-8”, Chem. Soc. Rev., Is 23, 2019, https://pubs.rsc.org/en/content/articlehtml/2021/xx/c9cs00472f.

Without intending to be limited by theory, it is believed that in the ZIF-8 nanocrystal the N-containing methylimidazole ligand may act as a precursor to give a N-doped porous carbon construct. An intersecting three-dimensional structural feature, a large, high thermal stability (˜400° C.) pore, and a large BET (Brunauer, Emmett, Teller) surface area, makes it suitable as a template for porous carbon synthesis. Herein, it is believed that the ZIF-8 promotes the anchoring of isolated Ca atoms by the nitrogen-doped carbon material.

Without intending to be limited by theory, it is also believed that single alkaline earth metals in a single-atom catalyst provide more active sites to enhance the piezoelectric effect. Such single-atom catalysts may demonstrate one or more compelling advantages such as, for example, high metal atom utilization, adjustable loading, excellent catalytic activity, and/or superior selectivity. It is believed that the spontaneous polarization and thus piezoelectric catalytic properties of a piezoelectric material is closely related to a material's structural asymmetry. It has been demonstrated that piezoelectricity can be engineered into carbon-based material by introducing adatoms, doping heteroatoms, crystalline defects, etc.

The polymer membrane herein serves to immobilize the ZIF-8 and structure the piezocatalyst, as well as to provide a flexible substrate.

The polymer membrane may contain a polymer selected from the group of polyvinylidene fluoride (PVDF), polyvinyl acetate (PVA), polydimethyl silane (PDMS), polyurethane (PU), nylon, polyethylene, polyaramid, cellulose, Teflon, and a combination thereof; or PVDF.

In an embodiment herein, the polymer is PVDF, due to its potential piezoelectric properties. Furthermore, it is believed via density functional theory (DFT) computations that PVDF and Ca may together provide synergistic enhancement of the Ca catalytic active sites.

Without intending to be limited by theory, it is believed that the present invention's polymer membrane provides a porous structure containing abundant active sites at which free radical reactions may occur. This plethora of active sites allows the unprecedented generation of ROS at multiple points, which in turn results in significantly higher reaction rates (as shown by significantly-higher reaction rate constants). This leads to increased degradation, antimicrobial efficacy, etc.

It is also believed that PVDF possesses five different crystal phases, namely, α, β, γ, δ, and ε, among which the β phase has the highest spontaneous polarization due to its all-trans (TTTT) conformation (see Itoh, “Solid-state calculations of poly(vinylidene fluoride) using the hybrid DFT method: spontaneous polarization of polymorphs”, Polym. J (Tokyo, Jpn). vol. 46, pp. 207-11, 2014). Ongun, et al., (“Enhancement of piezoelectric energy-harvesting capacity of electrospun β-PVDF nanogenerators by adding GO and rGO”, J. Mater. Sci: Mater. Electron., vol. 31, pp. 1960-68, 2020) reports that adding graphene or graphene oxide into a PVDF membrane can effectively improve its piezoelectric activity because the embedded nanoparticles can promote nucleation and formation of the β-phase PVDF.

The ZIF-8 mass ratio (e.g., (mass of ZIF-8 nanocrystal)/(mass of polymer membrane) herein is from about 0.0001 to about 0.5; or from about 0.001 to about 0.25; or from about 0.02 to about 0.15; or form about 0.025 to about 0.1. It is believed that such a mass ratio balances out the piezoelectric effects of the ZIF-8 and the polymer membrane in a cost-effective and efficient manner.

Without intending to be limited by theory, it is believed that an embodiment of the invention wherein the alkaline earth metal is Ca and the polymer membrane contains PVDF is especially synergistic in that the PVDF may synergistically enhance the catalytic performance of the Ca active sites, increasing the piezocatalytic performance.

### II. Process of Preparing Piezocatalyst and Piezoelectric Material

Another embodiment of this application relates to a method for preparing the piezocatalyst derived from an alkaline earth metal doped zeolitic imidazolate framework (ZIF) precursor herein, comprising the steps of:
(A) providing a precursor comprising the alkaline earth metal doped zeolitic imidazolate framework (ZIF); optionally, the ZIF can be selected from the group consisting of ZIF-6, ZIF-7, ZIF-8, and combinations thereof; and
(B) subjecting the precursor from step (A) to a pyrolysis process.

According to some embodiments, step (A) comprises:
(A1) providing a first mixture comprising a Zn source and an alkaline earth metal source comprising an alkaline earth metal selected from the group consisting of beryllium (Be), magnesium (Mg), calcium (Ca), Strontium (Sr), and barium (Ba);
(A2) providing a second mixture comprising 2-methylimidazole;
(A3) mixing the first mixture and the second mixture by stirring to provide a third mixture;
(A4) heating the third mixture to about 120° C. in an airtight container to provide a fourth mixture; preferably, heating the third mixture to about 120° C. at a rate of about 4° C./min to form a gel-like composite; optionally, the mixture is maintained under this temperature for about 3 to 4 hours, preferably 4 hours; and
(A5) isolating the precursor from the fourth mixture; for example, the isolation can be performed by centrifugation.

According to some embodiments, the pyrolysis process is performed by heating the precursor to a temperature of about 900° C. to 910° C. at a rate ranging from greater than 0 to about 5° C./min in an inert atmosphere (such as Ar atmosphere). For example, the heating rate may be about 3° C./min, about 4° C./min, or about 5° C./min.

According to some embodiments, the precursor is maintained at the temperature of about 900° C. to 910° C. for greater than 0 to about 4 hours, for example, about 2 to 4 hours, about 3 to 4 hours, or about 3.5 hours.

According to some embodiments, the first mixture, the second mixture, and the third mixture further comprise an organic solvent selected from the group consisting of propyl alcohol, n-butyl alcohol, acetonitrile, N-methyl-2-pyrrolidone, ethanol, methanol, acetone, tetrahydrofuran, and a combination thereof. In some embodiments, the organic solvent can be methanol. Optionally, each of the first and the second mixtures further comprises a reaction solvent selected from any one of ethanol, methanol, N-methyl-2-pyrrolidone, acetone, and tetrahydrofuran.

Another embodiment of this application relates to a method for manufacturing a piezoelectric material, comprising the steps of:
(1) providing a precursor comprising an alkaline earth metal doped zeolitic imidazolate framework (ZIF), optionally, the ZIF can be selected from the group consisting of ZIF-6, ZIF-7, ZIF-8, and combinations thereof, comprising:
   (A1) providing a first mixture comprising a Zn source and an alkaline earth metal source comprising an alkaline earth metal selected from the group consisting of beryllium (Be), magnesium (Mg), calcium (Ca), Strontium (Sr), and barium (Ba); or Ba, Mg and Ca; or Mg and Ca; or Ca;
   (A2) providing a second mixture comprising 2-methylimidazole;
   (A3) mixing the first mixture and the second mixture by stirring to provide a third mixture;
   (A4) heating the third mixture to about 120° C. in an airtight container to provide a fourth mixture; preferably, heating the third mixture to about 120° C. at a rate of about 4° C./min to form a gel-like composite; optionally, the mixture is maintained under this temperature for about 3 to 4 hours, preferably 4 hours; and
   (A5) isolating the precursor from the fourth mixture; for example, the isolation can be performed by centrifugation; and
(2) subjecting the precursor from step (1) to a pyrolysis process;
(3) forming the piezoelectric material; optionally, the forming step is performed during the pyrolysis process.

According to some embodiments, step (2) comprises subjecting the precursor and a carbon material to a pyrolysis process, wherein the carbon material is selected from the group consisting of graphite, carbon fiber, carbon nanotube, graphene, carbon black, CNTs, hollow spheres, mesoporous carbon, and reduced graphene oxide (GO).

According to some embodiments, step (2) comprises (a) subjecting the precursor to a pyrolysis process to provide powder of the piezocatalyst, such as calcium atom-embedded nitrogen-doped carbon (Ca/NC).

In some embodiments, step (3) includes the steps of
(b) dispersing the powder of Ca/NC into a polymer solution to provide a polymer suspension, wherein the polymer solution comprises a polymer selected from the group consisting of polyvinyl acetate (PVA), polydimethyl silane (PDMS), polyurethane (PU), polyaramid, polyethylene, cellulose, polytrifluoroethylene (PTFE), polyvinylidene fluoride (PVDF), polyamide, polyester, aramid, and a combination thereof; and
(c) forming a polymer membrane by casting the suspension, for example, on to a plate, in particular, a glass plate.

According to some embodiments, the pyrolysis process is performed at a temperature of about 900° C. to 910° C. According to some embodiments, the precursor is maintained at the temperature of about 900° C. to 910° C. for greater than 0 to about 4 hours, for example, about 2 to 4 hours, about 3 to 4 hours, or about 3.5 hours, or about 4 hours.

According to some embodiments, the forming step comprises the steps of:
i) providing a plate, in particular, a glass plate;
ii) casting the polymer suspension onto the plate;
iii) curing the polymer suspension into a polymer membrane; and
iv) removing the polymer membrane from the plate.

Without intending to be limited by theory, the inventors have, through their own research, trials, and experiments, devised developed a piezocatalyst membrane prepared by anchoring alkaline earth metal on a composite of carbon and polymer. In particular, the as-prepared piezocatalyst May 1) have a porous structure which provides abundant active sites for the free radical reactions, and 2) enabling piezoelectric generation of active oxygen species for decomposing organic contaminants with a record-high-rate constant efficiencies. It is believed that the as-prepared piezocatalyst may be potentially applied for seawater desalination, wastewater purification and other environmental remediation.

In the process of preparing the precursor, the Zn source may be Zinc nitrate hexahydrate (Zn(NO₃)₂·6H₂O). The alkaline earth metal source may be calcium chloride (CaCl₂)), or calcium acetylacetonate (Ca(acac)₂).

In an optional embodiment, the second mixture is formed by mixing the first mixture and 2-methylimidazole with stirring for at least 0.1 min.

In an embodiment of the invention, the alkaline earth metal source is Ca, and the precursor is Ca-doped ZIF-8. Optionally, the Ca-doped ZIF-8 takes a powder form.

In an optional embodiment, the method further comprises the step of providing a third mixture comprising the precursor and a carbon material. It is optional that the carbon material is selected from any one of graphite, carbon fiber, carbon nanotube, graphene, carbon black, hollow spheres, mesoporous carbon, and reduced graphene oxide (GO).

In an optional embodiment, the method is a host-guest method.

In another aspect of the invention, there is provided a piezocatalytic material comprising an alkaline earth metal-based membrane prepared by the method described herein. Optionally, the alkaline earth metal-based membrane is a porous structure which provides active sites for free radical reactions.

In an optional embodiment, the alkaline earth metal-based membrane enables piezoelectric generation of active oxygen species for decomposing organic contaminants. Optionally, the alkaline earth metal-based membrane generates active oxygen species under mechanical stress. It is optional that the mechanical stress is induced by ultrasonic vibration or water stirring ball milling.

In an optional embodiment, the piezocatalyst is capable of decomposing the organic contaminant to a concentration of at least ¼ of its original concentration. Optionally, the organic contaminant comprises Rhodamine B (RhB).

In the manufacture process, the precursor comprising an alkaline earth metal doped zeolitic imidazolate framework (ZIF) may be prepared by the following steps: providing a first mixture comprising a Zn source and an alkaline earth metal source; providing a second mixture comprising the first mixture and 2-methylimidazole; heating the second mixture to form a gel-like composite; and isolating the precursor from the gel-like composite.

In an embodiment, the first mixture may be prepared by dissolving the Zn source and the alkaline earth metal source in a reaction solvent selected from any one of ethanol, methanol, N-methyl-2-pyrrolidone, acetone, and tetrahydrofuran. The first mixture may then be mixed with 2-methylimidazole dissolved in any one of the above reaction solvents to form the second mixture.

After stirring for at least 0.1 min, such as for 5 min, the second mixture may be heated at a temperature of >1° C., such as 120° C. in a container such as a Teflon-lined stainless-steel autoclave for, e.g. at least 8 h. Preferably, the heating process may be a gradual heating process in which the temperature may be raised at a predetermined rate such as 4° C./min. After cooling to room temperature, a gel-like composite comprising the precursor may be obtained.

The precursor may be isolated from the gel-like composite by way of, for example, centrifugation and/or washing with suitable solvent(s). In an embodiment, the precursor may be isolated from the gel-like composite by centrifugation at, for example, about 9,000 rpm and then washed with, for example, methanol for at least four times. The isolated precursor may then be dried in, for example, a vacuum oven at a temperature of, such as about 60° C. for at least 8 h. Accordingly, powders of the precursor may be obtained.

It is appreciated that most of the alkaline earth metal (i.e., metals that belong to Group IIA in the periodic table) may be used as the alkaline earth metal source. In particular, the alkaline earth metal source may comprise any one of Ca, Mg, Ba, Sr, and Be. Preferably, the alkaline earth metal source may comprise any one of Ca, Mg, Ba.

As mentioned, the precursor as prepared by the method described herein is particularly an alkaline earth metal-doped ZIF. In an example embodiment where the alkaline earth metal source may be Ca, the precursor as prepared may be a Ca-doped ZIF-8, which preferably takes a powder form.

Prior to the pyrolysis, a mixture comprising the precursor, particularly powders of the precursor may be mixed with a carbon material in, such as, a tube furnace. After that, the mixture may be subjected to pyrolysis at a temperature of at least about 750° C., such as at about 910° C. for at least 1 h, such as for 4 h. Preferably, the pyrolysis temperature may be raised at a predetermined rate such as at a rate of about 5° C./min.

The carbon material may be selected from any one of graphite, carbon fiber, carbon nanotube, graphene, carbon black, CNTs, hollow spheres, mesoporous carbon, and reduced graphene oxide (GO).

Optionally or additionally, the as-formed alkaline earth metal-based powder-after pyrolysis may be washed with, for example HCl and DI water, followed by drying in for example, a vacuum oven, to give the alkaline earth metal-based powder as the desired product.

As mentioned, it is believed that the alkaline earth metal-based membrane is particularly suitable for acting as a piezocatalyst. In another aspect of the invention, there is provided a piezocatalytic material comprising an alkaline earth metal-based membrane prepared by the method as described herein. The alkaline earth metal-based membrane, in particular, may enable piezoelectric generation of active oxygen species for decomposing organic contaminants. In an embodiment, the alkaline earth metal-based membrane may generate active oxygen species under mechanical stress. For example, under a mechanical stress, such as one induced by ultrasonic vibration or water stirring, the piezocatalyst as described herein may be capable of generating a built-in electric field in its domain, which may promote spatial separation of excited electrons and hole pairs, followed by triggering redox reactions of water to generate reactive oxygen species (ROS) and subsequently degrade/decompose surrounding organic contaminants.

In an example embodiment, the piezocatalyst/piezocatalytic membrane herein may be capable of decomposing the organic contaminant such as Rhodamine B (RhB) to a concentration of at least ¼ of its original concentration.

An embodiment of the invention herein relates to a method for manufacturing a piezocatalyst via the steps of providing an alkaline earth metal, providing a nanocrystal precursor, providing an organic solvent; or an organic solvent, mixing the alkaline earth metal, nanocrystal precursor and the organic solvent to form a mixture, heating the mixture to form a nanocrystal mixture comprising a plurality of nanocrystals, separating the plurality of nanocrystals from the nanocrystal mixture, drying the plurality of nanocrystals to form dried nanocrystals, providing a polymer source, dispersing the dried nanocrystals in a polymer source to form a polymer mixture, and forming a polymer membrane from the polymer mixture. The alkaline metal is selected from the group of beryllium (Be), magnesium (Mg), calcium (Ca), Strontium (Sr), and barium (Ba); or Ba, Mg and Ca; or Mg and Ca; or Ca, and the organic solvent is selected from the group of propyl alcohol, n-butyl alcohol, acetonitrile, N-methyl-2-pyrrolidone, ethanol, methanol, acetone, tetrahydrofuran, and a combination thereof; or N-methyl-2-pyrrolidone, ethanol, methanol, acetone, tetrahydrofuran, and a combination thereof, or N-methyl-2-pyrrolidone. The drying step is at a drying temperature of from about 10° C. to about 100° C.; or from about 15° C. to about 80° C.; or from about 20° C. to about 60° C. for a drying time of about 2 hours to about 24 hours; or from about 3 hours to about 18 hours; or from about 5 hours to about 12 hours. The polymer source is selected from the group of polyvinyl acetate (PVA), polydimethyl silane (PDMS), polyurethane (PU), nylon, polyethylene, cellulose, polytrifluoroethylene (PTFE), polyvinylidene fluoride (PVDF), and a mixture thereof; or polyvinyl acetate (PVA), polydimethyl silane (PDMS), polyurethane (PU), nylon, polyethylene, cellulose, polytrifluoroethylene (PTFE), polyvinylidene fluoride (PVDF), and a mixture thereof; or polyvinylidene fluoride (PVDF).

An embodiment of the invention herein relates to an environmental remediation method containing the steps of providing the piezocatalyst as described herein, exposing the piezocatalyst to water and an environment in need of remediation, vibrating the piezocatalyst to generate a reactive oxygen species (ROS), and exposing the environment in need of remediation to the ROS.

Without intending to be limited by theory, it is believed that the present invention may provide one or more benefits such as easier and improved manufacturing, improved energy efficiency, improved piezocatalysis, an improved piezocatalyst, cheaper manufacture, a higher reaction constant, piezocatalysts with reduced use of rare earths and/or transition metals, improved single-atom piezocatalysts, improved disinfection, improved microbial kill rates, improved environmental remediation, improved passive environmental remediation, etc.

### III. Application of Piezocatalyst and Piezoelectric Material

Without intending to be limited by theory, it is believed that when immersed in water and subject to activation via vibrations heat, etc., such a piezocatalyst may be highly-efficient to decompose an environmental contaminant such as an organic dye, a bacteria, DNA, etc. via, for example, generating a reactive oxygen species (ROS) which may reduce and degrade the environmental contaminant. This may especially be true when combined with, energy from heat, sunlight, etc.

It is believed that when submerged in water and subject to mechanical stress, such as vibrations (e.g., ultrasonic vibrations, water vibrations, etc.), heat, stirring, etc., the piezocatalyst herein may generate a localized electric field. The electric field may promote the spatial separation of excited electrons and/or hole pairs. These in turn may trigger redox reactions in water molecules so as to generate reactive oxygen species (ROS), such as producing ·OH or ·O₂ reactive species for catalysis. The corresponding chemical reaction routes in piezocatalytic degradation is as follows:

O₂+e⁻+Ca-PVDF+ultrasonication→O₂⁻; (1)

O₂+e⁻+2H⁺Ca-PVDF→*2OH; (2)

*2OH+e⁻+H⁺→*OH+H₂O; (3)

*OH+ultrasonication→·OH; (4)

·O₂+·OH+e⁻+H⁺+ultrasonication→Rhodamine B(RhB)decomposition+Water disinfection. (5)

It is further believed that such ROS may in turn directly damage environmental contaminants containing certain biological constructs such as DNA, RNA, lipids, proteins, etc. which could then kill, for example, microbes such as viruses, bacteria, amoebas, etc. dependent on such biological constructs. It is further believed that such ROS could damage and/or attack various susceptible chemical bonds, such as double bonds, carbon-carbon triple bonds (C≡C), etc. so as to, for example, degrade organic materials and thereby neutralize dyes, remove odors, degrade organic contaminants, kill microorganisms such as bacteria, including, E. coli, etc.

In an embodiment herein, the piezocatalyst herein may be employed to purify contaminated water by, for example, submerging the piezocatalyst in contaminated water, subjecting the piezocatalyst to vibrations; or ultrasonic vibrations, and optionally subjecting the piezocatalyst to a heat source such as sunlight. The piezocatalyst causes water to evaporate as water vapor, leaving behind contaminants. Without intending to be limited by theory, it is believed that such a process enables a highly-efficient and stable evaporation rate. The evaporated water vapor can be captured and condensed into liquid water, and even drinkable water, which is collected. Thus, the present invention may be applicable to one or more of, for example, wastewater remediation and/or purification, environmental remediation of polluted water sources such as lakes and rivers, desalinization, removal of heavy metals from contaminated water, etc.

In an embodiment herein, under ultrasonic (US) conditions and illumination; or 1 sun illumination, it is believed that the piezocatalyst herein may provide a high and stable water evaporation rate of, for example, from 0.5 kg H₂O/m²h to about 8 kg H₂O/m²h; or from about 1 kg H₂O/m²h to about 5 kg H₂O/m²h; or from about 1.5 kg H₂O/m²h to about 4 kg H₂O/m²h; or about 2.14 kg H₂O/m²h.

Without intending to be limited by theory, it is believed that the present piezocatalyst may promote tissue repair/regeneration by fighting or even killing microorganisms, such as bacteria. For example, when the piezocatalyst is attached to or in connected relation to a wound, it could possibly disable or otherwise kill microbes such as bacteria, viruses, etc., keeping wounds sterile and/or clean and thus speeding up a body's normal healing and repair functions.

For example, to fight microorganisms, a piezocatalyst may generate a built-in electric field when subject to mechanical stress such as ultrasonic vibration or immersion in stirring water. The electric field may promote the spatial separation of excited electrons and holes pairs, which then may trigger redox reactions of water to generate reactive oxygen species (ROS) to directly damage bacterial DNA, lipids, proteins, thus killing the microorganism.

In an embodiment herein, the piezocatalyst may be used as a bio sensor for biosensing. Being flexible and soft, the piezocatalyst may be conformable when attached to skin; or human skin. In such a situation, the piezocatalyst may generate relevant electrical signals in response to mechanical stress caused by the motions of user (upon whose skin the piezocatalyst is placed), for example, as caused by skin wrinkling, muscles flexing, joints bending, etc.

In an embodiment of the present invention, the alkaline earth metal in the piezocatalyst may contain from about 75% to about 100%; or from about 85% to about 100%; or from about 95% to about 100%; of a single alkaline earth metal; or may be a single alkaline earth metal. Without intending to be limited by theory, it is believed that when a majority, or all, of the alkaline earth metal is a single-atom alkaline earth metal, then the catalytic reaction may be a single-atom catalyst, where the catalytic reaction is driven by the single atom.

It is believed that while transition and basic metals are known in creating piezoelectric materials, plentiful alkaline earth metals are much less explored for use in piezocatalysis. Calcium (Ca) is one of the cheapest and most biocompatible metals, and is the fifth most abundant element in the earth's crust. Therefore, in an embodiment herein the alkaline earth metal useful herein is calcium (Ca), as it is believed that applying Ca in catalytic reactions is sustainable, economical, and environmentally-friendly. Recent theoretical and experimental evidence demonstrates that atomically confined Ca in nitrogen-doped graphene can be an effective heterogeneous catalyst for electrocatalytic and photocatalytic hydrogen evolution reactions. However, there appear to be no reports on the use of single atoms of alkaline earth metals in piezocatalysis.

In an embodiment herein, the alkaline earth metal, such as calcium, and additional materials are added to an organic solvent, such as 2-methylimidazole (2-MIM), and well-mixed. Then the well-mixed solution is heated to obtain a gel-like form, from which nanocrystals of Calcium-loaded ZIF-8 (Ca@ZIF-8) are separated by centrifugation and then heated with high temperature to get Ca-embedded Nitrogen-doped Carbon (Ca—NC) in a dry powder form. This process obtains a Ca-doped NC powder, namely an alkaline earth metal coupled carbon. This ZIF-8 nanocrystal (in powder form) is mixed with the polymer which will form the polymer membrane. The polymer membrane may possess many properties, of which being a piezocatalyst is just one. In an embodiment herein, the entire polymer membrane shows a piezocatalyst effect.

In an embodiment herein, the piezocatalyst further contains calcium-atom-embedded nitrogen-doped carbon (Ca—NC).

In an embodiment herein, a method for manufacturing a piezocatalyst includes the steps of providing an alkaline earth metal selected from the group of beryllium (Be), magnesium (Mg), calcium (Ca), Strontium (Sr), and barium (Ba), providing a nanocrystal precursor, providing an organic solvent, mixing the alkaline earth metal, nanocrystal precursor and the organic solvent to form a mixture, heating the mixture to form a nanocrystal mixture containing a plurality of nanocrystals, separating the plurality of nanocrystals from the nanocrystal mixture, drying the plurality of nanocrystals at a drying temperature of from about 10° C. to about 100° C. for a drying time of about 2 hours to about 24 hours, to form dried nanocrystals. The method further includes the step of providing a polymer source selected from the group of polyvinyl acetate (PVA), polydimethyl silane (PDMS), polyurethane (PU), nylon, polyethylene, cellulose, polytrifluoroethylene (PTFE), polyvinylidene fluoride (PVDF), and a mixture thereof, dispersing the dried nanocrystals in a polymer source to form a polymer mixture, and forming a polymer membrane from the polymer mixture.

In an embodiment herein, the alkaline earth metal may be selected from the group of Ba, Mg and Ca; or Mg and Ca; or Ca. Without intending to be limited by theory, it is believed that calcium may provide synergistic effects with the polymer membrane, especially if the polymer source is PVDF.

In an embodiment herein, the organic solvent is selected from the group of propyl alcohol, n-butyl alcohol, acetonitrile, N-methyl-2-pyrrolidone, ethanol, methanol, acetone, tetrahydrofuran, and a combination thereof; or N-methyl-2-pyrrolidone, ethanol, methanol, acetone, tetrahydrofuran, and a combination thereof; or N-methyl-2-pyrrolidone;

In an embodiment herein the drying temperature is from about 15° C. to about 80° C., or from about 20° C. to about 60° C. In an embodiment herein the drying time is from about 3 hours to about 18 hours; or from about 5 hours to about 12 hours.

In an embodiment herein the polymer source may be selected from the group of polyvinyl acetate (PVA), polydimethyl silane (PDMS), polyurethane (PU), nylon, polyethylene, cellulose, polytrifluoroethylene (PTFE), polyvinylidene fluoride (PVDF), and a mixture thereof; or polyvinylidene fluoride (PVDF). Without intending to be limited by theory, it is believed that PVDF may provide synergistic benefits when combined with, for example, Ca, as proven by DFT.

In an embodiment herein, the nanocrystal contains acetylacetone (acac).

In an embodiment herein, the separation step employs centrifugation, especially at a typical centrifugation speed of from about 1,000 RPM to about 10,000 RPM, for a centrifugation time of from about 1 min. to about 10 min.

In an embodiment herein, the forming step contains the steps of providing a glass plate, casting the polymer mixture onto the glass plate, immersing the glass plate into water to cure the polymer mixture into a polymer membrane, and removing the polymer membrane from the glass plate. Without intending to be limited by theory, it is believed that these steps provide a simple, quick, and cost-effective forming step for piezocatalytic membranes.

In an embodiment herein, an environmental remediation method includes the steps of providing the piezocatalyst as described herein, exposing the piezocatalyst to water and an environment in need of remediation, vibrating the piezocatalyst to generate a reactive oxygen species (ROS), and exposing the environment in need of remediation to the ROS. Without intending to be limited by theory, it is believed that the environmental remediation method herein may provide fast, efficient, and/or cost-effective remediation of, for example, wastewater, contaminants, microorganisms, chemicals, organic contaminants, etc.

In an embodiment herein, the vibrating step of the environmental remediation method occurs at a frequency of from about 0.1 kHz to about 120 kH, or from about 1 kHz to about 100 kHz, or from about 20 kHz to about 50 kHz, or about 40 kHz. Without intending to be limited by theory, it is believed that such frequencies provide sufficient energy to cause the piezocatalyst to generate ROS and perform its environmental remediation functions.

The vibrations to activate and energize the piezocatalyst may be provide via many methods. In an embodiment herein, the vibrating step may be provided via, for example, ultrasound (US), a stirring bar, or other high- to mid-frequency vibrations. In an embodiment herein, the vibrating step may be provided slow-frequency movement such as when the piezocatalyst is attached to the skin of an animal or other body, etc. In an embodiment herein, the power of the vibrating step herein is from about 30 W to about 500 W, or from about 40 W to about 380 W, or from about 80 W to about 300 W.

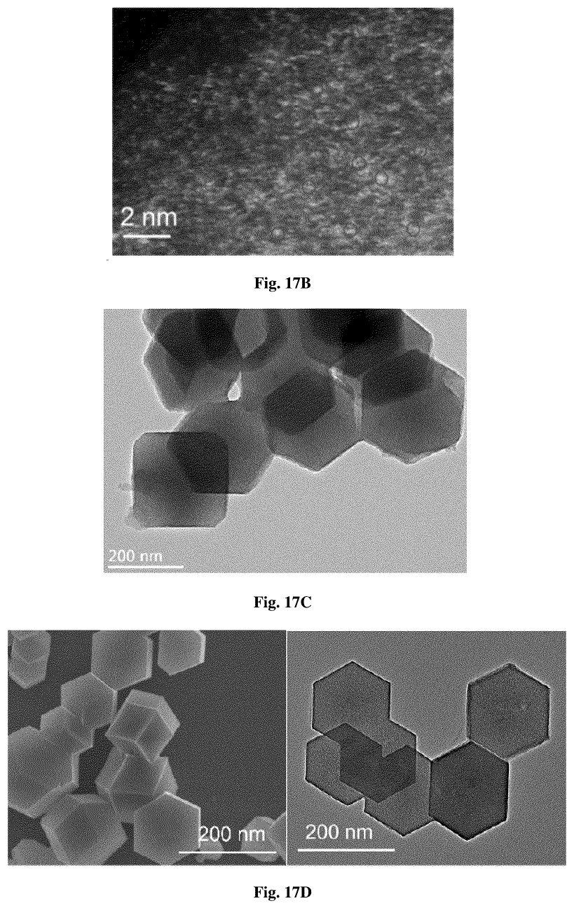

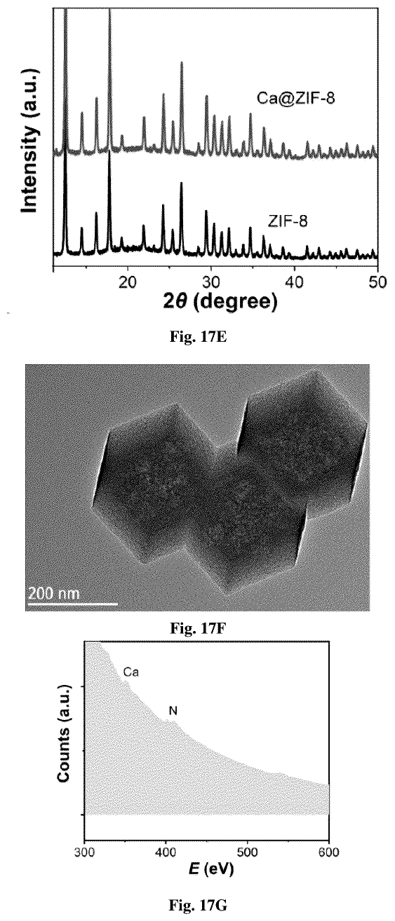

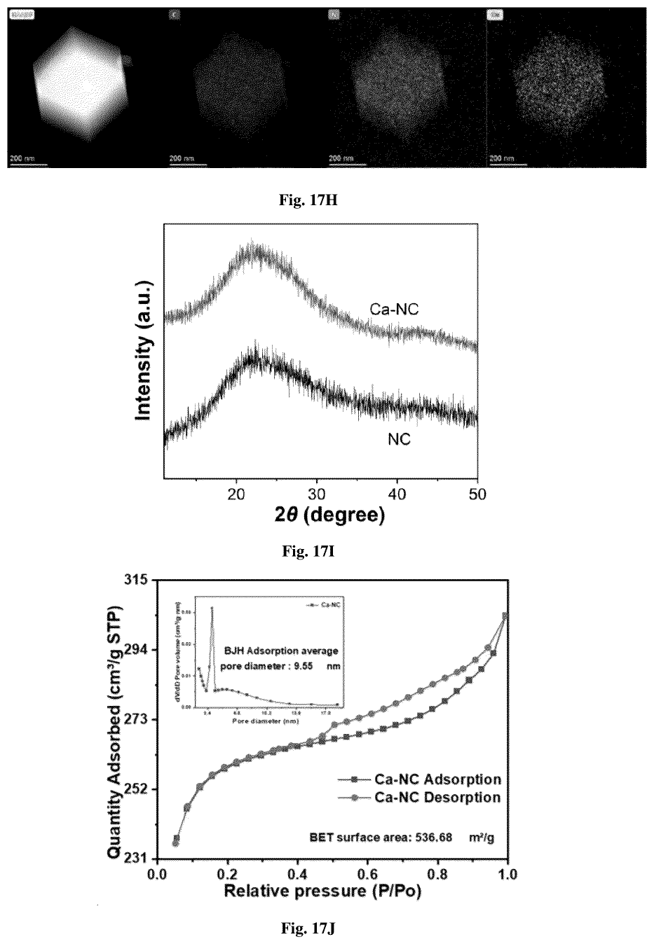

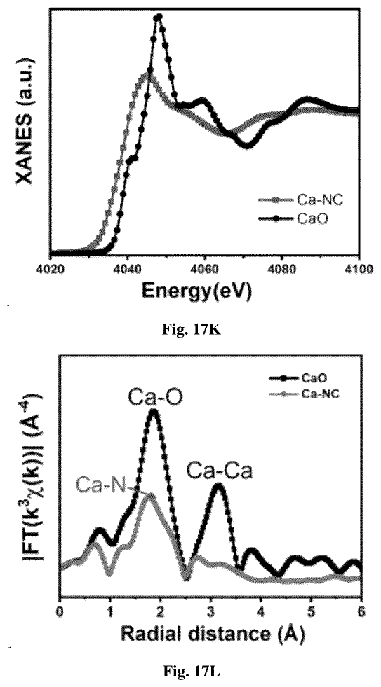

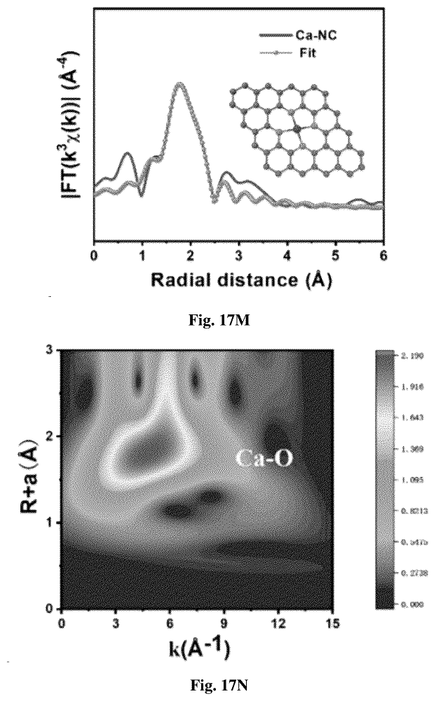

Turning to the Figures, FIG. 17 characterize an embodiment of the Ca—NC herein. Specifically, FIG. 17A shows a schematic of an embodiment of a Ca—NC synthesis herein. Specifically, the Ca and Zn ions added may self-assemble in solution to for a dummy (e.g., a substrate) surrounded by coordination polyhedra. This is then subject to pyrolysis which forms a polymeric membrane on the surface of the dummy/substrate. Generally, no observable Ca peaks are found in the XRD patterns, indicating that there is no detectable metallic Ca grain on the samples, and also confirming that the main composition in the Ca—NC is amorphous carbon and that Ca in the Ca—NC is about 1.9% (via inductively coupled plasma optical emission spectroscopy, IEP-OES). This is also confirmed via FTEXAFS spectra of the Ca—NC.

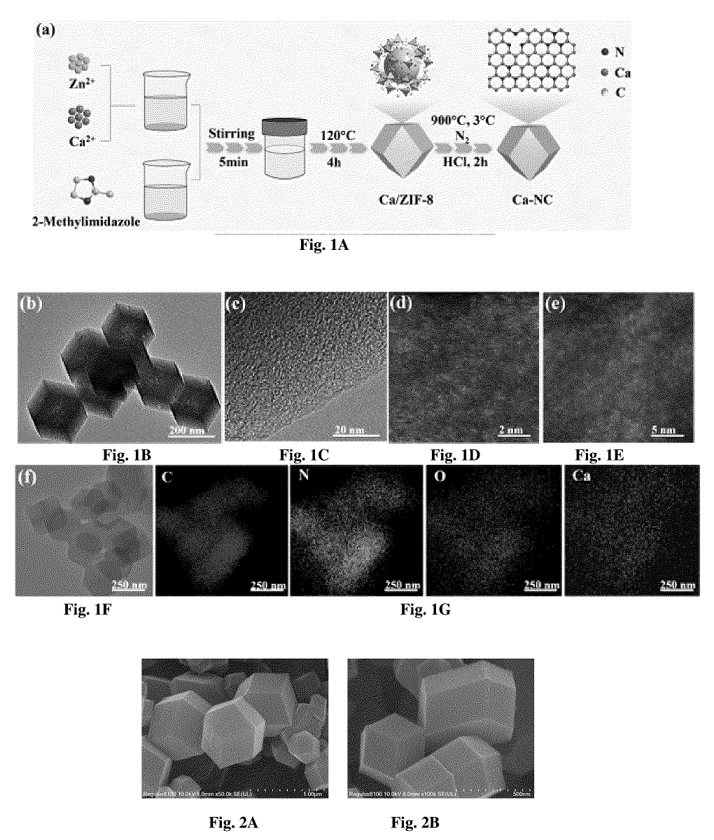

FIG. 17B shows an aberration-corrected high-angle annular dark-field scanning transmission electron microscopy (HAADF-STEM) image of FIG. 1A. In such an embodiment, the Ca atoms can be observed as the isolated bright spot on the substrate. See also FIG. 17H, which shows a HAADF-STEM image and its corresponding energy-dispersive A-ray spectroscopy (EDS) mapping of C, N, Ca and the Ca—NC, which indicate that the Ca, C and N elements are uniformly-distributed throughout the sample.

FIG. 17G shows an electron energy loss spectroscopy (EELS) spectrum of an embodiment of the Ca—NC herein. This figure verifies that the Ca and N components exist in the sample.

FIG. 17M shows a best-fit EXAFS result of an embodiment herein. The embodiment reveals a Ca—N contribution to Ca—NC of a coordination number of 4.

FIG. 17J shows a Brunauer-Emmett-Teller (BET) surface area analysis and Barrett-Joyner-Halenda (BJH) pore size and volume analysis of an embodiment of the Ca—NC herein. These analyses reveals a Ca—NC exhibiting a porous structure with a large specific surface area (536.68 m²/g) and an average pore diameter (9.55 nm), which was advantageous for exposing the Ca active sites

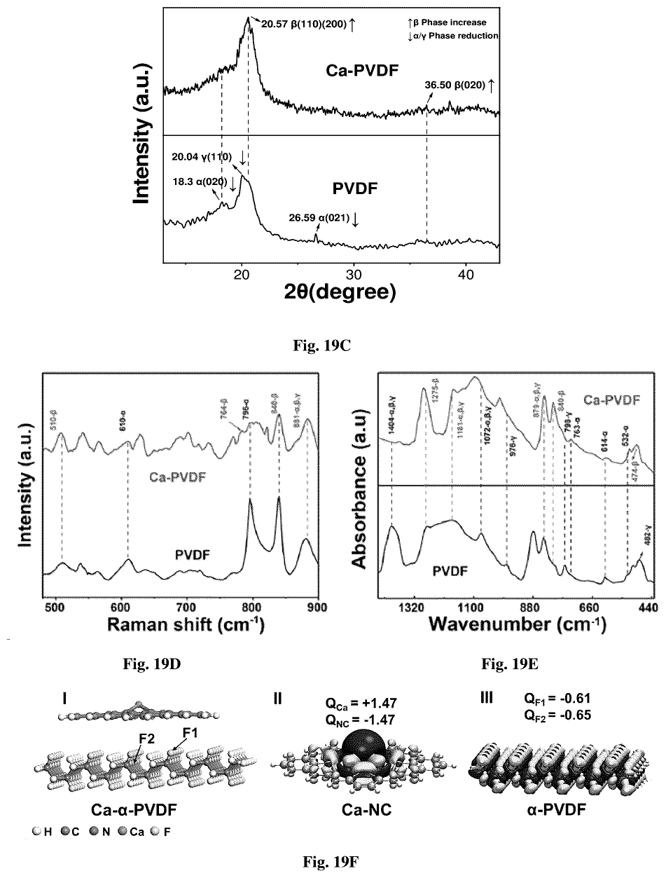

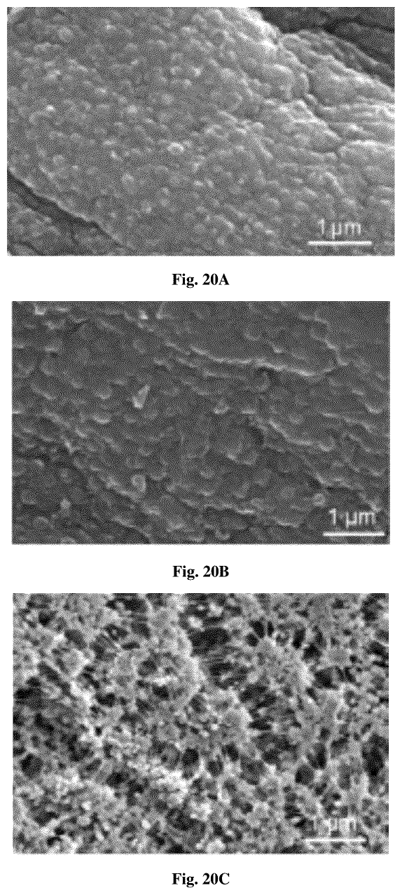

FIG. 19 characterize an embodiment of the Ca-PVDF membrane herein. Specifically, FIG. 19A shows a schematic diagram of the Ca-PVDF manufacturing method herein. It can be seen that the hybrid membrane of Ca-PVDF containing the Ca—NC and PVDF piezo-polymer is fabricated by a traditional phase-inversion method.

FIG. 19C shows a graph of XRD intensity of raw PVDF and an embodiment of the Ca-PVDF herein. This figure shows that both membranes contain the PVDF α, β, and γ phases. The decreased X-ray diffraction (XRD) intensity at 18.30° manifests the reduced a phase proportion in the Ca-PVDF membrane compared with the raw PVDF membrane, while a much stronger peak at 20.57° suggests the improved β phase ratio.

FIG. 19C shows a graph of Raman shift v. intensity of an embodiments of FIG. 19C. Signals at 610 and 796 cm⁻¹ are characteristic peaks of the α-phase, while those at 840, 764, and 510 cm⁻¹ correspond to the β-phase. The peak at 881 cm⁻¹ is common for all three α-, β- and γ-phases. The Raman results show that the Ca-PVDF membrane herein contains an increased β-phase which in turn may provide increased piezocatalytic potential. Fourier transform infrared (FITR) spectra analysis shows similar increased β-phase results. Thus, it is believed that the addition of Ca—NC significantly enhances the α-to-β phase transition in the Ca-PVDF membrane and to significantly and unexpectedly enhance the spontaneous polarization of the Ca-PVDF membrane.

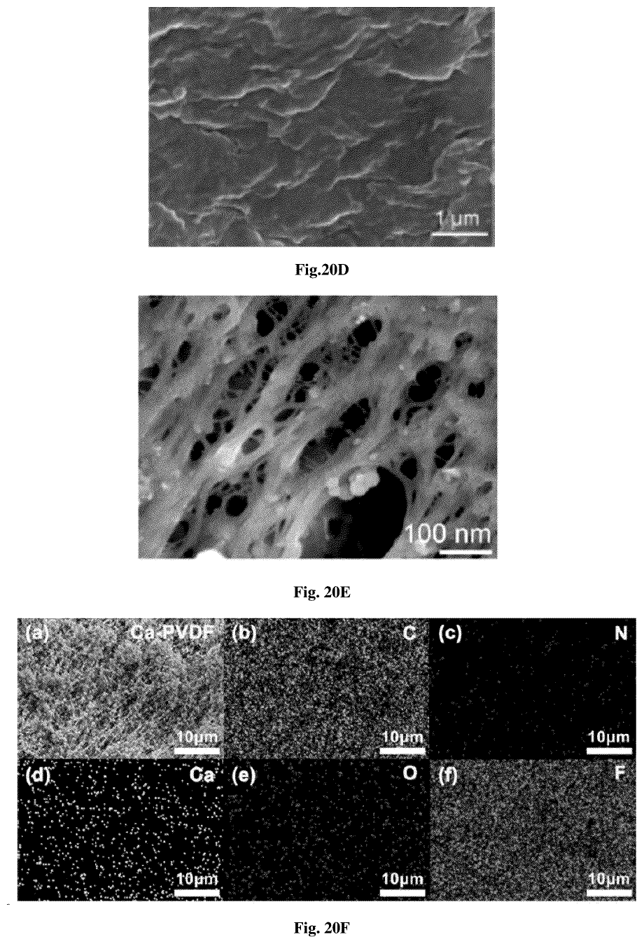

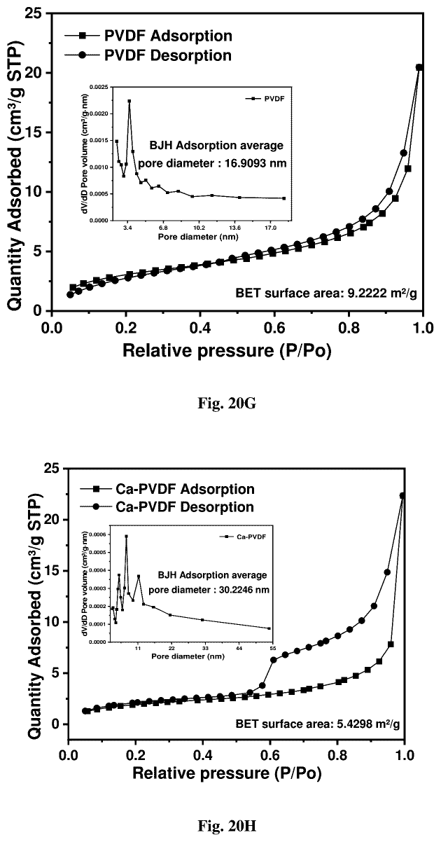

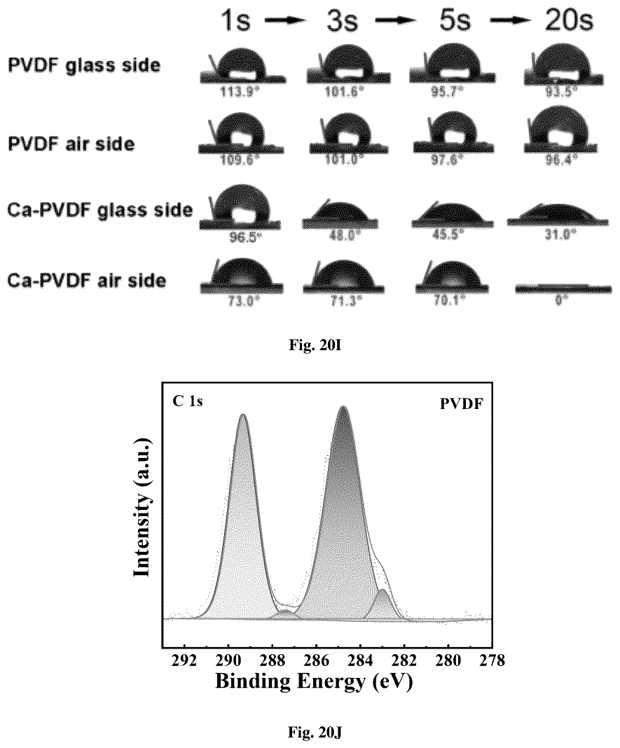

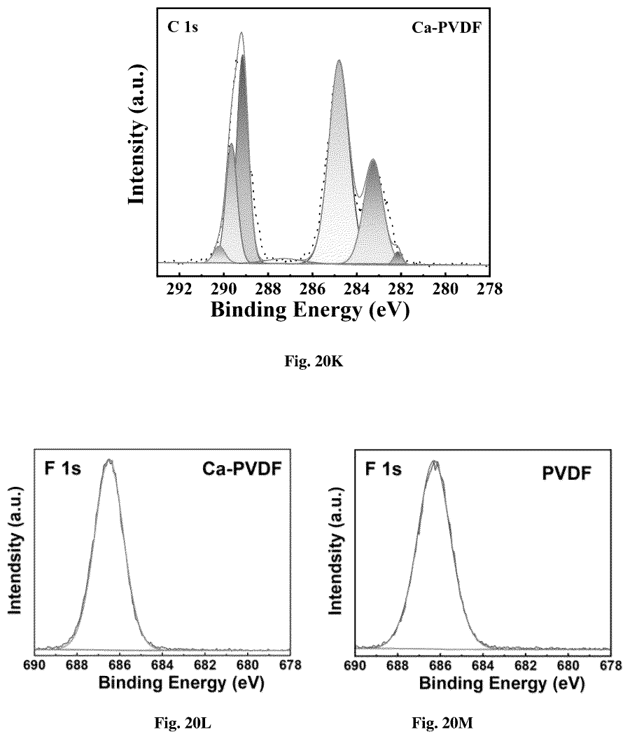

FIG. 20A shows a scanning electron microscope (SEM) image of the “air” side of a PDVF membrane, while FIG. 20B shows a SEM image of the “glass” side of a PDVF membrane. In contrast, FIG. 20C shows a SEM image of the “air” side of an embodiment of the Ca-PVDF membrane herein, while FIG. 20D shows a SEM image of the “glass” side of an embodiment of the Ca-PVDF membrane herein. The side of the membrane contacting the glass substrate during the membrane fabrication is hereafter referred as the “glass side”; the other surface is referred as the “air side”. As can be seen, the surface morphologies of the Ca-PVDF membranes show significant differences. Without the Ca—NC nanoparticles, the two sides of the pristine PVDF membrane show dense surfaces and similar morphologies. While the glass side of the Ca-PVDF membrane (FIG. 20D) also has a dense surface, the air side (FIG. 20D) shows a highly porous surface. Without intending to be limited by theory, it is believed that the porous Ca-PVDF structure consists of many interconnected fibers decorated with spherical particles.

FIG. 20E shows a high magnification SEM image of the “air” side of an embodiment of the Ca-PVDF membrane herein. This image shows that there are also many interconnecting fibers of a few nanometers scale. The co-existence of the micro- and the nanoscale structures is crucial for obtaining wetting behavior according to the Cassie model derived from Young's equation. It appears that the Ca—NC particles are well dispersed in the PVDF matrix, which can be confirmed by the uniformly distributed Ca, O, and N elements in the Ca-PVDF membrane.

FIG. 20G shows graphs of BET and BJH analyses of a PVDF membrane and FIG. 20H shows graphs of BET and BJH analyses of an embodiment of an embodiment of the Ca-PVDF membrane herein. These graphs show that introducing the Ca—NC additives, when forming a Ca-PVDF membrane of the present invention (FIG. 20H), increases significantly increase the porosity and creates much larger pores compared to the pristine PVDF membrane (FIG. 20G).

FIG. 20I shows photos of the contact angles for PVDF and an embodiment of the Ca-PVDF herein. These photos show that the (pristine) PVDF has a highly hydrophobic initial contact angle of from 109.6° to 113.9° after 1 second and maintains a high contact angle of 93.5°-96.4° after 20 seconds. In contrast, the Ca-PVDF membrane herein provides a initial contact angle of from 73° to 96.5° after 1 second and has a contact angle of from 31° to 0° after 20 seconds. Without intending to be limited by theory, it is believed that this porous structure and reduction in hydrophobicity and in fact, hydrophilicity, may provide easier access to solutions throughout the Ca-PVDF membrane to facilitate piezocatalytic reactions, a higher binding energy via dipole interaction in the Ca-PVDF vs. PVDF alone, and strong Ca—NC to PVDF electrostatic interaction, potentially-resulting in significantly-faster piezocatalysis.

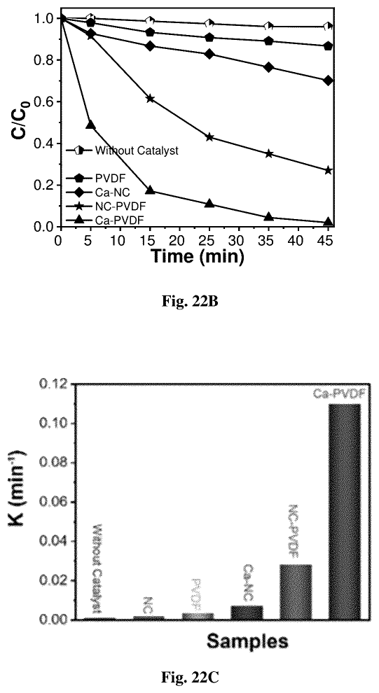

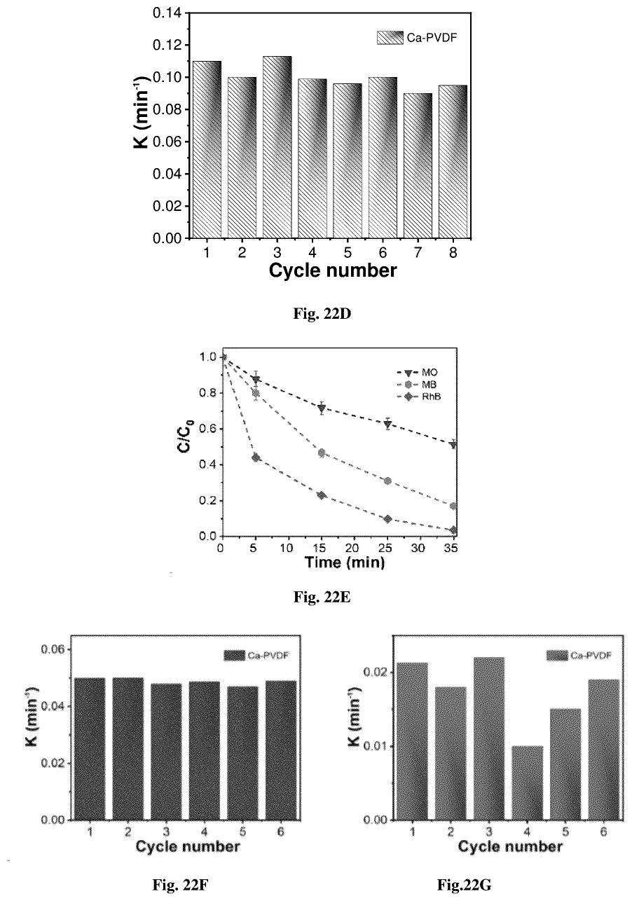

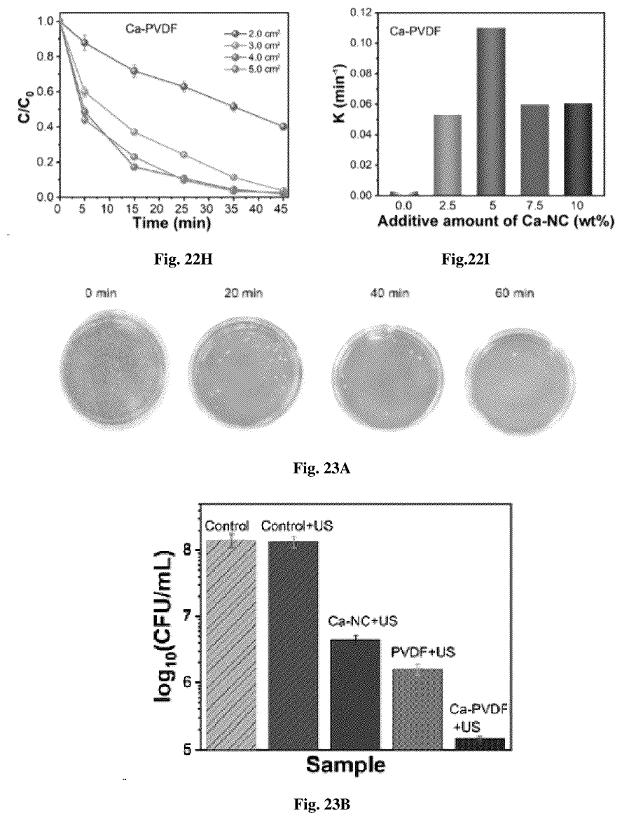

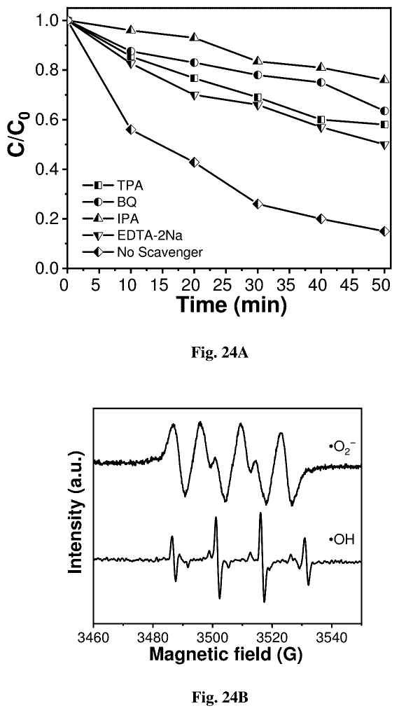

FIGS. 22A-22D describe degradation performance of Ca-PDVF. Specifically, FIG. 22A is a graph showing piezoelectric performance of recently-reported materials and an embodiment of the present invention. FIG. 22B is a graph comparing RhB degradation across various piezocatalysts. FIG. 22C is a graph comparing the reaction constants of various piezocatalysts. FIG. 22D is a graph showing the degradation rate vs. cycle number of an embodiment of the Ca-PVDF herein.

FIGS. 23A and 23B describe the antimicrobial efficacy of an embodiment herein. Specifically, FIG. 23A shows photographs of E. coli colonies on agar plates over time. In the figure, it can be seen that while a significant number of colonies exist at 0 min, after 20 min US treatment, most of the colonies are destroyed. After 40 minutes US treatment, even more colonies are destroyed, and after 60 min US treatment, almost all colonies are destroyed. FIG. 23B shows the comparative antibacterial efficacy against E. coli after 0 and 60 minutes US treatment. The leftmost sample “Control” lacks y piezocatalyst and is subject to no US treatment, while the other 4 samples are subject to 60 min US treatment. As can be seen, “Control+US” which indicates no piezocatalyst, but US treatment for 60 minutes shows no significant reduction in colonies. The middle sample, with Ca—NC and 60 minutes US treatment results in more than a 1 log colony reduction. The “PVDF+US” sample shows a slightly higher reduction than the Ca-NC+US sample. However, the “Ca-PVDF+US” sample shows about a significant 3 log reduction in E. coli colonies.

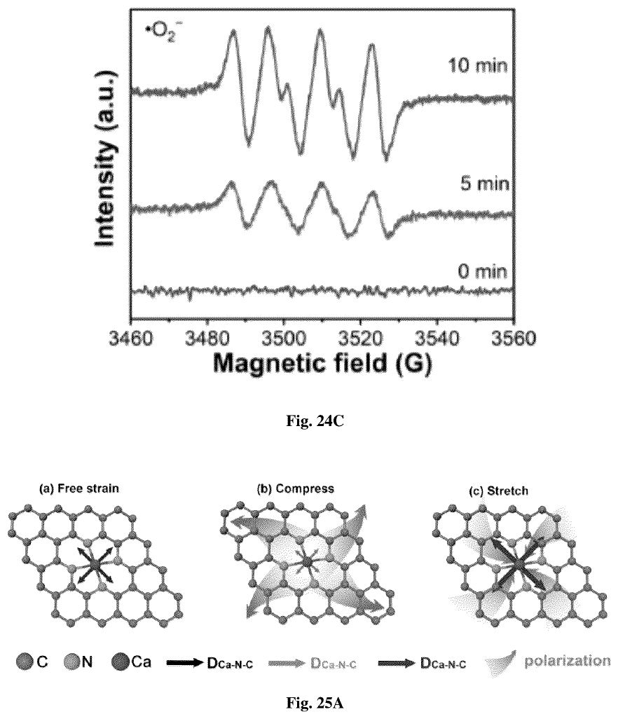

FIGS. 24A to 24C show piezocatalyst ROS analysis. Specifically, FIG. 24A is a graph showing the effect of ROS scavengers on RhB degradation of an embodiment herein. FIG. 24B is a graph showing the DMPO-·OH peaks and the DMPO-·O₂ peaks. FIG. 24C is a graph showing the increase of the DMPO-·O₂ signal peaks over time.

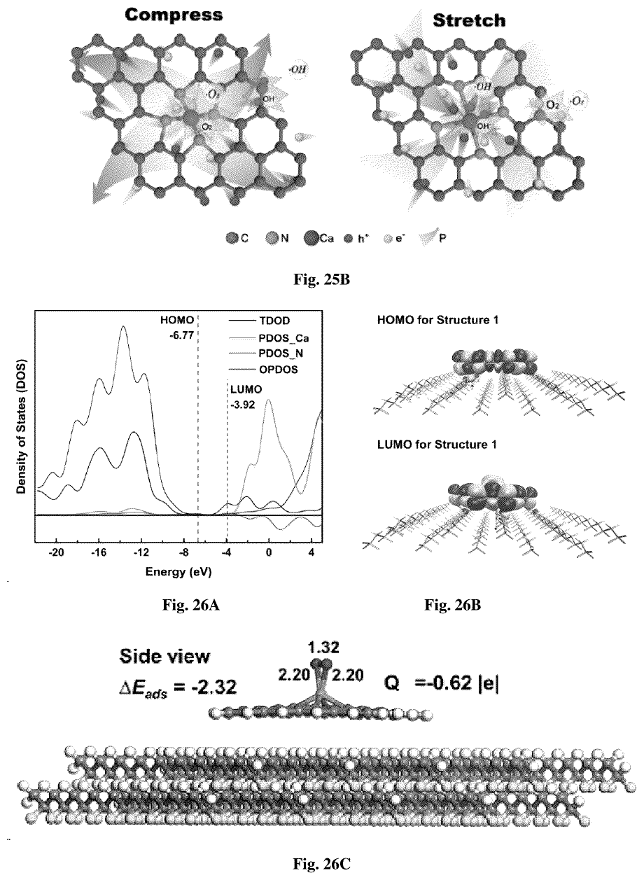

FIG. 25A is a schematic diagram showing different stress states of spontaneous dipole polarization. The compression of the Ca-PVDF herein may create a significant local dipole moment which enhances piezoelectricity. FIG. 25B is a schematic diagram showing the compression and stretching of an embodiment of the Ca-PVDF herein.

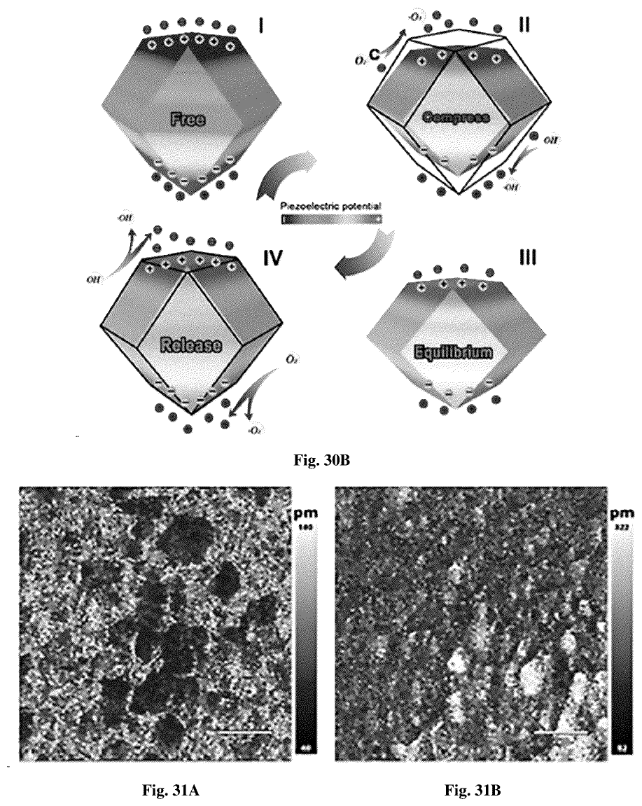

FIG. 30B is a schematic diagram of an embodiment of the Ca-PVDF herein at different piezocatalytic states.

### EXAMPLES

### Example 1

### Synthesis of Ca/NC

### 1. Chemical Reagents

Zinc nitrate hexahydrate (Zn(NO₃)₂·6H₂O), 2-methylimidazole (2-MeM), calcium chloride (CaCl₂)), methanol (CH₃OH), and absolute ethanol (C₂H₅OH) are provided by Sinopharm Chemical Reagent Co., Ltd. (Shanghai, China). Rhodamine B (RhB), acid orange 7 (AO7), methyl orange (MO), methyl blue (MB), disodium ethylenediaminetetraacetate (EDTA-2Na), tert-butyl alcohol (TBA), benzoquinone (BQ), isopropanol IPA, 5,5-dimethyl-1-pyrrole N-oxide (DMPO) were all purchased from China Aladdin Chemical Co., Ltd. Deionized water (DI) is prepared by ultrapure water generator (UPT-II-T). All reagents are commercially available and can be used without further purification.

### 2. Synthesis of Ca/NC

ZIF-8 coated Ca(Ca/ZIF-8) is prepared by hydrothermal method, and then Ca/NC is prepared by pyrolysis of Ca/ZIF-8 template. Specifically, Zn(NO₃)₂·6H₂O (0.594 g, 2.0 mmol) and CaCl₂) (0.111 g, 1.0 mmol) are simultaneously dissolved in 7.5 ml of methanol to form clear solution A, and 2-methylimidazole (0.656 g, 8.0 mmol) is dissolved in 15 ml of methanol to form solution B. Solution A is quickly mixed with Solution B under vigorous stirring for 5 minutes to form a uniform suspension. The mixed solution is then moved to a 50 mL PTFE-lined stainless-steel autoclave, placed in an oven, heated to 120° C. and maintain the temperature for 4 hours. Then, the autoclave is cooled down to room temperature. After centrifugation for 5 minutes at rate of 4,000 rpm, the solution is then re-dispersed into ethanol and centrifuged to collect the particles. Repeat the process for four times. Finally, the resultant is dried in a vacuum oven at 60° C., the precursor Ca/ZIF-8 nanoparticles of Ca/NC is obtained.

Place the precursor Ca/ZIF-8 nanoparticles in a tubular furnace, heat it to 900° C. (heating rate 5° C./min) under Ar₂ (50 mL/min) atmosphere, and keep it at this temperature for another 3 hours. The calcined material is then pickled with 3 M HCl to remove unstable calcium from the skeleton. The final sample is centrifuged and washed alternately with ethanol and distilled water for three times, and dried in a vacuum oven at 60° C. to obtain Ca/NC catalyst. NC sample is also prepared by this method, but no metal precursor is added.

FIG. 1 shows the process of preparing ZIF-8 coated Ca(Ca/ZIF-8) by hydrothermal method and calcining to prepare Ca/NC. Zinc nitrate hexahydrate, calcium chloride and dimethylimidazole are used as raw materials, which are realized by hydrothermal and further carbonization in methanol solvent. Further acid etching can not only remove residual zinc and calcium, avoid secondary pollution, but also generate more mesopores on the original structure of MOF, promote pollutant adsorption and generate more surface catalytic reaction active sites.

### Example 2

### Characterization of the Ca/NC

### 1. Methods

X-ray diffraction (XRD) measurement is performed from 10° to 80° using Bruker D8 Advance to analyze the crystalline phase of the sample. The morphology of the samples is characterized by transmission electron microscopy (TEM, FEOL JEM 2100F) and energy dispersive X-ray spectroscopy (EDS). High angle annular dark field (HAADF) scanning transmission electron microscope (STEM) images are detected using JEOL JEM-ARM200F microscope combined with STEM spherical aberration correction system. The chemical groups and bonding properties of the materials are characterized by X-ray spectrometer (Thermo Fisher Escalab 250xi). Electron paramagnetic resonance (ESR) spectrometer (Bruker A300) is used to detect active substances in piezocatalysis process. In order to analyze the specific surface area and pore size distribution of the sample, the Micromeritics ASAP 2460 system is used to obtain N₂ adsorption desorption. Use Horiba OLYMPUS BX41 Raman spectrometer to test the Raman spectrum. Fourier transform infrared (FT-IR, IRPrestige-21) spectroscopy is used to record the Fourier transform infrared spectrum in the range of 500-3000 cm-1. X-ray absorption near edge spectroscopy (XANES) and extended X-ray absorption fine structure spectroscopy (EXAFS) are conducted in transmission mode using beam line XAFCA in Singapore Synchrotron Radiation Light Source (SSLS). PFM measurement is carried out on a commercial piezoelectric response microscope (Bruker Dimension Icon).

### 2. Microstructure Analysis

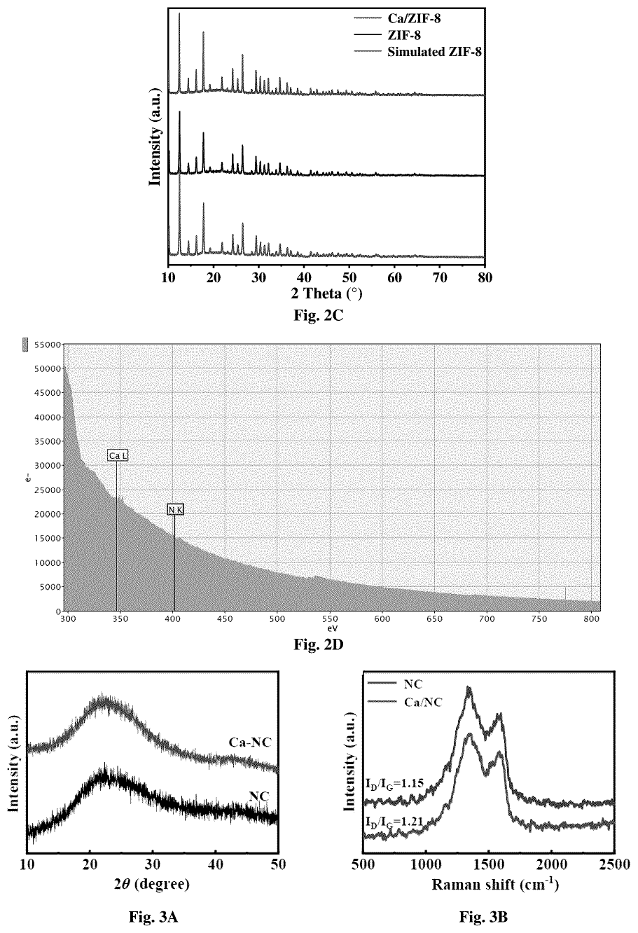

The piezocatalyst Ca/NC obtained in Example 1 is used for further characterization. Morphology studies show that the introduction of Ca does not affect the structure of ZIF. SEM images of ZIF-8 and Ca/ZIF-8 materials show similar regular dodecahedron morphology (FIGS. 2A and 2B). The powder XRD spectrum (FIG. 2C) shows that ZIF-8 and Ca/ZIF-8 have similar crystal phases.

The morphology of Ca/NC is characterized by transmission electron microscopy (TEM). As shown in FIG. 1B, the TEM image of Ca/NC after high-temperature pyrolysis still shows a standard dodecahedron structure, indicating that high-temperature treatment will not affect the structure of the material, which proves the high-temperature stability of Ca/NC materials. The high-resolution TEM image (FIG. 1C) shows that there is no obvious lattice stripe, and it is mainly composed of amorphous structure. The energy dispersive X-ray element mapping spectrum (EDS) image shows that the elements C, N, O and Ca are evenly distributed in Ca/NC, as shown in FIG. 1F. In order to clarify the existence form of Ca, aberration correction HAADF-STEM characterization of atomic resolution is realized. As shown in FIG. 1D-E, a large number of Ca atoms are dispersed in the carbon skeleton, which further provides a basis for the anchoring of a single atom of Ca in the carbon framework by N atoms and C atoms. In addition, the existence of Ca and N is confirmed by electron energy loss spectroscopy (EELS). At about 350 eV and 400 eV, there are two peaks distributed on the characteristic Ca L side and N K side respectively, which also provides strong evidence that the existence form of Ca element in Ca/NC is a single atom (FIG. 2D).

It can be seen from the X-ray diffraction pattern (XRD) (FIG. 3A) that NC and Ca/NC show characteristic peaks of carbon near 25° and 44°, corresponding to (002) and (101) diffracted carbon respectively. The XRD spectra of Ca/NC only diffracted graphite carbon, and no other diffraction is detected. This result is consistent with that of HRTEM. The obtained Raman spectra are featured by peaks at ˜1358 and 1590 cm⁻¹, corresponding to the disorder and defects in the sp²-hybridized carbon system (D band) and the in-plane C—C bond stretching mode of sp² carbons (G band), respectively, as shown in FIG. 3B. Therefore, I_{D}/I_{G} is related to the defect degree of carbon materials. The I_{D}/I_{G} value of Ca/NC (1.21) is higher than that of NC (1.15), indicating that the implantation of Ca atoms leads to more structural defects in the carbon matrix and provides rich Ca—N₃ active sites, which can improve the piezocatalytic performance of the catalyst. The specific surface area and pore size distribution of Ca/NC are obtained by measuring N₂ adsorption/desorption isotherms (FIG. 3C-D). The larger specific surface area and total pore volume are conducive to the contact between the catalyst surface and organic dyes, providing more exposed active sites for piezocatalytic reaction, thus obtaining amazing performance. Ca/NC has a BET surface area of 921.2 m²/g and a total pore volume of 0.54 cm³/g, while NC has a BET surface area of 810.6 m²/g and a total pore volume of 0.43 cm³/g. The larger specific surface area and total pore volume of Ca/NC are conducive to effective mechanical capture, rapid transfer of charge carriers and adsorption of organic dyes, and thus conducive to the degradation of organic dyes.

### 3. Chemical State and Active Site Analysis

In order to further study the chemical state of atoms in the Ca/NC piezocatalyst obtained in Example 1, X-ray photoelectron spectroscopy (XPS) is used to analyze the Ca/NC piezocatalyst. FIG. 4A shows the full energy spectrum of Ca NC, indicating that we have successfully prepared materials containing C, N, O and Ca. In order to explore the atomic configuration of Ca/NC, the spectra of C 1 s and N 1 s are deconvoluted into a single peak. As shown in FIG. 4C, the high-resolution C1 s peak of Ca/NC can be deconvoluted into three peaks, namely C═C (284.7 eV), C—N (285.7 eV) and C—C (288.2 eV). The addition of atomic calcium increases the relative content of C—N bonds from 31.9% to 34% (FIG. 4D), indicating that the N species obtained during the Ca coordination pyrolysis process are more stable. Nitrogen doping is considered to be an effective strategy to promote electron transfer and improve the catalytic performance of the catalyst. Therefore, it is necessary to discuss the type and content of nitrogen in the catalyst. FIG. 4F reveals that the N Is spectrum of Ca/NC can be decomposed into several types of N, which belong to pyridine-N (398.3 eV), pyrrole-N (399.5 eV), graphite-N (400.6 eV) and nitrogen oxides (404 eV) respectively. It is confirmed that N atoms are embedded in the carbon skeleton of Ca/N, but the mass percentage of each type of N atom in the catalyst is different (Table 1).

TABLE 1
Percentage of different bonds within the N1s spectrum in
the catalysts for Ca/NC and NC obtained by XPS

| | Binding | Atomic % of | |
|---|---|---|---|
| | Energy | bond (sample) | |
| Bond | (eV) | Ca/NC | NC |
| pyridinic N | 398.3 | 34 | 56 |
| pyrrolic N | 399.5 | 22 | 5 |
| graphitic N | 400.6 | 39 | 33 |
| N-oxide | 404 | 5 | 6 |

In the quantitative analysis, the content of graphite nitrogen (from 33% to 39%) is related to the formation of C—N bond after calcium atoms are added. Graphite nitrogen tends to retain carriers with high mobility, while Ca/NC with graphite nitrogen content up to 39% may show stronger piezocatalytic performance. And the pyrrole nitrogen concentration (increased by 22% from 5%) is related to the formation of defects in the carbon skeleton, which is generally considered as the adsorption site of organic pollutants. It can be seen from the Ca 2p spectrum (FIG. 4G) that the peaks at 347.2 and 350.8 eV correspond to Ca 2p_{3/2} and 2p_{1/2}, and there is no metal Ca 2p_{3/2} spectrum (344.9 eV), indicating that Ca exists in the catalyst as Ca²⁺.

The electronic structure and local coordination environment of monatomic calcium are further understood through X-ray absorption near edge structure (XANES) and extended X-ray absorption fine structure (EXAFS), which are used to reveal the structure of active sites. Because the Ca metal is very active in the air, the Ca K edge XANES spectrum of CaO is used as a calibration reference material. As shown in FIG. 5A, the near edge absorption spectrum of Ca/NC catalyst is close to the calcium containing reference (CaO), indicating that the Ca metal atom in Ca/NC is in a cationic state. This is consistent with the XPS spectrum (FIG. 4G). FIG. 5B shows the K-space diagram of Ca K-edge EXAFS. It is worth noting that the EXAFS curve of Ca/NC is obviously different from that of CaO. The Ca/NC uncorrected Ca k side Fourier transform (FT)-EXAFS curve shows that a main peak is at 2.1 Å, which is attributed to the Ca—N scattering path (FIG. 5C). Ca—O (1.8 Å) peak and Ca—O—Ca(3.1 Å) peak were not detected in Ca/CN, which confirmed that there was only calcium single atom in Ca/CN. The quantitative local coordination parameters of Ca atom are further revealed by least square EXAFS fitting (FIG. 5D and Table 2).

TABLE 2
EXAFS fitting parameters at the Ca K-edge for various samples (S₀² = 0.800)

| Sample | Shell | CN^{a} | R(Å)^{b} | σ²(Å²)^{c} | ΔE₀(eV) ^{d} | R factor |
|---|---|---|---|---|---|---|
| Ca—NC | Ca—N | 3.0 ± 0.4 | 2.270 ± 0.012 | 0.0076±0.0018 | −9.7 ± 1.3 | 0.0044 |

^{a}CN, coordination number;
^{b}R, the distance to the neighboring atom;
^{c}σ², the Mean Square Relative Displacement (MSRD);
^{d} ΔE₀, inner potential correction; R factor indicates the goodness of the fit. S0² was fixed to 0.800. Fitting range: 3.0 ≤ k (/Å) ≤ 12.1 and 1.0 ≤ R (Å) ≤ 3.0 (Ca—NC). A reasonable range of EXAFS fitting parameters: 0.700 < S₀² < 1.000; CN > 0; σ² > 0 Å²; |ΔE₀| < 10 eV; R factor < 0.02.

EXAFS fitting results show that the coordination number of the first shell is about 3, and the Ca—N bond length is 2.27 Å. It is worth noting that the fitting results of EXAFS show that the R-factor value of Ca—N₃ structure is 0.0044, which is in good agreement with the characterization results of the sample, indicating that Ca—N₃ is the active center of Ca/NC.

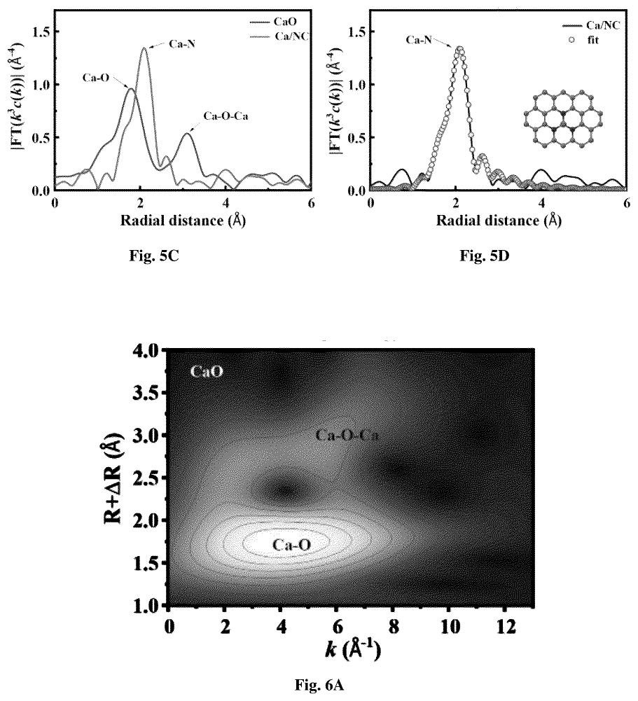

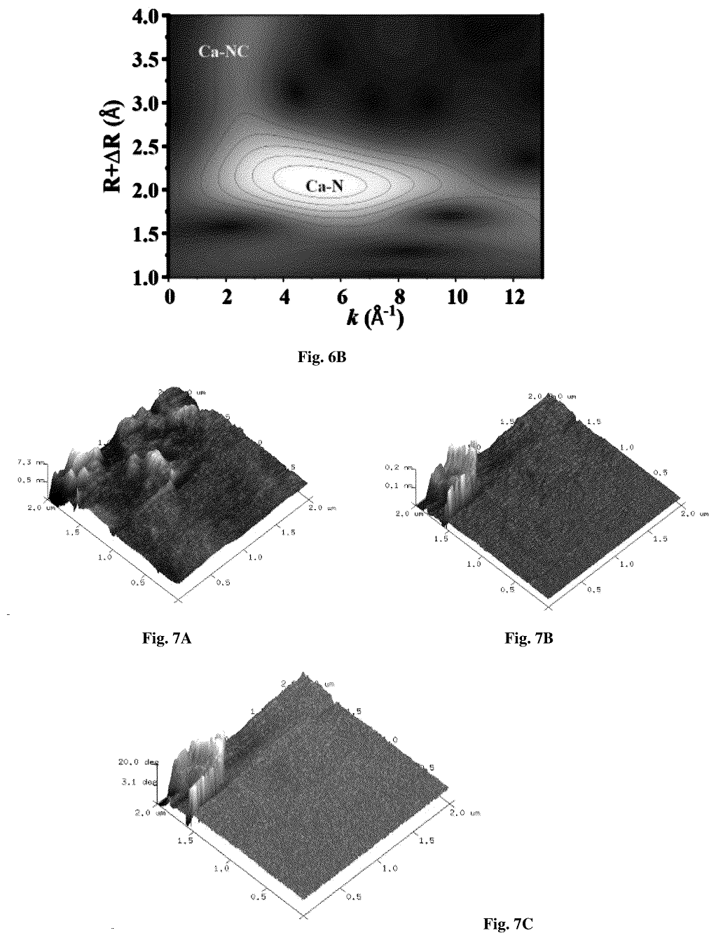

The wavelet transform (WT) is used to analyze the EXAFS oscillation on the Ca k side (FIG. 6B). Compared with the WT diagram of CaO in FIG. 6A, the maximum WT value of Ca/NC is 4.5 Å-1, which is allocated to Ca—N, but no Ca—O—Ca(4.0 Å⁻¹) is observed. It shows that Ca atom coordinates with N atom to form active site. The above results provide strong evidence for the successful synthesis of Ca/NC at the Ca—N₃ site by combining atomic dispersed Ca with three N atoms. It has been reported that the addition of heteroatoms will change the local charge distribution of surrounding atoms, thus changing the local dipole moment.

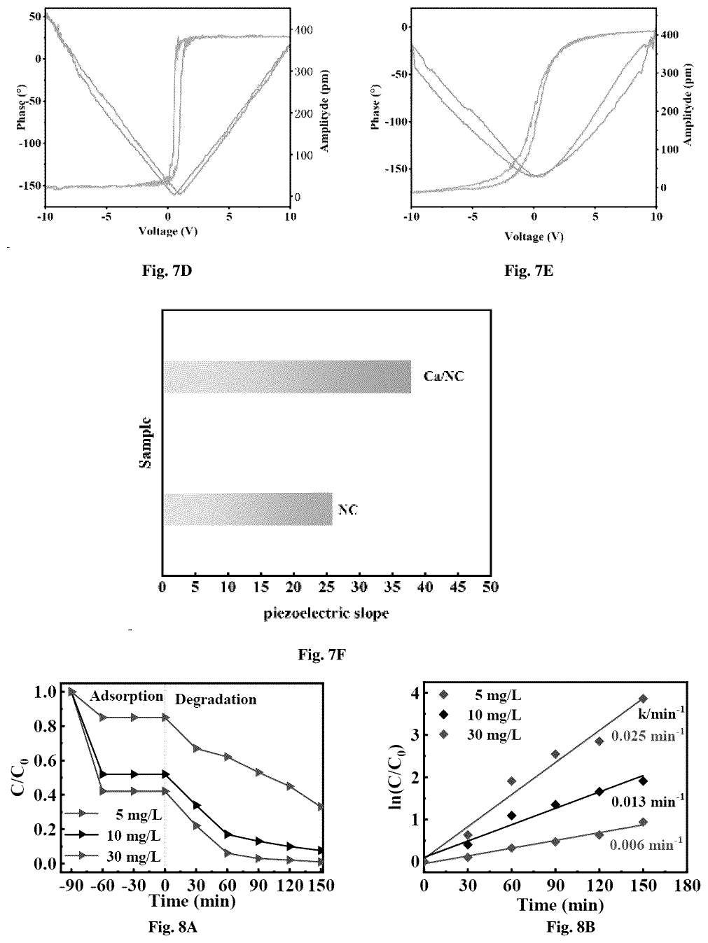

The piezoelectric properties of the samples are studied by PFM. The PFM amplitude mapping and phase mapping are completely consistent with the morphology mapping of the Ca/NC sample, indicating that the polarity is evenly distributed in the Ca/NC material (FIGS. 7A-7C). It should be noted that the piezoelectric inhomogeneity in this area may be caused by the disordered stacking of Ca/NC on the Si sheet due to uneven dispersion. In addition, the piezoelectric strength can be derived from the butterfly amplitude loop and phase curve. Under the −10 V-+10 V DC bias field, a local phase hysteresis loop and an amplitude butterfly loop are observed. The steep hysteresis loop means strong piezoelectric polarization (FIGS. 7D and 7E), which further confirms that Ca/NC has piezoelectric characteristic response and obvious polarization switching behavior in the piezoelectric domain. FIG. 7F shows that the estimated piezoelectric coefficient of the slope of the amplitude loop on different samples is about 38 pm/V, which is greater than 26 pm/V of NC. The results show that the introduction of Ca SA improves the piezoelectric response of NC significantly.

### Example 3

### Performance Tests and Degradation Mechanism of Ca/NC

### 1. Piezocatalytic Adsorption and Dye Degradation Performance Test

In this test, RhB is selected as the standard dye to evaluate its piezocatalytic degradation activity under ultrasonic vibration. Typically, 30 mg of catalyst is dispersed in 30 mL of RhB solution (5 mg/L). Then, the suspension is stirred in the dark at 400 rpm for 60 minutes to achieve a complete adsorption desorption equilibrium between catalyst particles and RhB molecules. Then put the mixture into an ultrasonic generator (120 W, 40 kHz), collect about 3 mL suspension every 30 minutes and centrifuge (8,000 rpm, 3 min) to remove catalyst particles. Degradation activity is measured using an UV-vis photo-spectrometer (Shimadzu, Japan UV-2550)

### 2. Free Radical Test

The purpose of free radical quenching test is to determine the concentration of reactive intermediates in the process of piezocatalytic degradation of dyes. In this experiment, 10 mM p-benzoquinone (BQ), tert-butyl alcohol (TBA), ethylene diamine tetracetic acid (EDTA-2Na) and isopropanol (IPA) were selected as scavengers to quench superoxide radicals (·02), hydroxyl radicals (·OH), positive charge (q′) and negative charge (e), respectively. The dye degradation experiments were carried out in the presence of various scavengers. In the electron paramagnetic resonance (ESR) experiment, 5 mg catalyst is added to 5 ml aqueous solution (for detecting hydroxyl radical) or methanol solution (for detecting superoxide radical) by mixing under ultrasonic wave. After that, 50 mM 5,5-dimethyl-1-pyrroline N-oxide (DMPO) spin capture reagent was added to the solution and placed in the ultrasonic generator (120 W, 40 kHz). After ultrasonic vibration for 10 minutes, measure the mixture sample with an electron paramagnetic resonance spectrometer.

### 3. Electrochemical Test

Piezoelectric electrochemical measurement is carried out in a standard three electrode system (CHI660E electrochemical station) under ultrasonic radiation (SCQ-250A ultrasonic cleaner, 120 W, 40 kHz). The three-electrode system consists of sample as working electrode, calomel as reference electrode and carbon rod as counter electrode. Use 0.1 M Na₂SO₄ solution as electrolyte. Fix the sample firmly on ITO glass with conductive adhesive. The preparation steps of the working electrode are as follows: uniformly disperse 10 mg of catalyst in 450 uL ethanol containing 50 uL Nafion. After ultrasonic treatment of the suspension for 30 min, use a pipette to take an accurate amount of 20 uL catalyst ink, drop it onto the ITO glass (1 cm²), and then air dry it at room temperature. Before the test, purge the reaction solution with nitrogen for 30 minutes to remove the dissolved oxygen in the electrolyte. According to the following formula, the potential of this working electrode has been converted from SCE to reversible hydrogen electrode (V vs. RHE):

$$E ( V vs . RHE ) = E ( V vs . SCE ) + 0.0 \; 591 pH + 0.242$$

### 4. Evaluation of the Adsorption Performance and Piezoelectric Activity

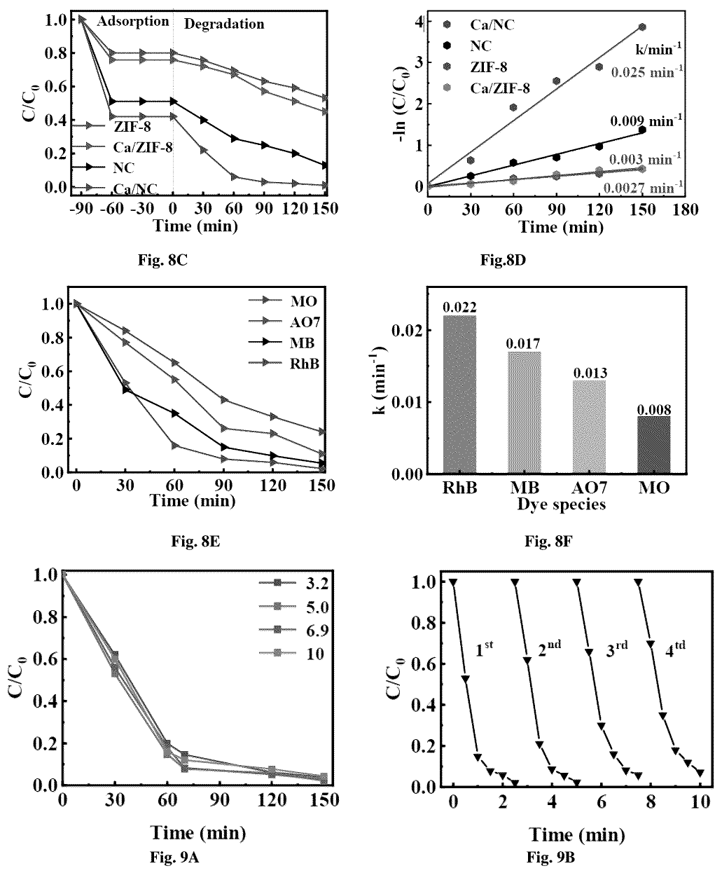

The influence of initial concentration (C₀) on Ca/NC pressure catalytic degradation performance is shown in FIG. 8A. It can be seen from the figure that the degradation efficiency changes with the initial concentration of RhB solution. It can be clearly seen from FIG. 8B that the deduced k value decreases with the increase of RhB solution C₀. Because the number of active sites is constant for a specific amount of catalyst, the increase of C₀ may exceed the number of active sites. When there are a large number of dye molecules in the aqueous solution, the reaction sites may be covered by these molecules, leading to the reduction of active components. Therefore, the k value decreases with the increase of C₀, and the maximum k value is 0.025 min⁻¹. In addition, the catalytic activities of ZIF-8, Ca/ZIF-8, NC and Ca/NC catalysts are evaluated in the piezocatalytic degradation of RhB. As shown in FIG. 8C, ZIF-8, Ca/ZIF-8 and NC catalysts degrade 34%, 34.2% and 74.5% RhB respectively in 150 min. When monatomic Ca/NC catalyst is used, RhB is almost completely degraded within 150 min, which indicates that this excellent catalytic performance may be attributed to the contribution of NC and the active site of monatomic Ca. It is worth noting that the adsorption efficiency of RhB increased from 49% to 58% after calcium is added into NC, which further confirms that the increase of pyrrole nitrogen promotes the adsorption of RhB by Ca/NC, thereby enhancing the degradation efficiency, which is consistent with the XPS analysis. It can be seen from FIG. 8D that the first-order rate constant (k) of Ca/NC is calculated to be as high as 0.025 min⁻¹, almost three times that of NC (0.009 min⁻¹). The piezoelectric degradation coefficients of ZIF-8 and Ca/ZIF-8 are very small, only one tenth of that of Ca/NC, indicating that single-atom Ca plays an important role in the degradation of RhB by Ca/NC piezocatalysis. In addition to RhB dye molecules, other organic dyes such as acid orange 7 (AO7), methyl blue (MB) and methyl orange (MO) can also be decompressed by the dye (FIG. 8E), indicating that the piezocatalytic activity of Ca/NC is widespread.

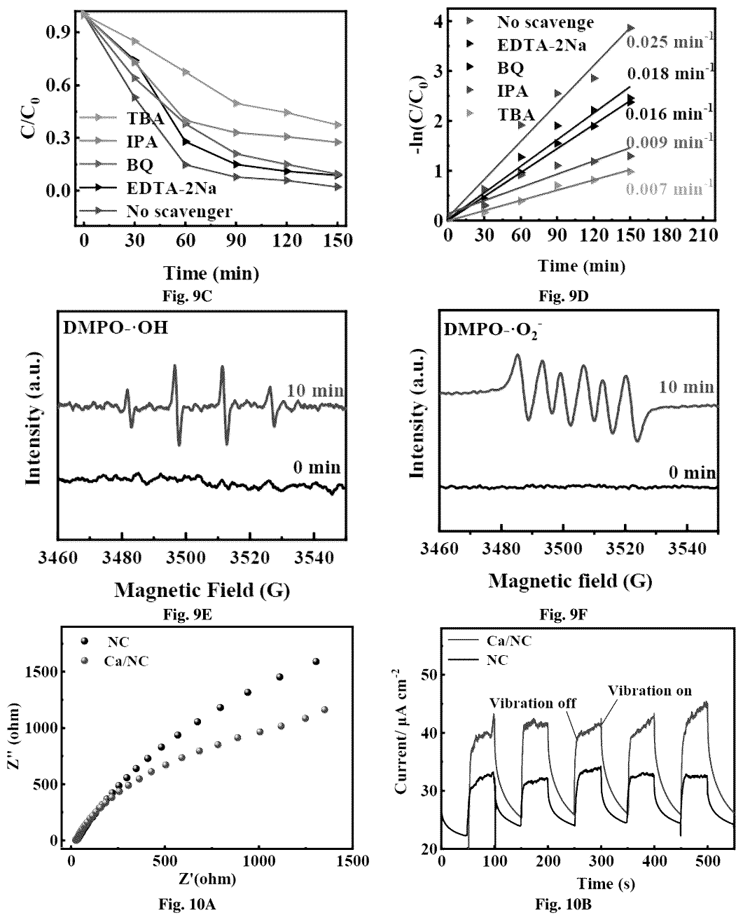

In order to test the stability of Ca/NC, the piezoelectric degradation properties of RhB solutions with different pH values are tested (FIG. 9A). When pH is lower than 6.9, the degradation rate of RhB is almost 100% within 150 min. Surprisingly, even at pH 10, RhB can still degrade 99.5% within 150 min, indicating that Ca/NC piezocatalyst has high stability. In order to further study the reusability of Ca/NC catalyst, a recovery test was conducted. As shown in FIG. 9B, after four consecutive piezocatalytic degradation processes of RhB, the degradation rate of RhB basically remains unchanged, indicating that monoatomic Ca/NC catalyst has high stability and durability. It is worth noting that the decrease of RhB degradation rate in each operation is due to the reduction of catalyst usage due to the loss of catalyst in the recovery/recovery process. Because industrial wastewater contains a lot of acidic or alkaline pollutants, the good pH stability and recoverability of Ca/NC piezo catalysts are of great significance for their practical applications.

In order to reveal the mechanism of the pressure catalytic process, isopropanol (IPA, scavenger of e⁻), disodium ethylenediaminetetraacetate (scavenger of EDTA-2Na, h⁺), tert butanol (scavenger of TBA, ·OH) and benzoquinone (scavenger of BQ, ·O₂⁻) are introduced into the pressure catalytic system. As shown in FIG. 9C-9D, the addition of these scavengers significantly inhibited the degradation efficiency of RhB. The inhibition sequence of RhB is TBA>IPA>BQ>EDTA-2Na. The results show that the piezocatalyst allows the formation of ·OH, ·O₂ radicals, electrons and holes in situ, which further react with dye molecules to promote the degradation process. Among these effective free radicals, ·OH and e⁻ are the main reaction species, ·O₂⁻ has a certain positive effect, and h is the secondary reaction species. Spin trapping is a useful tool to study free radicals. Using DMPO as spin reagent, hydroxyl radical (OH) and superoxide radical (·O₂) were detected in water and methanol respectively. As shown in FIG. 9E-F, no free radical signal is detected without ultrasonic vibration. After ultrasonic treatment for 10 minutes, DMPO-·OH and DMPO-·O₂ signals are clearly observed. The results show that the main oxidation species in the piezocatalytic system are ·OH and ·O₂⁻ free radicals.

### 4. Degradation Mechanism

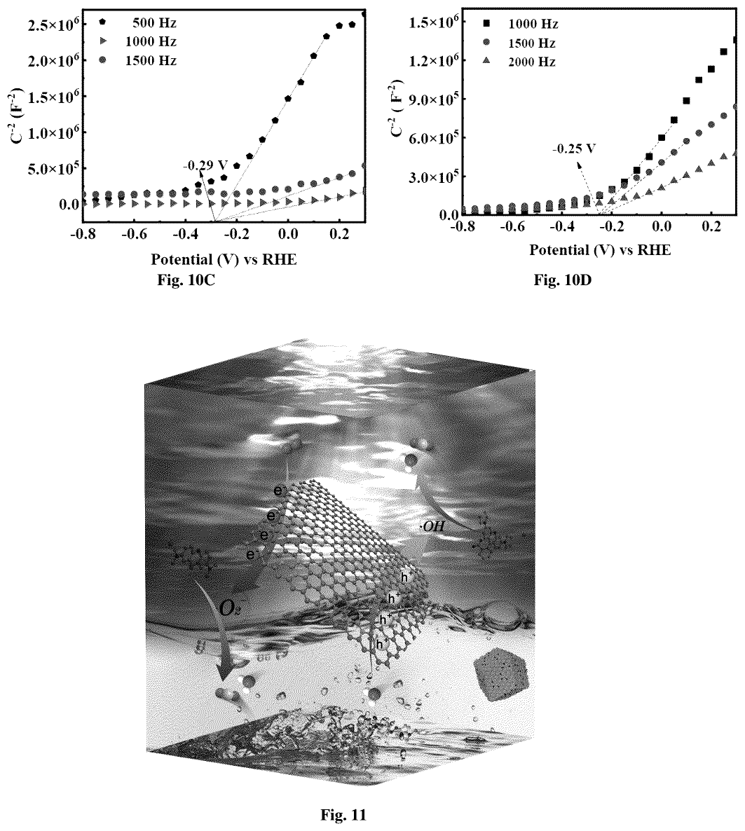

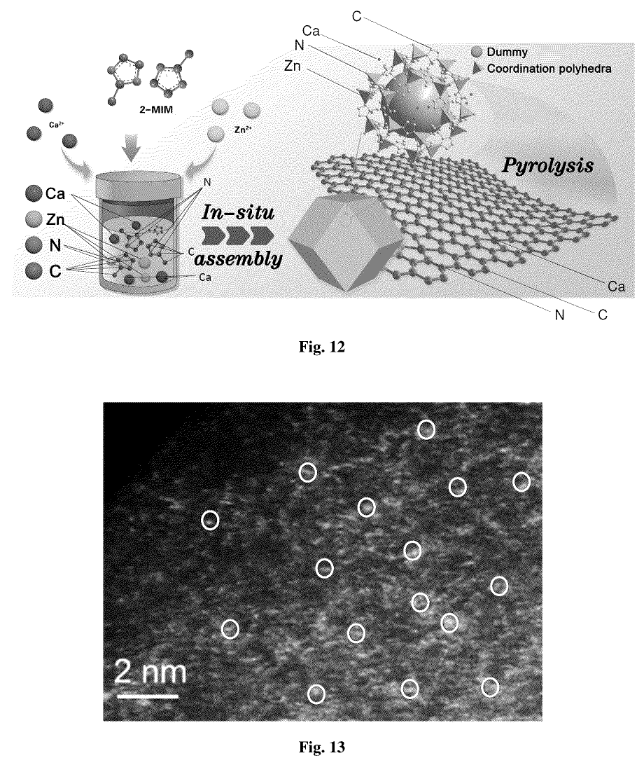

In order to verify the above inference, the inventors carry out a series of piezoelectric electrochemical measurements to verify the carrier transfer behavior in Ca/NC materials. Electrochemical impedance spectroscopy (EIS) is used to further study the transfer efficiency and interface reaction ability of piezoelectric electron holes in Ca/NC and NC. In general, the smaller the circular arc of the Nyquist circle, the lower the electron transfer interface resistance, which is conducive to charge separation. As shown in FIG. 10A, Ca/NC has a smaller semicircle diameter than NC, which indicates that the doping of Ca atoms can stimulate more effective carrier separation, generate faster interface charge transfer, effectively promote carrier transfer, and thus improve the piezocatalytic efficiency. Using transient current response technique, the carrier separation efficiency is studied, and the carrier mobility is revealed. As shown in FIG. 10B, Ca/NC and NC electrodes do not differentiate current output under the condition of no vibration. After the ultrasound is turned on, the Ca/NC output current rapidly increases to 40μ A. Output current higher than NC. This shows that the addition of monatomic calcium enhances the mobility of carriers. In addition, it can be seen from the Mott Schottky (MS) diagrams in FIGS. 10C and 10D that the calculated flat band potentials of Ca/NC and NC are −0.29 eV and −0.25 eV (close to the edge of the conduction band), respectively, indicating that the conduction band of NC is lower, so it can accelerate the separation of piezoelectric electron holes more than Ca/NC.

According to the experimental results and the above analysis, the possible degradation mechanism of RhB is described. Under ultrasonic vibration, the cavitation effect produces high-frequency mechanical impact on Ca/NC. The incorporation of monatomic calcium destroys the symmetry of the local lattice of the carbon substrate material, changes its chemical state and carrier distribution, and triggers the generation of the crystal medium voltage potential. After the separation of intrinsic free carriers (electrons and holes), they migrate to the Ca/NC surface driven by the polarized electric field, which triggers the redox reaction to generate active oxygen species such as ·O₂⁻ and ·OH. The presence of pyridine nitrogen near the Ca—N₃ active site on Ca/NC can effectively enhance the adsorption of organic dyes. The good adsorption performance of the material is very beneficial to the degradation of dyes, because the carriers (electrons and holes) generated by the piezoelectric effect of the catalyst cannot directly enter the solution, and only the dyes adsorbed on the material surface can be oxidized, which is similar to the situation of photogenerated carriers (electrons and holes) in photocatalysis. The abundant structural defects in Ca/NC and the presence of unsaturated Ca—N₃ active sites as well as pyridine nitrogen nearby can effectively realize the synergistic effect of adsorption and catalysis, and promote the efficient degradation of organic dyes.

In conclusion, N-doped porous carbon material (Ca/NC) derived from the alkaline earth metal Ca anchored in ZIF-8 is obtained for pressure catalytic degradation of RhB. At the same time, PFM test shows that Ca atom dispersion on NC introduces 1.46 times amplified piezoelectric response. Therefore, in 150 min, the removal rate of RhB (5 mg/L) by Ca/NC piezocatalysis can reach 98%, and its degradation rate constant is 0.025 min⁻¹. The free radical capture and quantitative detection experiments showed that ·OH is the main active component involved in piezocatalytic degradation, so the mechanism of piezocatalytic degradation is proposed. Based on the results of experiments and X-ray photoelectron spectroscopy (XPS), the inventors determine that Ca—N₃ is the active site for degrading organic dyes and pyrrole N is the adsorption site for organic pollutants. The double reaction sites in the Ca/NC catalyst will greatly shorten the migration distance of active ROS, thus significantly improving the catalytic performance of Ca/NC. This work confirms that the synergistic effect of adsorption and catalysis can be effectively realized by the presence of abundant structural defects, unsaturated Ca—N₃ active sites and pyridine nitrogen nearby, and verify that a single Ca atom dispersed in NC can be used as an efficient and stable piezocatalyst for the degradation of organic dyes. This study provides a new interest in the preparation of highly performance piezocatalysts from alkaline earth metals.

### Example 4

### Synthesis and Morphology of Ca—NC Membrane

FIG. 1 illustrates the synthetic scheme of Ca—NC membrane in accordance with an embodiment of the invention. Briefly, the synthesis involves an initial in-situ synthesis of a coordination polymer, particularly a Ca-doped metal-organic framework, and more particularly a Ca-doped ZIF, which is formed by mixing a Ca source, a Zn source, 2-methylimidazole (2-MIM) in a reactor with stirring. For example, a methanol solution of the Ca source and Zn source may be added to a methanol solution of 2-MIM. After vigorous stirring for 5 min, the mixed solution may be heated to obtain a gel-like composite, from which nanocrystals of Ca-loaded ZIF-8 are separated by centrifugation.

After that, the nanocrystals of Ca-loaded ZIF-8 may be subjected to pyrolysis with a carbon material such as any one of graphite, carbon fiber, carbon nanotube, graphene, carbon black, CNTs, hollow spheres, mesoporous carbon, and reduced graphene oxide (GO) to form the desired product (i.e. Ca-doped NC (Ca—NC)) as a membrane. Without intending to be bound by theory, it is believed that ZIF-8 may support carbon source and serve as bone structure, and carbon-nitrogen materials Ca—NC will be left after pyrolysis.

As shown in FIG. 13, a number of bright spots are well dispersed on the membrane, suggesting that all the Ca species are homogeneously and atomically dispersed in the Ca—NC membrane.

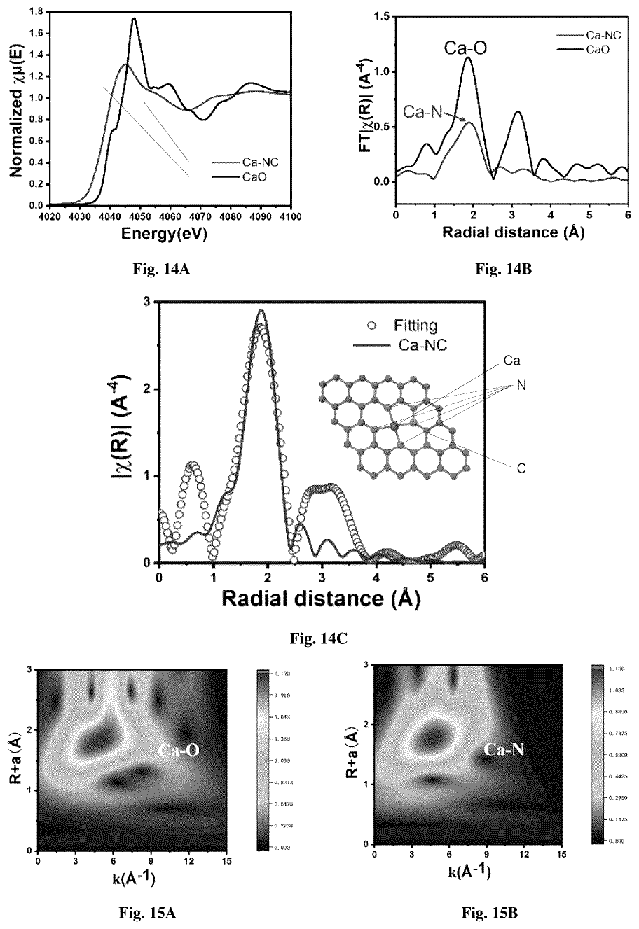

The atomic dispersion of Ca cations in Ca—NC is further confirmed by the X-ray absorption near-edge structure (XANES) spectroscopy and the extended X-ray absorption fine structure (EXAFS) spectroscopy, which are sensitive to the local environment of metal atoms. FIG. 14A shows the Ca K-edge of XANES curves of Ca—NC and CaO, respectively. Usually a metal foil is used for energy calibration. However, because calcium metal is very active in air, the Ca K-edge XANES spectrum of CaO is used as calibration reference material. As shown in FIG. 14A, the adsorption edge position of the Ca—NC XANES curves is generally comparable to that of CaO, indicating that Ca metal atoms in Ca—NC are in cationic states.

FIG. 14B show the Ca K-edge EXAFS R-space plot for the Ca—NC. It is noted that the EXAFS curve of Ca—NC is generally distinguishing from that of CaO. As shown, the R space plot of Ca—NC show a sharp peak at approximately 1.9 Å. However, CaO shows two strong bonding features at around 1.9 Å and 3.1 Å, which are attributed to the Ca—O bond and Ca—O—Ca bonds, respectively. The major peak for Ca—NC at approximately 1.9 Å can be corresponded to the formation of Ca—N bond. Atomic structure simulations indicate that the anchored Ca single atoms are located at the defective sites of NC derived from pyridine-N (FIGS. 14C, 15A and 15B).

### Example 5

### Organic Contaminant Degradation by Ca—NC

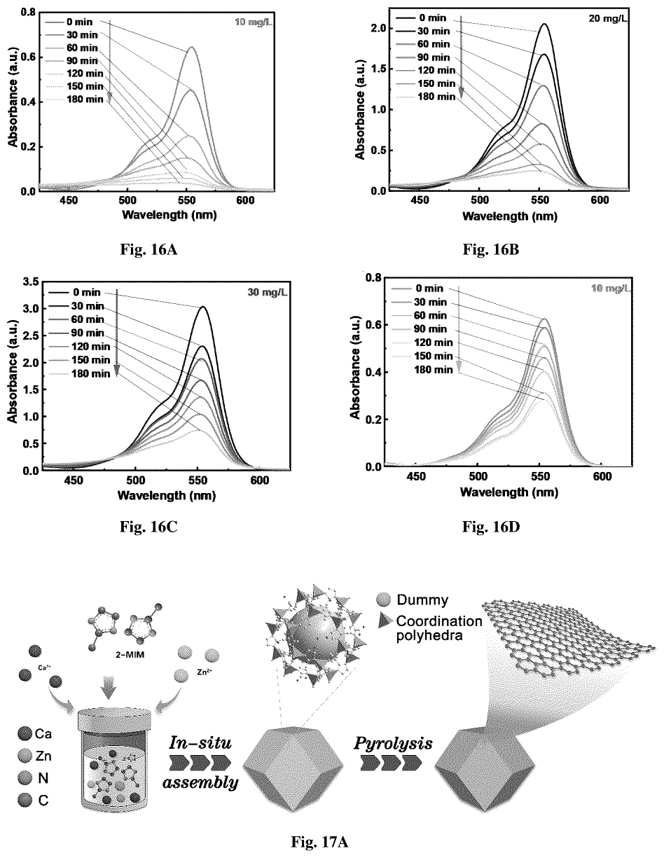

The degradation performance of the Ca—NC toward organic contaminants is investigated and compared with ZIF-8. As shown in FIGS. 16A to 16C, all the Ca—NC samples (from 10 mg/L to 30 mg/L) could degrade rhodamine B (RhB) to a concentration of at least one-fourth of its original concentration over 180 min, as reflected by the UV-Vis absorbance. Based on the UV-Vis absorbance data, the kinetic rate constant of Ca—NC is determined to be from greater than 0 min⁻¹ to about 60 min⁻¹. In contrast, under the same experimental condition, at least one-half of RhB remained when Ca—NC is replaced with ZIF-8.

### Example 6

### Synthesis and Characterization of Ca—NC

### 1. Materials

Calcium acetylacetonate (Ca(acac)₂) and Zn(NO₃)₂·6H₂O are purchased from Alfa Aesar. 2-Methylimidazole is purchased from Macklin Reagent Co. Ltd. polyvinylidene fluoride (PVDF); N-Methyl-2-pyrrolidone (NMP) is purchased from Aladdin. All reagents in this example are used directly without further purification. Deionized (DI) water used for all experiments is prepared using an ultrapure water generator.

### 2. Synthesis of Ca—NC

FIG. 17A schematically depicts the synthesis of Ca—NC. A single-atom Ca-embedded nitrogen-doped carbon (Ca—NC) is prepared by reacting 0.594 g (2.0 mmol) Zn(NO₃)₂·6H₂O and 45.8 mg (0.20 mmol) Ca(acac) 2 are dissolved in 7.5 ml methanol to form a clear solution. A solution of 0.656 g (8.0 mmol) 2-methylimidazole (2-MIM) in 15 ml methanol is prepared. The clear solution is added to the 2-MIM solution and vigorously stirred for 5 min. The mixed solution is transferred to a 50 mL, airtight, Teflon™-lined stainless-steel autoclave. The autoclave is heated to 120° C. at a rate of 4° C./min, then allowed to cool to room temperature to obtain a gel-like product. Nanocrystals of Calcium-loaded ZIF-8 (Ca@ZIF-8) are separated from the gel by centrifugation at 9,000 rpm and then washed with methanol four times to purify the Ca@ZIF-8 nanocrystals. The Ca@ZIF-8 nanocrystals were dried in vacuum overnight at 60° C. For comparison, ZIF nanocrystals are also prepared without adding Ca(acac) 2. The Ca/ZIF-8 and ZIF-8 nanocrystals respectively are heated to 910° C. at a rate of 5° C./min and maintained at that temperature for 4 hours in a tube furnace filled with Ar. The products are washed sequentially with 3 M HCl and DI water and finally dried in vacuum overnight to obtain the final products, Ca-doped NC (Ca—NC) and NC in powder form.

### 3. Characterization of Ca—NC

The XRD pattern of Ca@ZIF-8 is consistent with that of ZIF-8 (FIG. 17C), indicating that the addition of Ca does not affect the crystallization of ZIF-8. The existence of Ca and N components is verified using electron energy loss spectroscopy (EELS) (FIG. 17G). Energy-dispersive X-ray spectroscopy (EDS) mappings (FIG. 17H) demonstrate that Ca, C, and N elements are uniformly distributed throughout the sample. The main composition in Ca—NC is amorphous carbon, which is confirmed by XRD (FIG. 17I). According to the ICP-OES results, the loading percentage of Ca in Ca—NC is 1.88 wt %, however, no observable Ca peaks are found in the XRD pattern, indicating there is no detectable metallic Ca grain on the sample. Dispersed Ca atoms can be clearly observed with the aberration-corrected high-angle annular dark-field scanning transmission electron microscopy (HAADF-STEM) image (FIG. 17B). The isolated bright spot on the substrate suggests the successful anchoring of Ca single atom(s) on NC. Brunauer-Emmett-Teller (BET) Surface Area Analysis and Barrett-Joyner-Halenda (BJH) Pore Size and Volume Analysis (FIG. 17J) reveals that Ca—NC exhibits a porous structure with a large specific surface area (536.68 m²/g) and an average pore diameter (9.55 nm), which is advantageous for exposing the Ca active sites.

Ca K-edges in XANES curves of Ca—NC and CaO are shown in FIG. 17K. The Ca K-edge XANES spectrum of CaO is used as a calibration reference. The Ca K-edge energy of Ca—NC is lower than that of CaO, meaning a lower oxidation state of Ca in Ca—NC. Ca's coordination environments in Ca—NC were determined using extended X-ray absorption fine structure (EXAFS) spectroscopy. In the Fourier transform (FT) EXAFS spectra (FIG. 17L), CaO exhibits two characteristics peaks at about 1.8 and 3.1 Å, attributable to the Ca—O and Ca—O—Ca bonds, respectively. Ca-NC's main peak at around 1.9 Å can be attributed to the Ca—N bond, which is slightly longer than the Ca—O bond in CaO. The lack of obvious FT peak corresponding to Ca—Ca(3.1 Å) bond indicates the absence of Ca cluster in Ca—NC. The best-fit EXAFS results and parameters are summarized in FIG. 17M and Table 3.

TABLE 1
EXAFS fitting parameters at the Ca K-edge for various samples (S02 = 0.75)

| Sample | Shell | CN^{a} | R(Å)^{b} | σ²(Å²)^{c} | S₀² | ΔE₀(eV)^{d} | R factor |
|---|---|---|---|---|---|---|---|
| CaO | Ca—O | 6 | 2.35 | 0.0091 | 0.75 | 0.58 | 0.0165 |
| Ca—NG | Ca—N | 4.02 | 2.37 | 0.0086 | 0.75 | −2.21 | 0.0177 |

Note:
^{a}CN, coordination number;
^{b}R, the distance between absorber and backscatter atoms;
^{c}σ2, Debye-Waller factor to account for thermal and structural disorders;
^{d}ΔE₀, inner potential correction; R factor indicates the goodness of the fit. According to the experimental EXAFS fit of Ca foil by fixing CN as the known crystallographic value. Fitting range: 3.0 ≤ k (/Å) ≤ 10.3 and 1.0 ≤ R (Å) ≤ 2.5 (CaO); 3.0 ≤ k (/Å) ≤ 9.5 and 1.0 ≤ R (Å) ≤ 2.8 (128).

The relevant findings revealed that the Ca—N contribution to Ca—NC had a coordination number of 4. Wavelet transform (WT) contour plots of CaO (FIGS. 17N and 17O) show a maximum intensity at 5.6 Å 1, attributed to the Ca—O—Ca bonds. In contrast, Ca—NC has a solitary intensity maximum at 4.6 Å 1 that can be ascribed to the Ca—N bond. All the above results suggest that calcium in Ca—NC exist as isolated Ca atoms with a Ca—N₄ configuration.

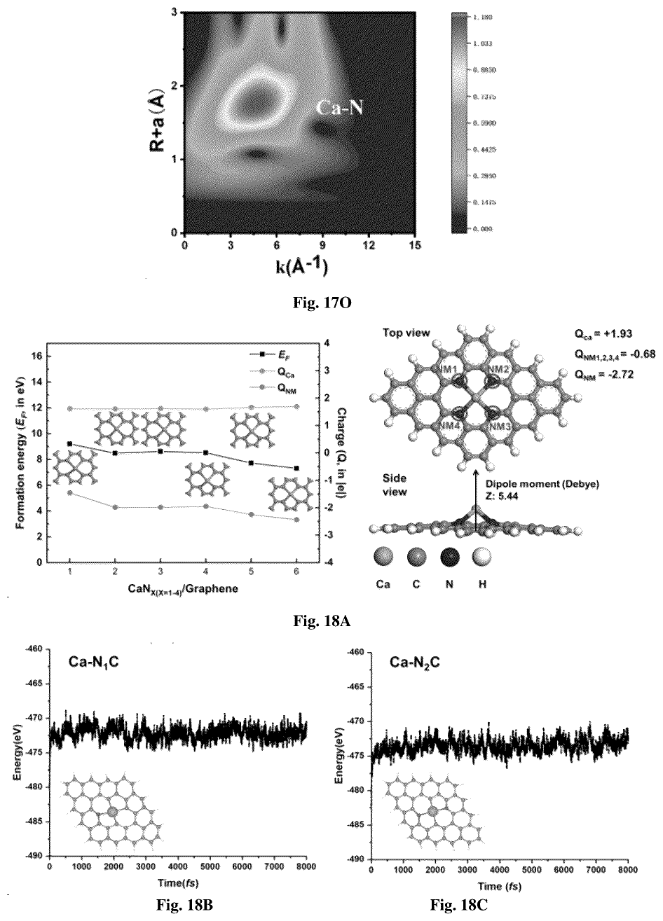

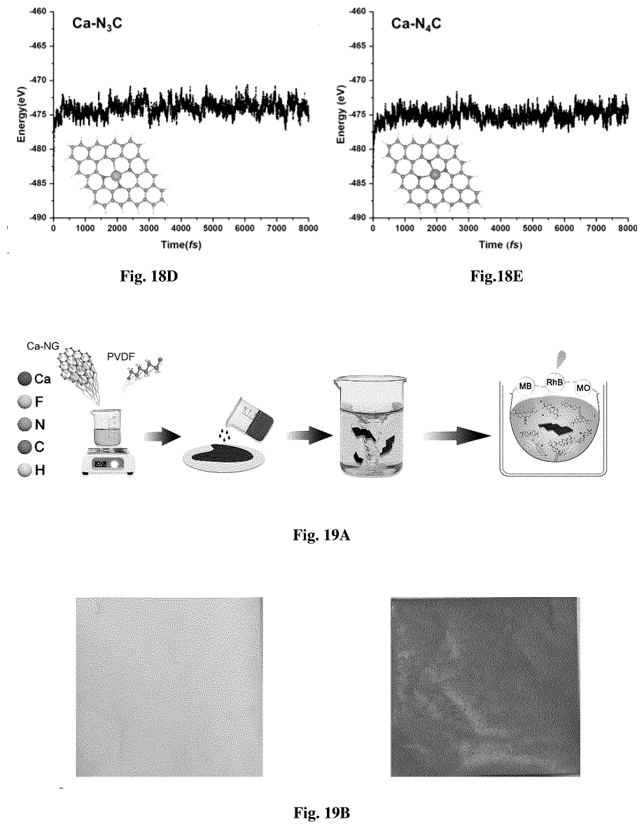

The DFT calculations have further proved that the Ca—N₄ configuration processes the lowest formation energy among the structural models of Ca and N doped carbon materials (Ca—N_{X(X=1-4)}C), implying its stability (FIG. 18A). In addition, the stability of the Ca—N_{X(X=1-4)} in Ca—N_{X(X=1-4)}C was further confirmed by performing AIMD simulations (FIGS. 18B to 18E).

For DFT calculations, the structural models of Ca and N doped carbon materials (Ca—N_{X(X=1-4)}C) are constructed as shown in FIG. 18A. As the number of N atoms bonded to the Ca atom increases, the negative charges surrounding the Ca atom become larger, leading to stronger interaction between the Ca atom and substrate, as supported by the charge difference between Q_{Ca} and Q_{NM}. The most stable geometry was determined to be the Ca—NC doped with four N atoms, as shown in FIG. 18A, based on formation energy calculations. Therefore, we use Ca—N₄C as the Ca—NC structure. The Ca atom is determined to be 1.14 Å above the surface and carries a net positive charge of +1.69 |e|, surrounded by a negative charge of −2.44 |e| on the four N atoms, forming a small dipole moment of 5.44 Debye of Ca—NC along the positive Z-axis direction as shown in FIG. 18A. However, owing to the symmetry in the directions of the X-axis and Y-axis, there are no dipole moments along these directions. In addition, the stability of the Ca—N_{X(X=1-4)} in Ca—N_{X(X=1-4)}C was further confirmed by performing AIMD simulations for 8,000 fₛ (8 ps) (FIGS. 18B to 18E). It is demonstrated that the Ca—N_{X(X=1-4)} in Ca—N_{X(X=1-4)}C can be well maintained even at a high temperature (T=700 K). The total energies of Ca—N_{X(X=1-4)}C materials keep fluctuating toward stable values (FIGS. 18B to 18E), and meanwhile, there are no significant conformational changes in Ca—N_{X(X=1-4)}C during the 8,000 fₛ (8 ps) simulations.

### Example 7

### Synthesis and Characterization of Ca-PVDF Membranes

### 1. Synthesis of Ca-PVDF and PVDF Membranes

PVDF polymer (1.8 g, powder: average molecular weight of around 534,000) is first dissolved in N-Methyl-2-pyrrolidone (NMP) (12 mL) at 60° C. under magnetic stirring (800 rpm) for six hours to obtain a homogeneous milky white solution. Ca—NC powder, as prepared in Example 6, is then added to the milky white solution (5 wt. % PVDF) and stirred at 900 rpm for ten hours. The obtained suspension is cast onto a glass plate, which is then immersed in DI water for coagulation at room temperature. The membrane is then peeled off and carefully washed with DI water to remove any residual solvent. For comparison, pristine PVDF membranes are also prepared using the same approach without adding any Ca—NC powder.

### 2. Characterization of the Ca-PVDF Membrane

Transmission electron microscopy (TEM) images, scanning transmission electron microscopy (STEM) images, and energy dispersive X-ray spectroscopy (EDS) were carried out on a JEM-2100F/HR transmission electron microscope operated at 200 kV. High-angle annular dark-field (HAADF) scanning transmission electron microscopy (STEM) was carried out using a JEOL JEM-ARM200F microscope incorporated with a spherical aberration correction system. X-ray diffraction (XRD) patterns were recorded on a BRUKER-D8 X-ray diffractometer using Cu Kα radiation (0.15418 nm). Raman spectra were performed using a Lab RAM high-resolution (HR) Raman spectrometer using a 514 nm excitation laser. Composition analyses were conducted with an Optima 8,000 inductively coupled plasma optical emission spectrometer (ICP-OES). Fluorescence spectroscopy was performed with a Fluorescence Detector (RF-10A, Shimadzu, Japan). Fourier transform infrared (FT-IR) spectra were recorded over 500-4,000 cm⁻¹ using a Nicolet iS10 (Thermo Fisher, USA) infrared spectrometer with a DTGS detector. X-ray absorption fine structure (XAFS) spectra were measured at the BL14 W1 beamline of the Shanghai Synchrotron Radiation Facility (SSRF).

The hybrid membrane of Ca-PVDF composited with Ca—NC and PVDF piezo-polymer was fabricated by the traditional phase-inversion method (FIG. 19A). The digital photos of PVDF and Ca-PVDF membranes are shown in FIG. 19B. Both membranes of raw PVDF and Ca-PVDF contain α, β, and γ phases of PVDF (FIG. 19C). The decreased X-ray diffraction (XRD) intensity at 18.30° manifests the reduced a phase proportion in the Ca-PVDF membrane compared with the raw PVDF membrane, while a much stronger peak at 20.57° suggests the improved β phase ratio.

FIG. 19D shows the Raman spectra of the two membranes. Raman spectra signals at 610 and 796 cm⁻¹ are characteristic peaks of the α-phase, while those at 840, 764, and 510 cm 1 correspond to the β-phase. The peak at 881 cm⁻¹ is common for all three α-, β- and γ-phases. The Raman results also show that there is more β-phase in the Ca-PVDF membrane.

Comparing FTIR spectra of the PVDF and the Ca-PVDF membranes also show the enhanced formation of β-phase in the composite membrane (FIG. 19E). Both samples show peaks at absorbance bands of nonpolar α-crystals at 532 cm⁻¹ (—CF₂ bending), 614 and 763 cm⁻¹ (—CF₂ bending and skeletal bending), and 798 cm⁻¹ (CH₂ rocking), where the peak intensities of Ca-PVDF membrane are significantly lower. The peaks at 474, 510, 840, and 1275 cm⁻¹ are characteristic of the β-phase. Also, the Ca-PVDF membrane shows increased peak intensities at 840, 1181, and 1275 cm⁻¹ and decreased peak intensity at 1404 cm-1. Peaks at 482, and 976 cm⁻¹ are from the polar γ-phase. Interestingly, the peak at 474 cm⁻¹, belonging to β-phase, only appears in the Ca-PVDF membrane.

Fractions of electroactive β-phase in both membranes are quantified using the Lambert-Beer Law, and are calculated to be 29.8 and 56.3%, respectively. Details are listed below:

### Volume Fractions of β Phase in PVDF and Ca-PVDF Membranes

Volume fractions of electroactive β phases content (F_{EA}) in a PVDF and a Ca-PVDF membranes were determined using the Lambert-Beer Law:

$${F}_{EA} = \frac{{I}_{EA}}{( \frac{{K}_{940}}{{K}_{763}} ) {I}_{763} + {I}_{EA}} \times 100 \% ; \qquad ( S4 )$$

where, IEA and I763 are the absorbances intensities at 840 and 763 cm⁻¹, respectively; K840 and K763 are the absorption coefficients at the respective wave numbers with values of respectively 7.7×104 and 6.1×104 cm² mol⁻¹ from You, et al (2018).

Then, volume fraction of β phase in the electroactive phases was determined as:

$${F}_{( β )} = {F}_{EA} ( \frac{Δ {H}_{β}}{Δ {H}_{β} + Δ {H}_{γ}} ) \times 100 \% ; \qquad ( S5 )$$

Calculations showed that volume fraction of the β phases in pure PVDF is 29.8%. After loading Ca—NC into PVDF, the fraction of the β-phase increases significantly to 56.3%.

These results above further confirm that the addition of Ca—NC significantly enhances the α-to-β phase transition in the Ca-PVDF membrane.

To further confirm this, the DFT calculations analyze the charge density distributions of Ca—NC modified α-phase of PVDF (α-PVDF) membrane (Ca-α-PVDF) (FIG. 19F-I). Owing to the Coulomb exclusion. between the negatively charged NC of Ca—NC (FIG. 19F-II) and the F atoms of α-PVDF (FIG. 19F-III), the F atoms are repelled from Ca—NC, leading to the transformation of the α-phase into the β-phase. Thus, the addition of Ca—NC is expected to considerably enhance the spontaneous polarization of the Ca-PVDF membrane.

It is found that surface morphologies of the Ca-PVDF membranes show significant differences. The side of the membrane contacting the glass substrate during the membrane fabrication is hereafter referred as the “glass side”; the other surface is referred as the “air side”. As noted herein and in the figures, without the Ca—NC nanoparticles, the two sides of the pristine PVDF membrane show dense surfaces and similar morphologies (FIGS. 20A and 20B). While the glass side of the Ca—NC membrane also has a dense surface; the air side shows a highly porous surface of nanometer-scale interconnected fibers decorated with spherical particles (FIGS. 20C and 20D). The porous structure consists of many interconnected fibers decorated with spherical particles. At higher magnifications (FIG. 20E), it can be observed that there are also many interconnecting fibers of a few nanometers scale. Without intending to be limited by theory, it is believed that the co-existence of the micro- and the nanoscale structures is crucial for obtaining wetting behavior according to the Cassie model derived from Young's equation. It is also observed that the Ca—NC particles are well dispersed in the PVDF matrix, which can be confirmed by the uniformly distributed Ca, O, and N elements in the Ca-PVDF membrane (FIG. 20F). As noted, BET and BJH measurements confirm that introducing the Ca—NC additives increases much more porosity and pores of much larger sizes compared to PVDF alone (FIGS. 20G and 20H). Without intending to be limited by theory, it is believed that this porous structure may obviously provide easier access to solutions throughout the Ca-PVDF membrane to facilitate piezocatalytic reactions.

As noted herein, it is found that the PVDF membrane exhibits hydrophobicity on both sides (initial water contact angles of 113.9 and 109.6°, see FIG. 20I). Adding Ca—NC obviously enhances the membrane's wettability on both sides (initial water contact angles of 96.5 and 73.0°, see FIG. 20I). It is interesting that as time proceeds, while the water droplets on the both sides of the PVDF are relatively stable, and the water contact angles of the glass side of the Ca-PVDF membranes become 31.0°, the droplets on the air side of the Ca-PVDF membrane completely disappear after 20 s (bottom-right most picture in FIG. 20I). It is considered that the water droplet can be much more easily sucked into the Ca-PVDF membrane on its air side due to the highly porous surface structure and more hydrophilic nature.

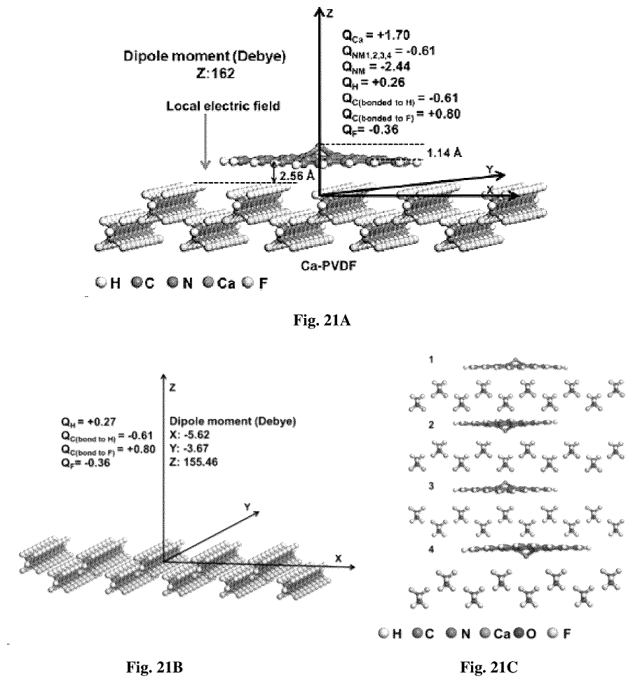

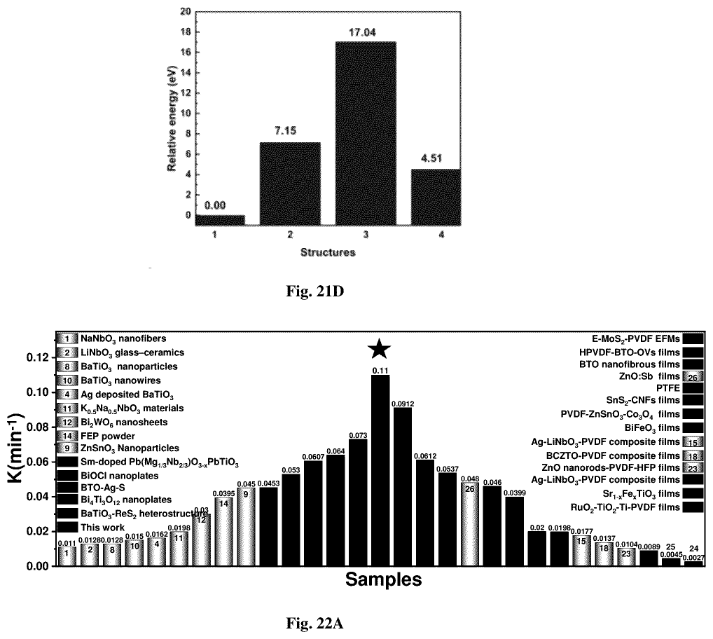

XPS analysis of surface compositions and chemical states of the pristine PVDF and the Ca-PVDF membranes indicate strong electrostatic interaction of the PVDF chain to Ca—NC. XPS is used to analyze surface compositions and chemical states of the pristine PVDF and the Ca-PVDF membranes. XPS spectra of C Is and F Is peaks for the two membranes are shown respectively in FIGS. 20J to 20M. For the PVDF membrane, the two main C Is peaks at 284.8 and 289.2 eV can be attributed to respectively-CH₂-and-CF₂-species. For the Ca-PVDF membrane, the C Is spectrum shows more peaks, with two major additional peaks at 289.6 and 282.1 eV, which can be assigned to —F—C—H— and —F—C—C—H— (crosslinking of polymer chains) species of PVDF.^{40,42} In the Ca-PVDF membrane, the F Is peak shifts to higher binding energy compared to that of the pristine PVDF membrane, which may be due to interactions between dipoles of the PVDF chains and the negatively charged Ca—NC.^{43, 44} Overall, the chemical shift in the F Is spectra and the appearance of new peaks in the C Is spectra indicate strong electrostatic interaction of the PVDF chain to Ca—NC. The DFT calculation results have demonstrated the strong H-π interaction between the Ca—NC and the H-terminated side of β-phase-PVDF (FIGS. 21A to 21D). Therefore, the Ca—NC is stalely bonded to β-phase-PVDF with a distance of 2.56 Å.

### Example 8

### Piezocatalytic Degradation Performance of the Ca-PVDF Membrane

Piezocatalytic activities of the samples are evaluated by degrading Rhodamine B (RhB) under ultrasonic (US) excitation at room temperature. As shown in FIGS. 22B and 22C, the Ca-PVDF membrane can remove 98% of RhB molecules under US within 45 min with a quasi-first-order kinetic rate constant of 0.11 min⁻¹, which is 15.7 and 36.7 times higher than those of Ca—NC (0.007 min⁻¹) and the pristine PVDF membrane (0.003 min⁻¹). Repeated RhB degradation experiments are performed to evaluate the stability of the Ca-PVDF membrane. As shown in FIG. 22D, the RhB degradation rate shows little decrease even after eight cycles of 1 hour excitation duration each, indicating the durability of the fabricated Ca-PVDF membrane. In addition, the stability and degradation capability of the Ca-PVDF membrane in a wide pH range from 2.6 to 11.2 and other organic pollutants are also demonstrated (FIGS. 22E and 22F to 22I). Respectively, 88% and 48% of methylene blue (MB) and methyl orange (MO) can be removed within 35 minutes. In FIGS. 22F and 22G, the piezocatalytic degradation stability for the removal of MB and MO is measured. As one can see, the Ca-PVDF membrane shows better piezocatalytic degradation performance in MB solution than MO solution. But with a wide pH range, it shows good stability. We also compare the piezocatalytic degradation efficiency of different areas of Ca-PVDF membrane and addictive amount of Ca—NC in FIGS. 22H and 22I. The results show that 5 wt % addictive of Ca—NC and the membrane area of 4 cm² performed best. Piezocatalytic performance of recently reported materials is compared in Table 4 and FIG. 22A. The performance of the Ca-PVDF membrane according to this application (see rows 1-3) is considerably higher than those of the recently reported piezocatalytic catalysts.

TABLE 4
A comparison of the piezoelectric catalytic performance with previously
reported piezoelectric catalysts and Ca-PVDF membrane

| | | | | Rxn |
|---|---|---|---|---|
| | Materials | Substrate | Catalytic conditions | constant |
| 1 | Ca-PVDF* | RhB [10 mg · L⁻¹] | Ultrasound [360 W, 40 kHz] | 0.11 |
| 2 | Ca-PVDF* | RhB [10 mg · L⁻¹] | Ultrasound [270 W, 40 kHz] | 0.07 |
| 3 | Ca-PVDF* | RhB [10 mg · L⁻¹] | Ultrasound [180 W, 40 kHz] | 0.053 |
| 4 | NaNbO₃ nanofibers ^{[1]} | RhB [5 mg · L⁻¹] | Ultrasound [80 W, 40 kHz] | 0.011 |
| 5 | LiNbO₃ glass-ceramics ^{[2]} | MB [5 mg · L⁻¹] | Ultrasound [70 W, 40 kHz] | 0.0128 |
| 6 | BTO-Ag-S ^{[3]} | MO [5 mg · L−1] | Ultrasound [120 W, 40 kHz] | 0.0607 |
| 7 | Ag deposited BaTiO₃ ^{[4]} | MO [5 mg · L⁻¹] | Ultrasound [120 W, 40 kHz] | 0.0162 |
| 8 | Sm-doped Pb(Mg_{1/3}Nb_{2/3}) | MO [5 mg · L⁻¹] | Ultrasound [120 W, 40 kHz] | 0.0453 |
| | O₃₋ₓPbTiO₃ ^{[5]} | | | |
| 9 | Bi₄Ti₃O₁₂ nanoplates ^{[6]} | RhB [5 mg · L⁻¹] | Ultrasound [80 W, 40 kHz] | 0.064 |
| 10 | BiOCl nanoplates ^{[7]} | RhB [10 mg · L⁻¹] | Ultrasound [150 W, 53 kHz] | 0.053 |
| 11 | BaTiO₃ nanoparticles ^{[8]} | RhB [10 mg · L⁻¹] | Ultrasound [80 W, 40 kHz] | 0.0128 |
| 12 | ZnSnO₃ Nanoparticles ^{[9]} | RhB [4.7 × 10⁻⁶ M] | Ultrasound [120 W, 33 kHz] | 0.045 |
| 13 | BaTiO₃ nanowires ^{[10]} | MO [5 mg · L⁻¹] | Ultrasound [80 W, 40 kHz] | 0.015 |
| 14 | K_{0.5}Na_{0.5}NbO₃^{[11]} | RhB [5 mg · L⁻¹] | Ultrasound [180 W, 40 kHz] | 0.0198 |
| 15 | Bi₂WO₆ nanosheets ^{[12]} | RhB [5 mg · L⁻¹] | Ultrasound [120 W, 40 kHz] | 0.03 |
| 16 | BaTiO₃₋ReS₂ | RhB [10 mg · L⁻¹] | Ultrasound [100 W, 40 kHz] | 0.073 |
| | heterostructure ^{[13]} | | UV-vis | |
| 17 | FEP powder ^{[14]} | MO [5 ppm] | Ultrasound [110 W, 40 kHz] | 0.0395 |
| 18 | Ag-LiNbO₃ PVDF composite | MB [5 mg · L⁻¹] | Ultrasound [70 W, 40 kHz] | 0.0177 |
| | films ^{[15]} | | | |
| 19 | PTFE ^{[16]} | MO [5 mg · L⁻¹] | Ultrasound [110 W, 40 kHz] | 0.046 |
| 20 | E-MOS₂-PVDF EFMs ^{[17]} | OTC [20 mg · L⁻¹] | Ultrasound [650 W, 20 KHz] | 0.0912 |
| 21 | BCZTO-PVDF composite | MB [5 mg · L⁻¹] | Ultrasound [70 W, 40 kHz] | 0.0137 |
| | films^{[18]} | | | |
| 22 | Ag-LiNbO₃₋PVDF composite | TC [0.2 mM] | Ultrasound [120 W, 40 kHz] | 0.0089 |
| | films^{[15]} | | | |
| 23 | HPVDF-BTO-OVs films ^{[19]} | BPA [15 mg · L⁻¹] | Ultrasound [300 W, 40 kHz] | 0.0612 |
| 24 | BTO nanofibrous films ^{[20]} | MB [5 mg · L⁻¹] | Ultrasound [240 W, 40 kHz] | 0.0537 |
| 25 | SnS₂-CNFs films ^{[21]} | BPA [10 mg · L⁻¹] | Ultrasound [300 W, 40 kHz] | 0.0399 |
| 26 | PVDF-ZnSnO₃-Co₃O₄ | MB [5 mg · pL⁻¹] | Ultrasound [120 W, 33 kHz] | 0.020 |
| | films ^{[22]} | | | |
| 27 | ZnO nanorods-PVDF-HFP | MO [5 mg · L⁻¹] | 1000 rpm + light | 0.0104 |
| | films ^{[23]} | | | |
| 28 | RuO₂-TiO₂-Ti-PVDF films ^{[24]} | SA [50 μM] | Ultrasound [20 mW, 100 kHz] | 0.0027 |
| 29 | Sr₁₋ₓFeₓTiO₃ films ^{[25]} | MB [3.6 mg · L⁻¹] | Ultrasound [70 W, 40 kHz] | 0.0045 |
| 30 | ZnO:Sb films ^{[26]} | RhB [2.5 ppm] | 360 rpm 500 W | 0.048 |
| | | | 350-450 nm light | |
| 31 | BiFeO₃ films ^{[27]} | MB [5 ppm] | Ultrasound [158 mW, 40 KHz] | 0.0198 |
| | | | xenon lamp 950 W · m⁻² | |

Note:
*indicates materials according to this application; and ^{[1]} to ^{[27]} indicate references at the end of the description.

### Example 8

### Piezocatalytic Performance Against Microorganisms

Antibacterial performance of the Ca-PVDF membrane is investigated using the spread plate method. Escherichia coli (CICC 23657) is chosen for investigating the antibacterial activity of the prepared samples via a spread plate method. 5 ml of bacterial suspensions (106 CFU mL-1) are loaded into each test tube of 3 cm diameter which respectively contain no catalyst (control), Ca—NC powder (0.5 mg), a PVDF or a Ca-PVDF membrane of 2 cm×2 cm size. The test tubes are then ultrasonicated at 40 kHz, 360 W cm-2 for 0 to 60 min. 100 μL of suspensions are then collected from each sample and spread on Luria-Bertani (LB) agar plates and incubated at 37° C. for 1 day. Antibacterial efficiency n is calculated using the following formula:

η=(N_{Control group}−N_{Experiment group})/N_{Control group}×100% (S3);
where, N presents the number of colonies.

E. coli suspensions containing no catalyst (control group), Ca—NC powder, a PVDF, or a Ca-PVDF membrane are ultrasonically treated for 60 min. After spreading the suspensions onto agar plates and incubated for 1-day, antibacterial efficiencies were determined by comparing the numbers of E. coli colonies on the plates. FIG. 4A shows the antibacterial comparison of Ca-PVDF group on E. coli for different piezoelectric treatment times of piezoelectric treatment. As noted above, in the first 20 minutes of ultrasonic treatment, the Cn-PVDF already killed most of the bacterial colonies. FIG. 23B shows a graph comparing different piezocatalysts after 60 minutes of treatment. The antibacterial efficiencies are 69.3, 85.4, and 99.8% for the Ca-NC+US, the PVDF+US, and the Ca-PVDF+US piezocatalysts, respectively. These results demonstrate that the Ca-PVDF membrane has high antibacterial efficiency under US conditions.

When we conducted the bacterial experiments under ultrasonication by the Ca-PVDF membrane, the voltage generated on the Ca-PVDF side makes it an excellent electron donor that can disrupt the normal electron transport process. Thus, electron transfer can effectively disrupt metabolic processes and induce membrane stress in bacteria, while also generating intracellular ROS. This electrical interaction caused a damaging effect on the cell membrane. Subsequently, the cascade and accumulation of intracellular ROS become the ultimate executioner, leading to bacterial death. The effect of PVDF enhances the rate of electron transfer between the materials and the bacteria and accepts more electrons from Ca-PVDF, further accelerating bacterial death. These results demonstrate that the PVDF membrane can improve the performance of Ca—NC, leading to a high antibacterial efficiency under ultrasonication.

### Example 9

### Piezocatalytic Mechanism and DFT Calculations

To better understand the piezoelectric catalytic mechanism, we repeat the RhB degradation experiment with Ca-PVDF by adding p-benzoquinone (BQ), isopropyl alcohol (IPA), terephthalic acid (TPA), and disodium ethylenediaminetetraacetate (EDTA-2Na) which are respectively ·O₂⁻, ·OH, e⁻, and h⁺ scavengers. As shown in FIG. 24A, all four scavengers decrease the degradation rate, suggesting that the degradation process is related to all the four active species, and Ca-PVDF membrane can simultaneously generate ·O₂⁻, ·OH, e⁻, and h⁺ under ultrasonic excitation. As the degradation suppressions are most obvious for the groups with IPA and BQ, ·OH and ·O₂⁻ are considered the leading reactive radicals. Electron spin resonance (ESR) confirm Ca-PVDF's capabilities of ·OH and ·O₂⁻ generation under ultrasonication. FIG. 24B shows the characteristic quadruple peak of DMPO-·OH with an intensity ratio of 1:2:2:1 that can be detected. Similarly, a typical DMPO-·O₂⁻ distinct peak can also be observed. Also, the intensity of DMPO-·O₂⁻ signal peaks gradually increase with the ultrasonication duration from 0 to 10 min (FIG. 24C), confirming that the piezocatalyst herein may produce both ·OH and ·O₂⁻.

More importantly, it is believed that the spontaneous polarization of a piezocatalytic material is closely related to its structural asymmetry, and its piezoelectric catalytic properties can be modulated by changing its structural asymmetry. Modulated atomically localized dipoles of restricted Ca single-atoms lead to a proposed model system of PVDF-constrained Ca—N₄ polar centers. It is believed that the significant electronegativity difference between Ca and N atoms (see FIG. 25A) and the longer Ca—N bond length induces a more significant local dipole moment, producing a more considerable transient local dipole moment change and thus enhancing piezoelectricity. Furthermore, it is believed that longer bond lengths and inhomogeneous distribution of bond lengths in Ca—N—C may result in smaller Young's modulus and lead to more intense local ripples around the Ca atoms. Therefore, the Ca—N dipole in Ca—NC is much more sensitive to mechanical stress (FIG. 25B). Thus, rational optimization of the local polarization structure, enhancing the local piezoelectric effect, and improving the stress sensitivity will likely be effective in developing efficient piezoelectric catalysts.

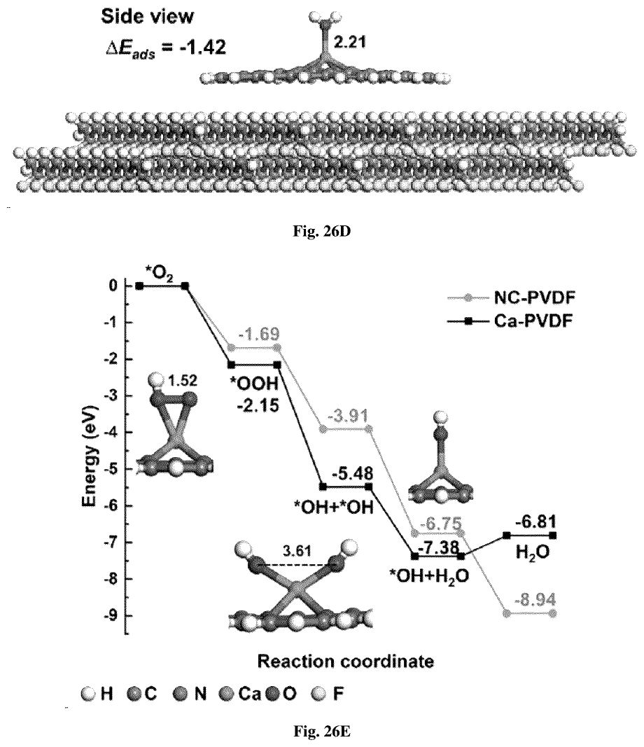

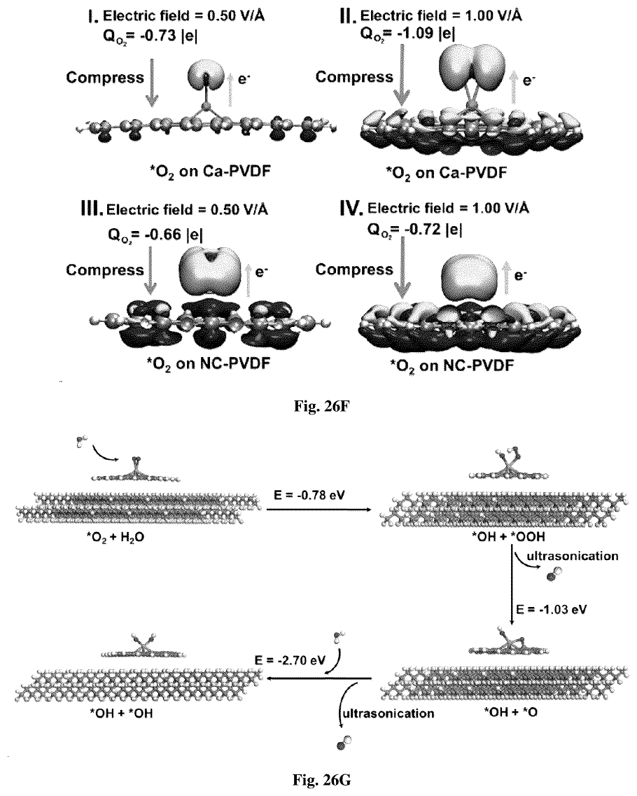

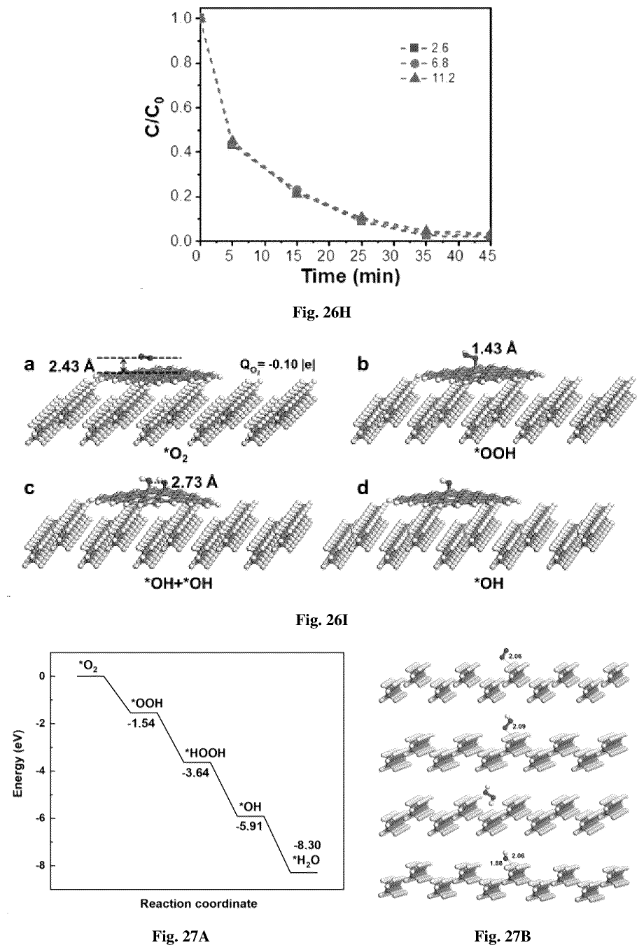

Meanwhile, DFT calculations are performed to analyze the catalytic mechanism carefully. Similar to Mo, Ni, and N co-doped carbon (MoNi—NC) anchored PVDF, the MoNi—NC segment serves as the catalytic site. The distributions of the density of states (FIG. 26A) prove that the Ca—NC moiety acts as an active catalytic site, as demonstrated by the HOMO and LUMO (FIG. 26B) on the Ca—NC moiety. Concerning ·OH generation, it can result from either the hydrogenation of O₂ or the decomposition of water in an acidic environment. Due to the strong adsorption energy of the O₂ molecule on the Ca atom, as compared to that of water (−2.32 vs. −1.42, FIGS. 26C and 26D), the Ca site will be preferentially occupied by O₂, thereby primarily yielding ·OH through the O₂ hydrogenation. Following adsorption, because of the local electric field contributed by the significant dipole moment in this catalytic system (FIG. 21A), even in the absence of an external electric field induced by ultrasonication (FIG. 26C), −0.62 |e| negative charges are driven to transfer to O₂, enhancing the formation of ·O₂ and promoting the dissociation of the O—O bond of the O₂ molecule. The bond length (D_{O-O}) of the O—O bond (Table 5) was elongated to 1.32 Å, compared to 1.22 Å of D_{O-O} for free O₂ molecule.

Table 5. The distance (DO-O, in Å) between two O atoms in the geometries of intermediates adsorbed on Ca-PVDF, NC-PVDF, Ca—NC and NC. * Presents that the molecules are adsorbed on the surface.

TABLE 5
The distance (DO—O, in Å) between two O atoms in the geometries of
intermediates adsorbed on Ca—PVDF, NC—PVDF, Ca—NC and NC.

| | D_{O—O} | D_{O—O} | D_{O—O} | D_{O—O} |
|---|---|---|---|---|
| Molecular | (adsorbed on Ca—PVDF) | (adsorbed on NC—PVDF) | (adsorbed on Ca—NC) | (adsorbed on NC) |
| *O₂ | 1.32 | 1.25 | 1.33 | 1.26 |
| *OOH | 1.52 | 1.43 | 1.53 | 1.44 |
| *OH+*OH | 3.61 | 2.72 | 3.56 | 2.72 |

*Presents that the molecules are adsorbed on the surface.

Consequently, the reaction pathway under acidic conditions shows that the Coulombic repulsion of the negatively charged O atoms makes the O—O bond easy to break in the subsequent hydrogenation process with downward reaction energy as shown in FIG. 26E. However, the step of *OH hydrogenation owns an upward reaction energy of 0.57 eV, which is an endothermic reaction and is unlikely to proceed to H₂O. The result explains the release of ·OH by ultrasonication as the final product to remove pollutants, as shown in FIG. 24B.

The reaction pathway under alkaline conditions (FIG. 26G) also shows spontaneous reaction to produce ·OH, implying that Ca-PVDF exhibits high activity across a broad pH range. The corresponding chemical reaction steps are shown as follows:

*O₂+H₂O→*OH+*OOH+ultrasonication→*OOH+·OH; (1)

*OOH→*+*OH+ultrasonication→*O+·OH; (2)

*O+H₂O→*OH+*OH+ultrasonication→·OH+·OH. (3)

As shown in FIG. 26G, the reaction mechanisms of the reduction of O₂ on the Ca-PVDF membranes under alkaline conditions proved that the ·OH was produced by the reaction between O₂ and H₂O under alkaline conditions.

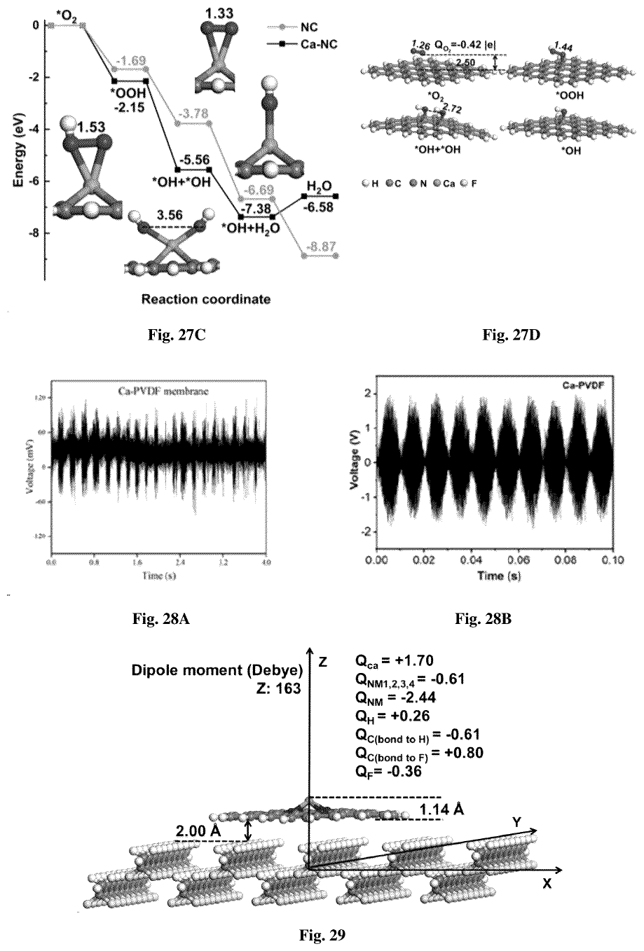

This is consistent with the experimental results (FIG. 26H) under different pH values. In contrast, for β-phase-PVDF (NC-PVDF) membranes decorated with carbon material doped with only N atom (NC) (FIG. 26I), the O₂ is physically adsorbed 2.43 Å away from the surface, with 0.10 |e| of charge transfer as well as almost unchanged bond length (1.25 Å) of D_{O-O}, implying a lower catalytic activity. In this case, the O₂ molecule is gripped by the C atom bonded to the N atom (FIG. 26I) and hydrogenated to *OH. In FIG. 26I, the distance of 2.43 Å between the O₂ molecule and NC moiety and the charge (−0.10 |e|) of O₂ molecule are marked. The distances between two O atoms (DO-O, in Å) of the intermediates are shown. * indicates that the molecules are adsorbed on the surface. But further hydrogenation to H₂O occurs with downward reaction energy, as shown in FIG. 26E, indicating a lower yield of ·OH compared to the case of Ca-PVDF. The energy profile diagram in FIGS. 27A to 27D show that the hydrogenation process of the O₂ molecule produces ·OH on Ca—NC, same as Ca-PVDF, and H₂O on NC, same as NC-PVDF and β-phase-PVDF. Therefore, this demonstrates that the primary contribution to catalytic activity arises from the doping of single Ca atoms.

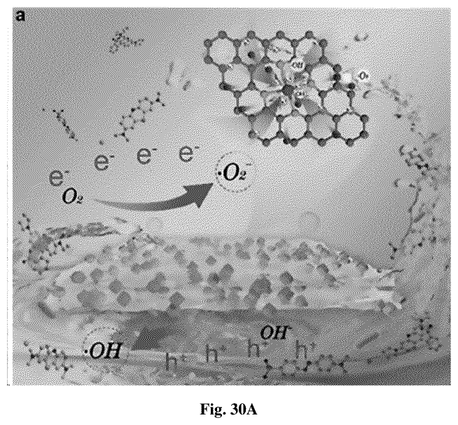

Additionally, considering the possible piezoelectric effect, the contributions of β-phase-PVDF are also calculated. As shown in FIG. 21A, because of the mismatch of negative and positive centers, the large local electric field of about 162 Debye along the Z-axis is formed. Especially when we applied mechanical stress by hand bend mildly in FIG. 28A, we can get the optimum voltage output (180 mV) and the maximum optimum voltage output (2V) of the Ca-PVDF membrane under the vibration (5 HZ) (FIG. 28B). This proved that the local electric field can be altered by ultrasonic compression (FIG. 29). As illustrated in FIG. 26F, compression results in the decreased distance between the centers of negative and positive charges in the Ca-PVDF membrane, thereby amplifying the electric field that points towards the bottom of the material shown by the blue arrow. This was simulated by applying external electric fields of 0.50 (FIG. 26F-I and FIG. 26F-III) and 1.00 V/Å (FIG. 26F-II and FIG. 26F-IV), which can facilitate the migration of free electrons to the O₂ molecule as shown by the yellow arrows in FIG. 26F. The O₂ molecule obtains more electrons on Ca-PVDF (FIG. 26F-I and FIG. 26F-II) compared to NC-PVDF (FIG. 26F-III and FIG. 26F-IV) under the same electric field. Notably, −1.09 |e| electrons transfer to the adsorbate on Ca-PVDF under the electric field of 1.00 V/Å, forming ·O₂ species as shown in FIG. 26F-II. Subsequently, the produced ·O₂⁻ species detached from the surface upon ultrasonication, as depicted in FIG. 24B. However, since O₂ is physisorbed on the NC-PVDF without any chemical bonding, the same external electric field results in less electron transfer to the adsorbates. This leads to a lower catalytic activity for ·O₂⁻ production than chemisorbed O₂ on Ca-PVDF. Therefore, the β-phase-PVDF mainly contributes to the local electric field promoting electron transfer to O₂, and the Ca—NC moiety plays a significant role in enhancing the catalytic activity for the O₂ molecular hydrogenation. This suggests that there might be a synergy between Ca—NC and β-phase-PVDF in producing ·O₂⁻ and ·OH species.

From the material aspect, it is believed that the decoration of carbon nanoparticles would result in the porous morphology of the membrane, which contributes to the opened channels for mass transfer and plenty of exposed active sites for ROS generation and organic compound degradation. Besides that, the addition of nanoparticles fiberized the in-situ polymerized PVDF, which not only improves the crystallization of the polymer and the content of β-phase PVDF, but also improves the orientation of the polymer chain in the domain. The porosity also decreases the Young's modulus of the membrane and thus yielding more structural distortion under the same mechanical excitation. DFT computations also proved the catalytic synergy of the calcium atoms as active sites and the β phase formation of PVDF offering a higher local electric field. Under the synergistic effect of the above factors, the overall spontaneous polarization and thus the piezoelectric properties of the Ca-PVDF membrane are significantly promoted.

### Example 10

### The Working Principle of Ca-PVDF Membrane for Degradation

The working principle of the Ca-PVDF membrane for degradation (FIGS. 30A and 30B). The Ca—NC nanoparticles embedded into the PVDF can act as nucleating agents to promote the formation of the β-phase PVDF in the Ca-PVDF composite membrane. This leads to polarization around the polar single-atom-region as the polarization-induced bound charges are balanced by the external shielding charges with opposite signs, so that Ca-PVDF membranes are electrically neutral (FIG. 30B). Under compressive stress generated by ultrasound, the temporary charge equilibrium state is disturbed, and the polarization weakens, and the excess charge-free charges can promote redox reactions with oxygen molecules in water to form ·O₂⁻. Hydroxyl radicals are then generated through a two-step reduction reaction. At the same time, h can react with free hydroxide ions to form hydroxyl radicals. Finally, the generated radicals can then destroy RhB, E. coli, and other organic pollutants. Interestingly, the Ca—N—C structure leads to enhanced macroscopic polarization, which primarily facilitates charge separation, promoting molecular oxygen activation during ultrasound-assisted piezoelectric catalysis. These reactions continue until a new electrical equilibrium is reached (FIG. 30B). When the material restores to its original shape, the polarization potential is increased, and the charges are absorbed from the surrounding electrolyte to balance the bound charges induced by the piezoelectric effect, so that free radicals can be formed in the aqueous solution (FIG. 30B). After cycling, a new electrostatic equilibrium is reached. Thus, it is believed that a piezoelectric material under periodical stress and in an electrolyte environment will offer continuous charge to produce ·OH or ·O₂⁻ reactive species for catalysis.

Ca—NC nanoparticles embedded into the PVDF can act as nucleating agents to promote the formation of the β-phase PVDF in the Ca-PVDF composite membrane. The single Ca atom in Ca-PVDF, serving as both the active site and electron donor, seizes O₂ molecules. Catalyzed by the Ca atom, O₂ molecules undergo a two-step reduction reaction to *OH (Eq. 1, Eq. 2), subsequently dissociating to generate ·OH under ultrasonication (Eq. 3). Meanwhile, upon receiving electrons, some O₂ molecules do not participate in the reduction reaction but are directly released as ·O₂ under ultrasonication (Eq. 4). At the same time, h′ can react with free hydroxide ions to form ·OH species (Eq. 5). On the other hand, the piezoelectricity of Ca-PVDF could also potentially enhance catalytic efficiency. The polarization of Ca-PVDF around the polar single-atom-region as the polarization-induced bound charges are balanced by the external shielding charges with opposite signs so that Ca-PVDF membranes are electrically neutral (FIG. 30B-I). Under compressive stress generated by ultrasound, the temporary charge equilibrium state is disturbed, the polarization weakens (FIG. 30B-II), and the excess charge-free charges can promote redox reactions with oxygen molecules in water to form ·O₂⁻ (Eq. 4). Finally, the generated radicals can then destroy RhB, E. coli, and other organic pollutants (Eq. 6). Interestingly, the Ca—N—C structure leads to enhanced macroscopic polarization, which primarily facilitates charge separation, promoting molecular oxygen activation during ultrasound-assisted piezoelectric catalysis. These reactions continue until a new electrical equilibrium is reached (FIG. 30B-III). When the material restores its original shape, as a result, the polarization potential is increased, and the charges are absorbed from the surrounding electrolyte to balance the bound charges induced by the piezoelectric effect, so that free radicals can be formed in the aqueous solution (FIG. 30B-IV). After cycling, a new electrostatic equilibrium is reached. Thus, a piezoelectric material under periodical stress and in an electrolyte environment might offer continuous charge to produce ·OH or ·O₂⁻ reactive species for catalysis. Hence, while Ca single atoms function as catalytic active sites, the piezoelectricity of the material might also offer auxiliary assistance in further enhancing the activity of Ca-PVDF, thereby increasing the yield of ·OH or ·O₂⁻ species.

The corresponding chemical reaction routes in catalytic degradation are as follows:

O₂+e⁻+2H⁺+Ca-PVDF→*2OH; (1)

*2OH+e⁻+H⁺→*OH+H₂O; (2)

*OH+ultrasonication→·OH; (3)

O₂+e⁻+Ca-PVDF+ultrasonication→O₂; (4)

OH⁻+h⁺→·OH; (5)

·O₂⁻+·OH+e⁻+h⁺+ultrasonication→RhB decomposition+Water disinfection. (6)

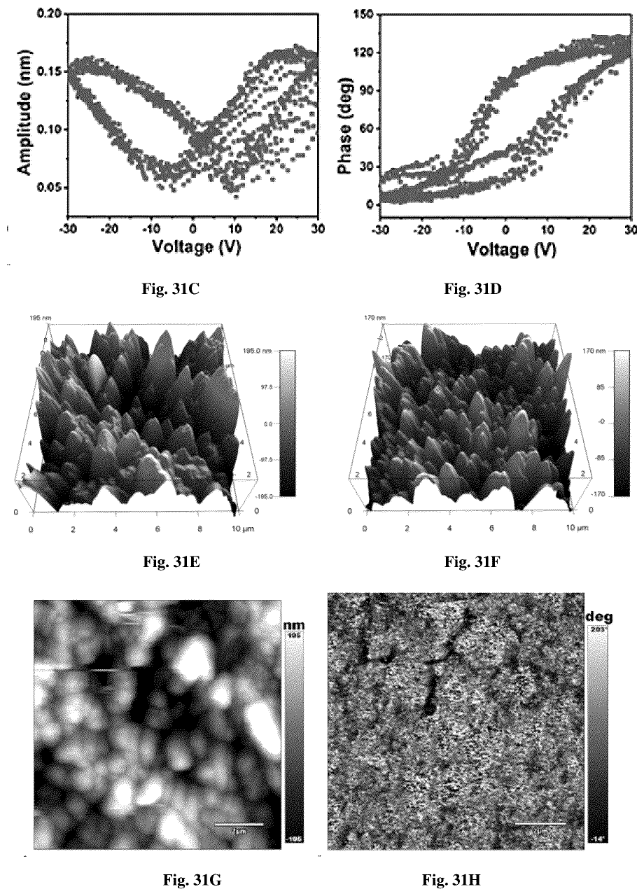

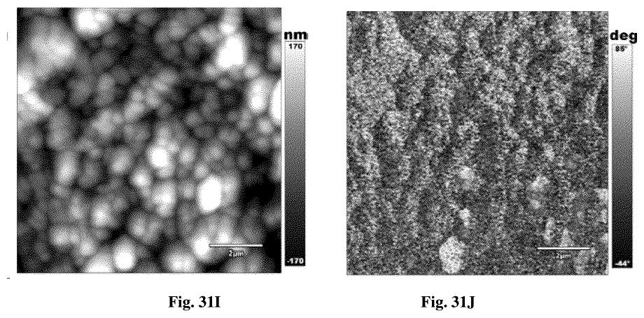

Subsequently, piezoelectric force microscopy (PFM) is employed to confirm the proposed mechanism. A localized point to point piezo response is studied by applying a bias voltage (10 V) on a conductive cantilever tip. The topographic, vertical piezoresponse amplitude and phase images of the Ca-PVDF and PVDF are shown in FIG. 31A-30J. From the 3D-PFM topography image of the PVDF and the Ca-PVDF membranes (FIGS. 31E and 31F), we can see the variation in the height signals. Phase (FIGS. 31G and 31I) and amplitude (FIGS. 31A and 31B) images of the two membranes correspond well with their morphologies (FIGS. 31H and 31J). From the phase images (FIGS. 31G and 31I), we can see notable phase differences in different regions, indicating the presence of varying polarization directions in both samples. As shown in FIGS. 31A and 31B, the Ca-PVDF membrane presents a more distinct piezoresponse amplitude than the PVDF membrane. Furthermore, the butterfly-shaped amplitude curve (FIGS. 31C and 31D) displayed apparent variation in the amplitude under the external electric field, while the phase angle changed by approximately 135° in the hysteresis loop, verifying that the Ca-PVDF membrane show stronger piezoelectric responses.

### DISCUSSION

The modulation of the transient local dipole moment change by introducing Ca atoms and anchoring single-atom Ca in nitrogen-doped carbon-coupled PVDF membranes obtains a high percentage of PVDF β-phase (52.3%). Thus obtaining improved self-polarization and piezoelectric properties from the Ca-PVDF membrane which exhibits a record high degradation reaction rate constant of 0.11 min⁻¹ and good E. coli kill performance compared with other reported piezocatalysts under ultrasonication.

Additionally, computational results show that the O₂ molecule is easily hydrogenated to produce ·OH on the Ca-PVDF membrane and the local electric field provided by β-phase-PVDF could enhance ·O₂⁻ production. The experiments prove the synergistic effects on the yields of ·O₂⁻ and ·OH species. The mild and convenient host-guest strategy and phase conversion method of synthesis described herein make Ca-PVDF membranes a promising candidate for practical applications. This work demonstrates that single-atom structural modifications can give conventionally considered impossible materials catalytic properties.

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

All references specifically cited herein are hereby incorporated by reference in their entireties. However, the citation or incorporation of such a reference is not necessarily an admission as to its appropriateness, citability, and/or availability as prior art to/against the present invention.

### REFERENCES

[1] ADDIN EN.REFLIST You, H. et al. Piezoelectrically/pyroelectrically-driven vibration/cold-hot energy harvesting for mechano-/pyro-bi-catalytic dye decomposition of NaNbO₃ nanofibers. Nano Energy. 52, 351-359 (2018).
[2] Singh, G. et al. Transparent ferroelectric glass-ceramics for wastewater treatment by piezocatalysis. Commun. Mater. 1, 100 (2020).
[3] Lin, E. et al. BaTiO₃ nanocubes/cuboids with selectively deposited Ag nanoparticles: Efficient piezocatalytic degradation and mechanism. Appl. Catal. 285, (2021).
[4] Lin, E. et al. Silver modified barium titanate as a highly efficient piezocatalyst. Catal. Sci. Technol. 8, 4788-4796 (2018).
[5] Yuan, B. et al. Sm-doped Pb(Mg_{1/3}Nb_{2/3})O₃₋ₓPbTiO₃ piezocatalyst: Exploring the relationship between piezoelectric property and piezocatalytic activity. Appl. Mater. Today. 17, 183-192 (2019).
[6] Pan, M. et al. Unlocking the high redox activity of MoS₂ on dual-doped graphene as a superior piezocatalyst. Nano Energy. 68, 104366 (2020).
[7] Shao, D. et al. Oxygen Reduction Reaction for Generating H₂O₂ through a Piezo-Catalytic Process over Bismuth Oxychloride. ChemSusChem. 11, 527-531 (2018).
[8] Wang, Y. et al. Piezo-catalysis for nondestructive tooth whitening. Nat. Commun. 11, 1328 (2020).
[9] Biswas, A. et al. ZnSnO3 Nanoparticle-Based Piezocatalysts for Ultrasound-Assisted Degradation of Organic Pollutants. ACS Appl. Nano Mater. 2, 1120-1128 (2019).
[10] Wu, J. et al. Effective enhancement of piezocatalytic activity of BaTiO₃ nanowires under ultrasonic vibration. Nano Energy. 45, 44-51 (2018).
[11] Liu, Y. L.; Wu, J. M. Synergistically catalytic activities of BiFeO₃/TiO₂ core-shell nanocomposites for degradation of organic dye molecule through piezophototronic effect. Nano Energy. 56, 74-81 (2019).
Kang, Z. et al. Effect of oxygen vacancies and crystal symmetry on piezocatalytic properties of Bi₂WO₆ ferroelectric nanosheets for wastewater decontamination. Environmental Science: Nano. 8, 1376-1388 (2021).
Liu, W. et al. Directing Charge Transfer in a Chemical-Bonded BaTiO₃ @ReS2 Schottky Heterojunction for Piezoelectric Enhanced Photocatalysis. Adv. Mater., e2202508 (2022).
Wang, Z. et al. Contact-electro-catalysis for the degradation of organic pollutants using pristine dielectric powders. Nat. Commun. 13, 130 (2022).
Singh, G. et al. Flexible Ag@LiNbO₃/PVDF Composite Film for Piezocatalytic Dye/Pharmaceutical Degradation and Bacterial Disinfection. ACS Appl. Mater. Interfaces. 13, 22914-22925 (2021).
Wang, Y. et al. Ultrasonic activation of inert poly(tetrafluoroethylene) enables piezocatalytic generation of reactive oxygen species. Nat. Commun. 12, 3508 (2021).
Ma, W. et al. Fabrication of PVDF-based piezocatalytic active membrane with enhanced oxytetracycline degradation efficiency through embedding few-layer E-MoS₂ nanosheets. Chem. Eng. J. 415, (2021).
Sharma, M. et al. Piezocatalysis in ferroelectric Ba_{0.85}Ca_{0.15}Zr_{0.1} Ti_{0.9}O₃/polyvinylidene difluoride (PVDF) composite film. J. Appl. Phys. 130, (2021).
Wan, L. et al. Hydrophilic porous PVDF membrane embedded with BaTiO₃ featuring controlled oxygen vacancies for piezocatalytic water cleaning. Nano Energy. 94, (2022).
Wang, X. et al. Synthesis of flexible BaTiO₃ nanofibers for efficient vibration-driven piezocatalysis. Ceram. Int. 47, 25416-25424 (2021).
Tian, W. et al. Efficient piezocatalytic removal of BPA and Cr (VI) with SnS₂/CNFs membrane by harvesting vibration energy. Nano Energy. 86, (2021).
Raju, T. D. et al. Polyvinylidene Fluoride/ZnSnO3 Nanocube/Co₃O₄ Nanoparticle Thermoplastic Composites for Ultrasound-Assisted Piezo-Catalytic Dye Degradation. ACS Appl. Nano Mater. 3, 4777-4787 (2020).
Wang, R. et al. Bi-piezoelectric effect assisted ZnO nanorods/PVDF-HFP spongy photocatalyst for enhanced performance on degrading organic pollutant. Chem. Eng. J. 439, (2022).
Zheng, J. et al. Effective Removal of Sulfanilic Acid From Water Using a Low-Pressure Electrochemical RuO₂—TiO₂@Ti/PVDF Composite Membrane. Front Chem. 6, 395 (2018).
Singh, K. P. et al. Utilizing the localized surface piezoelectricity of centrosymmetric Sr₁₋ₓ FeₓTiO₃ (x≤0.2) ceramics for piezocatalytic dye degradation. J. Eur. Ceram. Soc. 41, 326-334 (2021).
Laurenti, M. et al. Piezo- and Photocatalytic Activity of Ferroelectric ZnO:Sb Thin Films for the Efficient Degradation of Rhodamine-beta dye Pollutant. ACS Appl. Mater. Interfaces. 12, 25798-25808 (2020).
Nguyen, T. N. N.; Chang, K. S. Piezophotodegradation and piezophotoelectrochemical water splitting of hydrothermally grown BiFeO₃ films with various morphologies. Journal of Environmental Chemical Engineering. 10, (2022).

What is claimed is:

1. A piezocatalyst comprising:
a nitrogen doped carbon skeleton derived from a zeolitic imidazolate framework (ZIF), and
a single-atom alkaline earth metal anchored on the nitrogen doped carbon skeleton,
wherein the alkaline earth metal is selected from the group consisting of beryllium (Be), magnesium (Mg), calcium (Ca), Strontium (Sr), and barium (Ba),
wherein the piezocatalyst comprises an active cite formed with the single-atom alkaline earth metal and nitrogen atoms from the ZIF.

2. The piezocatalyst according to claim 1, wherein the ZIF is selected from the group consisting of ZIF-6, ZIF-7, ZIF-8, and combinations thereof.

3. The piezocatalyst according to claim 1, wherein the alkaline earth metal is Ca.

4. The piezocatalyst according to claim 3, wherein the active cite comprises Ca—N₃ or Ca—N₄ configuration.

5. The piezocatalyst according to claim 1, wherein the piezocatalyst has a porous structure with a BET surface area ranging from about 530 m²/g to about 925 m²/g.

6. A piezocatalytic material comprising a piezocatalyst according to claim 1.

7. The piezocatalytic material according to claim 6, wherein the ZIF is selected from the group consisting of ZIF-6, ZIF-7, ZIF-8, and combinations thereof, and wherein the alkaline earth metal is Ca.

8. The piezocatalytic material according to claim 6, wherein the piezocatalytic material comprises greater than 0 to about 20 wt % of the piezocatalyst.

9. The piezocatalytic material according to claim 6, wherein the piezocatalyst is a nanoparticle of calcium atom-anchored nitrogen-doped carbon.

10. The piezocatalytic material according to claim 6, wherein the piezocatalytic material further comprises any of the following materials:
(1) a carbon material selected from the group consisting of graphite, carbon fiber, carbon nanotube, graphene, carbon black, hollow spheres, mesoporous carbon, reduced graphene oxide (GO), and a combination thereof; and
(2) a polymer selected from the group consisting of polyvinyl acetate (PVA), polydimethyl silane (PDMS), polyurethane (PU), polyethylene, cellulose, polytrifluoroethylene (PTFE), polyvinylidene fluoride (PVDF), polyamide, polyester, aramid, and a combination thereof.

11. The piezocatalytic material according to claim 10, wherein the piezocatalytic material is a membrane having a porous structure on both sides.

12. The piezocatalytic material according to claim 10, wherein the piezocatalytic material comprises the carbon material, which is subjected to a pyrolysis process together with the alkaline earth metal doped ZIF precursor to form a membrane.

13. The piezocatalytic material according to claim 10, wherein the piezocatalytic material is a hybrid membrane composited with the piezocatalyst and PVDF and having an improved β phase ratio compared with a raw PDVF membrane.

14. The piezocatalytic material according to claim 13, wherein the hybrid membrane comprises a first side having microscale structure and a second side having nanoscale structure.

15. A method for preparing a piezocatalyst according to claim 1, comprising the steps of:
(A) providing a precursor comprising alkaline earth metal doped zeolitic imidazolate framework (ZIF); and
(B) subjecting the precursor from step (A) to a pyrolysis process.

16. The method according to claim 15, wherein step (A) comprises:
(A1) providing a first mixture comprising a Zn source and an alkaline earth metal source comprising an alkaline earth metal selected from the group consisting of beryllium (Be), magnesium (Mg), calcium (Ca), Strontium (Sr), and barium (Ba);
(A2) providing a second mixture comprising 2-methylimidazole;
(A3) mixing the first mixture and the second mixture by stirring to provide a third mixture;
(A4) heating the third mixture to about 120° C. in an airtight container to provide a fourth mixture; and
(A5) isolating the precursor from the fourth mixture.

17. The method according to claim 15, wherein the pyrolysis process is performed by heating the precursor to a temperature of about 900° C. to 910° C. at a rate ranging from greater than 0 to about 5° C./min in an inert atmosphere.

18. The method according to claim 17, wherein the precursor is maintained at the temperature of about 900° C. to 910° C. for greater than 0 to about 4 hours.

19. The method according to claim 16, wherein the first mixture, the second mixture, and the third mixture further comprise an organic solvent selected from the group consisting of propyl alcohol, n-butyl alcohol, acetonitrile, N-methyl-2-pyrrolidone, ethanol, methanol, acetone, tetrahydrofuran, and a combination thereof.

20. A method for manufacturing a piezocatalytic material, comprising the steps of:
(1) providing a precursor comprising an alkaline earth metal doped zeolitic imidazolate framework (ZIF), comprising:
(A1) providing a first mixture comprising a Zn source and an alkaline earth metal source comprising an alkaline earth metal selected from the group consisting of beryllium (Be), magnesium (Mg), calcium (Ca), Strontium (Sr), and barium (Ba); or Ba, Mg and Ca; or Mg and Ca; or Ca;
(A2) providing a second mixture comprising 2-methylimidazole;
(A3) mixing the first mixture and the second mixture by stirring to provide a third mixture;
(A4) heating the third mixture to about 120° C. in an airtight container to provide a fourth mixture; and
(A5) isolating the precursor from the fourth mixture; and
(2) subjecting the precursor from step (1) to a pyrolysis process;
(3) forming the piezocatalytic material.

21. The method according to claim 20, wherein step (2) comprises subjecting the precursor and a carbon material to a pyrolysis process, wherein the carbon material is selected from the group consisting of graphite, carbon fiber, carbon nanotube, graphene, carbon black, hollow spheres, mesoporous carbon, and reduced graphene oxide (GO).

22. The method of according to claim 20, wherein:
step (2) comprises
(a) subjecting the precursor to a pyrolysis process to provide powder of a piezocatalyst;
step (3) comprises:
(b) dispersing the piezocatalyst into a polymer solution to provide a polymer suspension, wherein the polymer solution comprises a polymer selected from the group consisting of polyvinyl acetate (PVA), polydimethyl silane (PDMS), polyurethane (PU), polyethylene, cellulose, polytrifluoroethylene (PTFE), polyvinylidene fluoride (PVDF), polyamide, polyester, aramid, and a combination thereof; and
(c) forming a polymer membrane by casting the suspension.

23. The method according to claim 20, wherein the pyrolysis process is performed at a temperature of about 900° C. to 910° C.

24. The method according to claim 22, wherein the forming step comprises the steps of:
i) providing a glass plate;
ii) casting the polymer suspension onto the glass plate;
iii) curing the polymer suspension into a polymer membrane; and
iv) removing the polymer membrane from the glass plate.

25. An environmental remediation method comprising the steps of:
A) providing a piezocatalyst or a piezocatalytic material including the piezocatalyst, the piezocatalyst comprising:
a nitrogen doped carbon skeleton derived from a zeolitic imidazolate framework (ZIF), and
a single-atom alkaline earth metal anchored on the nitrogen doped carbon skeleton, wherein the alkaline earth metal is selected from the group consisting of beryllium (Be), magnesium (Mg), calcium (Ca), Strontium (Sr), and barium (Ba), wherein the piezocatalyst comprises an active cite formed with the single-atom alkaline earth metal and nitrogen atoms from the ZIF;
B) exposing the piezocatalyst or the piezocatalytic material to water and an environment in need of remediation;
C) vibrating the piezocatalyst or the piezocatalytic material to generate a reactive oxygen species (ROS); and
D) exposing the environment in need of remediation to the ROS.

26. The environmental remediation method according to claim 25, wherein the vibrating step (C) is at a frequency of from about 1 kHz to about 120 kH.

27. The environmental remediation method according to claim 25, further comprising the step of exposing the piezocatalyst or the piezocatalytic material to illumination.
